(19) United States
(12) Patent Application Publication
(10) Pub. No.: US 2021/0061929 A1
(43) Pub. Date: Mar. 4, 2021

(54) ACTIVE-ENERGY-RAY-CURABLE COMPOSITION, ACTIVE-ENERGY-RAY-CURABLE INK, COMPOSITION STORED CONTAINER, TWO-DIMENSIONAL OR THREE-DIMENSIONAL IMAGE FORMING METHOD AND APPARATUS, CURED PRODUCT, AND DECORATED PRODUCT

(71) Applicants: Masahide KOBAYASHI, Kanagawa (JP); Mitsunobu MORITA, Shizuoka (JP); Takashi OKADA, Kanagawa (JP); Takenori SUENAGA, Kanagawa (JP); Soh NOGUCHI, Kanagawa (JP); Tatsuki YAMAGUCHI, Kanagawa (JP)

(72) Inventors: Masahide KOBAYASHI, Kanagawa (JP); Mitsunobu MORITA, Shizuoka (JP); Takashi OKADA, Kanagawa (JP); Takenori SUENAGA, Kanagawa (JP); Soh NOGUCHI, Kanagawa (JP); Tatsuki YAMAGUCHI, Kanagawa (JP)

(21) Appl. No.: 17/001,752

(22) Filed: Aug. 25, 2020

(30) Foreign Application Priority Data
Sep. 4, 2019 (JP) 2019-161563
Jun. 26, 2020 (JP) 2020-110701

(51) Int. Cl. C08F 2/50; C09D 11/322; C09D 11/101; C08K 3/30; C08K 3/22; C08F 220/58

(52) U.S. Cl. CPC C08F 2/50; C09D 11/322; C09D 11/101; C08K 2003/2296; C08K 3/22; C08F 220/58; C08K 2003/3036; C08K 3/30

(57) ABSTRACT

An active-energy-ray-curable composition including a pigment, a polymerizable compound, and a pigment-adsorptive component is provided. The pigment is at least one selected from the group consisting of strontium titanate, calcium titanate, zinc sulfide, and zinc oxide. The polymerizable compound contains an acrylamide compound (A1) having a specific ester structure.

### CROSS-REFERENCE TO RELATED APPLICATIONS

This patent application is based on and claims priority pursuant to 35 U.S.C. § 119(a) to Japanese Patent Application No. 2019-161563, filed on Sep. 4, 2019 and Japanese Patent Application No. 2020-110701, filed on Jun. 26, 2020, in the Japan Patent Office, the entire disclosure of which is hereby incorporated by reference herein.

### BACKGROUND

### Technical Field

The present disclosure relates to an active-energy-ray-curable composition, an active-energy-ray-curable ink, a composition stored container, two-dimensional or three-dimensional image forming method and apparatus using the same, a cured product, and a decorated product.

### Description of the Related Art

Active-energy-ray-curing inkjet recording methods, which are solvent-free and do not generate volatile organic compounds (hereinafter, may be referred to as “VOC”), are advantageous in environmental friendliness, quick drying property, and recording ability over liquid-non-absorbable recording media that do not absorb inks.

From various durability-related viewpoints, pigment-based inks are often demanded as active-energy-ray-curable inks, which are formed of active-energy-ray-curable compositions. Pigments need to be uniformly dispersed in the inks. Degradation of pigment dispersibility brings about degradation of liquid permeability during filtration of the inks and degradation of dischargeability such as nozzle clogging.

Examples of the method for dispersing pigments include coating of pigments with resins and addition of dispersants in the inks.

### SUMMARY

According to one aspect of the present disclosure, an active-energy-ray-curable composition includes a pigment, a polymerizable compound, and a pigment-adsorptive component, wherein the pigment is at least one selected from the group consisting of strontium titanate, calcium titanate, zinc sulfide, and zinc oxide, and wherein the polymerizable compound contains an acrylamide compound (A1) having an ester structure represented by General formula (1) below or General formula (4) below.

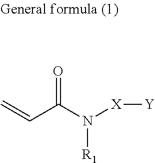

In General formula (1), R₁ represents an alkyl group containing from one through six carbon atoms, X represents an alkylene group containing from one through six carbon atoms, and Y represents a structure represented by General formula (2) below or General formula (3) below.

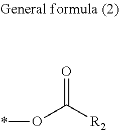

In General formula (2), R₂ represents an alkyl group containing from one through ten carbon atoms, and * represents a binding site with the X.

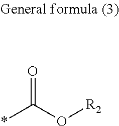

In General formula (3), R₂ represents an alkyl group containing from one through ten carbon atoms, and * represents a binding site with the X.

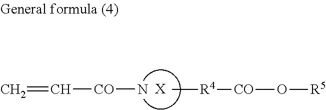

In General formula (4), a ring X represents a nitrogen-containing ring structure containing from two through five carbon atoms, R⁴ represents a single bond, or a straight-chained or branched alkylene group containing from one through three carbon atoms, R⁵ represents a straight-chained or branched alkyl group containing from one through three carbon atoms, and the total number of carbon atoms contained in the ring X, R⁴, and R⁵ is from three through six.

### BRIEF DESCRIPTION OF THE SEVERAL VIEWS OF THE DRAWINGS

Amore complete appreciation of the disclosure and many of the attendant advantages and features thereof can be readily obtained and understood from the following detailed description with reference to the accompanying drawings, wherein:

FIG. 1 is a schematic view illustrating an example of an image forming apparatus according to an embodiment of the present disclosure;

FIG. 2 is a schematic view illustrating another example of an image forming apparatus according to an embodiment of the present disclosure; and

FIGS. 3A to 3D are schematic views illustrating yet another example of an image forming apparatus according to an embodiment of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

White pigment dispersion compositions in which pigments are dispersed in high-polarity dispersion media cannot maintain a good dispersion/storage stability. Hence, there is a problem that the white hiding power of the compositions degrades. On the other hand, white pigment dispersion compositions in which pigments are dispersed in low-polarity dispersion media use the low-polarity dispersion media having a high skin sensitizing potential, and use titanium dioxide, which has been pointed out to have carcinogenicity, as white pigments in order to increase the white hiding power. Hence, there is a problem that safety of the compositions cannot be ensured.

Therefore, it has been impossible to obtain pigment dispersion compositions, active-energy-ray-curable compositions, and active-energy-ray-curable inkjet inks having a high safety in terms of representative safety items such as skin sensitizing potential and carcinogenicity, and having a good dispersion/storage stability and a high white hiding power by means of a dispersion medium having a high polarity. That is, it has been impossible to satisfy all of safety, dispersion/storage stability, white hiding power, liquid permeability, dischargeability, and curability.

The present disclosure has an object to provide an active-energy-ray-curable composition containing strontium titanate, calcium titanate, zinc sulfide, and/or zinc oxide as white pigments, low in carcinogenicity and skin sensitizing potential, and excellent in storage stability, white hiding power, liquid permeability, dischargeability, and curability.

According to the present disclosure, it is possible to provide a pigment dispersion composition excellent in safety and storage stability of the composition, and an active-energy-ray-curable composition and an ink excellent in white hiding power, safety, storage stability, liquid permeability, dischargeability, curability, and adhesiveness, when a white pigment selected from strontium titanate, calcium titanate, zinc sulfide, and zinc oxide is used as a colorant.

### (Active-Energy-Ray-Curable Composition)

An active-energy-ray-curable composition of the present disclosure contains a pigment, an acrylamide compound (A1) having an ester structure represented by General formula (1) or General formula (4) above, and a pigment-adsorptive component, and further contains a polymerization initiator, a polymerization accelerator, and other components as needed.

Each of the components constituting the active-energy-ray-curable composition will be described below.

### <Pigment>

As the pigment, at least one selected from the group consisting of strontium titanate, calcium titanate, zinc sulfide, and zinc oxide is used. Hereinbelow, strontium titanate, calcium titanate, zinc sulfide, and zinc oxide may be referred to as white pigments. The 50% cumulative volume-based particle diameter of the pigment is preferably 30 nm or greater but 350 nm or less, and more preferably 100 nm or greater but 300 nm or less. When the 50% cumulative volume-based particle diameter of the pigment is 30 nm or greater but 350 nm or less, dispersibility can be improved. The 50% cumulative volume-based particle diameter can be obtained based on the mean value of cumulative distribution of unidirectional particle diameters of primary particles in the number of 200 or more but 500 or less, measured within the interval between two parallel lines extending in a certain direction and sandwiching each of the primary particles, using a scanning electron microscope (instrument name: SU3500, available from Hitachi High-Technologies Corporation) in a field of view of a 10,000 times magnification.

The white pigment may be appropriately selected depending on the intended purpose from strontium titanate, calcium titanate, zinc sulfide, and zinc oxide.

In order to obtain a good dispersibility, it is preferable to apply surface treatment such as acid treatment to the surface of the white pigment. The acid treatment makes it easier for a basic dispersant polymer to be adsorbed to the white pigment, making it possible to improve dispersibility through a steric repulsion effect.

The method for the surface treatment is not particularly limited and may be appropriately selected depending on the intended purpose. Examples of the method include, but are not limited to, known methods such as treatment with a pigment derivative, modification with a resin, acid treatment, and plasma treatment.

The application field of the white pigment is not particularly limited and may be appropriately selected depending on the intended purpose. Examples of the application field include, but are not limited to, inkjet pigments, cosmetics pigments, and dental pigments.

A commercially available product can be used as the white pigment, Examples of the commercially available product include, but are not limited to, SW-100 (fired strontium titanate, with a number average primary particle diameter of 320 nm, available from Titan Kogyo, Ltd.), SW-300 (wet strontium titanate, with a number average primary particle diameter of 320 nm, available from Titan Kogyo, Ltd.), SW-350 (wet strontium titanate, with a number average primary particle diameter of 300 nm, available from Titan Kogyo, Ltd.), TC-100 (calcium titanate, with a number average primary particle diameter of 250 nm, available from Titan Kogyo Ltd.), TC-110 (calcium titanate, with a number average primary particle diameter of 250 nm, available from Titan Kogyo, Ltd.), SACHTOLITH HD-S (zinc sulfide, with a number average primary particle diameter of 300 nm, available from Connell Brothers Japan. Co., Ltd.), XZ-100F (zinc oxide, with a number average primary particle diameter of 100 nm, available from Sakai Chemical Industry Co., Ltd.), XZ-300F (zinc oxide, with a number average primary particle diameter of 300 nm, available from Sakai Chemical Industry Co., Ltd.), XZ-100F-LP (zinc oxide, with a number average primary particle diameter of 100 nm, available from Sakai Chemical Industry Co., Ltd.), XZ-300F-LP (zinc oxide, with a number average primary particle diameter of 300 nm, available from Sakai Chemical Industry Co., Ltd.). One of these commercially available products may be used alone or two or more of these commercially available products may be used in combination.

The content of the white pigment is preferably 1% by mass or greater but 10% by mass or less relative to the total amount of the active-energy-ray-curable composition. When the content of the white pigment is 1% by mass or greater, the coloring power can be improved. When the content of the white pigment is 10% by mass or less, viscosity thickening can be suppressed and dischargeability can be improved.

### <Acrylamide Compound (A1)>

The acrylamide compound (A1) contains an acrylamide group and an ester structure, and is a polymerizable monomer in the active-energy-ray-curable composition.

An acrylamide group refers to a group that has polymerizability and a bond formed between an acryloyl group (CH₂═CH—CO—) and a nitrogen atom of an amine compound.

The method for synthesizing the acrylamide compound (A1) is not particularly limited. Examples of the method include, but are not limited to, a method of allowing a compound containing an activated acryloyl group such as acrylic acid chloride and acrylic anhydride to undergo a reaction with an amine compound. The amine compound that can be used when synthesizing the acrylamide compound (A1) may be any selected from primary amines and secondary amines. Secondary amines are preferable because tertiary amides that are free of hydrogen bonding between amide groups and advantageous in anti-thickening can be obtained.

The ester structure contained in the acrylamide compound (A1) is preferably a straight-chained or branched alkyl ester group containing from one through four carbon atoms. Examples of the straight-chained or branched alkyl group containing from one through four carbon atoms include, but are not limited to, a methyl group, an ethyl group, a propyl group, an isopropyl group, a butyl group, a sec-butyl group, an isobutyl group, and a tert-butyl group.

The acrylamide compound (A1) is preferably a compound represented by General formula (1) or General formula (4) below.

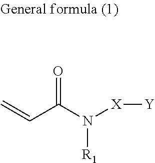

In General formula (1), R₁ represents an alkyl group containing from one through six carbon atoms, X represents an alkylene group containing from one through six carbon atoms, and Y represents a structure represented by General formula (2) below or General formula (3) below.

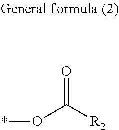

In General formula (2), R₂ represents an alkyl group containing from one through ten carbon atoms, and * represents a binding site with the X.

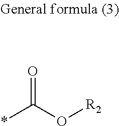

In General formula (3), R₂ represents an alkyl group containing from one through ten carbon atoms, and * represents a binding site with the X.

In General formula (1), R₁ represents a hydrogen atom, or a straight-chained or branched alkyl group containing from one through six carbon atoms, and is preferably a straight-chained or branched alkyl group containing from one through six carbon atoms. Examples of R₁ include, but are not limited to, a methyl group, an ethyl group, a propyl group, an isopropyl group, a butyl group, a sec-butyl group, an isobutyl group, and a tert-butyl group.

In General formula (1), X represents a straight-chained or branched alkylene group containing from one through six carbon atoms. Examples of X include, but are not limited to, a methylene group, an ethane-1,1-diyl group, an ethane-1,2-diyl group, a propane-1,1-diyl group, a propane-1,2-diyl group, a propane-1,3-diyl group, a butane-1,1-diyl group, a butane-1,2-diyl group, a butane-1,3-diyl group, a butane-1,4-diyl group, a 2-methylpropane-1,1-diyl group, a 2-methylpropane-1,2-diyl group, and a 2-methylpropane-1,3-diyl group.

In General formulae (2) and (3), R₂ represents a straight-chained or branched alkyl group containing from one through ten carbon atoms, and is preferably an alkyl group containing from one through two carbon atoms. Examples of R₂ include, but are not limited to, a methyl group, an ethyl group, a propyl group, an isopropyl group, a butyl group, a sec-butyl group, an isobutyl group, and a tert-butyl group.

The total number of carbon atoms contained in R¹, X, and R₂ is from two through six.

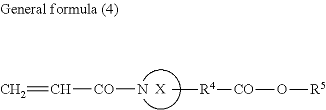

In General formula (4), a ring X represents a nitrogen-containing ring structure containing from two through five carbon atoms, R⁴ represents a single bond, or a straight-chained or branched alkylene group containing from one through three carbon atoms, and R⁵ represents a straight-chained or branched alkyl group containing from one through three carbon atoms. The total number of carbon atoms contained in the ring X, R⁴, and R⁵ is from three through six.

In General formula (4), the ring X represents a nitrogen-containing ring structure containing from two through five carbon atoms. Examples of the ring X include, but are not limited to, aziridine, azetidine, pyrrolidine, and piperidine. Pyrrolidine and piperidine are preferable.

In General formula (4), R⁴ represents a single bond, or a straight-chained or branched alkylene group containing from one through three carbon atoms. Examples of R⁴ include, but are not limited to, a single bond, a methylene group, an ethane-1,1-diyl group, an ethane-1,2-diyl group, a propane-1,1-diyl group, a propane-1,2-diyl group, and a propane-1,3-diyl group.

In General formula (4), R⁵ represents a straight-chained or branched alkyl group containing from one through three carbon atoms. Examples of R⁵ include, but are not limited to, a methyl group, an ethyl group, a propyl group, and an isopropyl group.

The total number of carbon atoms contained in the ring X, R⁴, and R⁵ is from three through six.

The compound represented by General formula (1) or (4) is preferably, for example, N-acryloyl-N-alkylamino acid alkyl ester (including N-acryloylproline alkyl ester), and N-acryloylpiperidine carboxylic acid alkyl ester. The alkyl group as referred to in this paragraph means a straight-chain or branched alkyl group containing from one through four carbon atoms. Particularly preferable examples of the alkyl group include, but are not limited to, an alkyl group containing one or two carbon atoms (i.e., a methyl group or an ethyl group).

Specific examples of the N-acryloyl-N-alkylamino acid alkyl ester include, but are not limited to, N-acryloyl-N-methylglycine methyl ester, N-acryloyl-N-methylglycine ethyl ester, N-acryloyl-N-methylglycine propyl ester, N-acryloyl-N-methylglycine butyl ester, N-acryloyl-N-ethylglycine methyl ester, N-acryloyl-N-ethylglycine ethyl ester, N-acryloyl-N-ethylglycine propyl ester, N-acryloyl-N-propylglycine methyl ester, N-acryloyl-N-propylglycine ethyl ester, N-acryloyl-N-butylglycine methyl ester, N-acryloyl-N-methylalanine methyl ester, N-acryloyl-N-methylalanine ethyl ester, N-acryloyl-N-methylalanine propyl ester, N-acryloyl-N-ethylalanine methyl ester, N-acryloyl-N-ethylalanine ethyl ester, N-acryloyl-N-propylalanine methyl ester, N-acryloyl-N-methyl-β-alaninemethyl ester, N-acryloyl-N-methyl-β-alanine ethyl ester, N-acryloyl-N-ethyl-β-alanine methyl ester, N-acryloyl-N-ethyl-β-alanine ethyl ester, N-acryloyl-N-methylvaline methyl ester, N-acryloylproline methyl ester, and N-acryloylproline ethyl ester.

Specific examples of the N-acryloylpiperidine carboxylic acid alkyl ester include, but are not limited to, methyl N-acryloylpiperidine-2-carboxylate, methyl N-acryloylpiperidine-3-carboxylate, and methyl N-acryloylpiperidine-4-carboxylate.

Specific examples of a compound that is represented by General formula (1) or (4) and is other than the N-acryloyl-N-alkylamino acid alkyl ester and N-acryloylpiperidine carboxylic acid alkyl ester include, but are not limited to, methacryloyloxyethyl acrylamide.

The acrylamide compound (A1) represented by General formula (1) or (4), as the polymerizable monomer contained in the composition of the present disclosure, is capable of reducing a skin sensitizing, which is preferable.

The molecular weight of the acrylamide compound (A1) is preferably 150 or greater but 250 or less and more preferably 150 or greater but 200 or less. It is preferable that the molecular weight of the acrylamide compound (A1) be 150 or greater, because an odor due to volatilization of the compound can be suppressed and inkjet discharging stability can be improved. It is preferable that the molecular weight of the acrylamide compound (A1) be 250 or less, because the composition has an excellent curability, the strength of a cured product is improved, and the composition is suppressed from viscosity thickening.

For application to an inkjet recording method, it is preferable that the acrylamide compound (A1) be a clear and colorless or clear and light-yellow liquid having a low viscosity (100 mPa·s or lower) at normal temperature (25 degrees C.). In terms of safety of the user, it is preferable that the acrylamide compound (A1) be not strongly acid or basic, and be free of formaldehyde that is toxic as an impurity.

Many commercially available products of an acrylamide compound containing a polymerizable acrylamide group but free of an ester structure are sold (e.g., N-acryloylmorpholine, N,N-dimethylacrylamide, N,N-diethylacrylamide, N-isopropylacrylamide, N-(2-hydroxyethyl)acrylamide, N-(hydroxymethyl)acrylamide, N-(butoxymethyl)acrylamide, N-[3-(dimethylamino)propyl]acrylamide, N-(1,1-dimethyl-3-oxobutyl)acrylamide, and 2-acrylamide-2-methylpropane sulfonic acid). However, it is impossible to find out a commercially available product that satisfies all of the effects of the present disclosure. The present disclosure is based on the finding that the acrylamide compound (A1) satisfies the effects of the present disclosure by containing an ester structure that is neutral and has an adequate polarity.

It is preferable that the acrylamide compound (A1) be contained by 4.8% by mass or greater but 94.8% by mass or less, more preferably 9.8% by mass or greater but 84.8% by mass or less, and yet more preferably 19.8% by mass or greater but 74.8% by mass or less relative to the total amount of the composition of the present disclosure. It is preferable that the content of the acrylamide compound (A1) be 19.8% by mass or greater because an adhesive agent used for assembling an ink discharging head has a better liquid contact property with the composition. It is preferable that the content of the acrylamide compound (A1) be 94.8% by mass or less because the composition has an excellent curability when irradiated with active energy rays. One kind of the acrylamide compound (A1) may be used alone or two or more kinds of the acrylamide compound (A1) may be used in combination.

Many commercially available products of an acrylamide compound containing a polymerizable acrylamide group but free of an ester structure are sold (e.g., N-acryloylmorpholine, N,N-dimethylacrylamide, N,N-diethylacryladmie, N-isopropylacrylamide, N-(2-hydroxyethyl)acrylamide, N-(hydroxymethyl)acrylamide, N-(butoxymethyl)acrylamide, N-[3-(dimethylamino)propyl]acrylamide, N-(1,1-dimethyl-3-oxobutyl)acrylamide, and 2-acrylamide-2-methylpropane sulfonic acid). However, it is impossible to find out a commercially available product that satisfies all of the effects of the present disclosure. The present disclosure is based on the finding that the acrylamide compound represented by General formula (1) or (4) satisfies the effects of the present disclosure by containing an ester structure that is neutral and has an adequate polarity.

Specific examples of the acrylamide compound represented by General formula (1) or General formula (4) include, but are not limited to, compounds included in the group “a” to group “i” presented below.

Examples of the compound represented by General formula (1) include, but are not limited to, the compounds of the group “a” to the group “g” presented below. Examples of the compound represented by General formula (4) include, but are not limited to, the compounds of the group “i” presented below.

Examples of compounds in the group “a” include, but are not limited to, the compounds of the groups a1 to a6 presented below. One of these compounds may be used alone or two or more of these compounds may be used in combination.

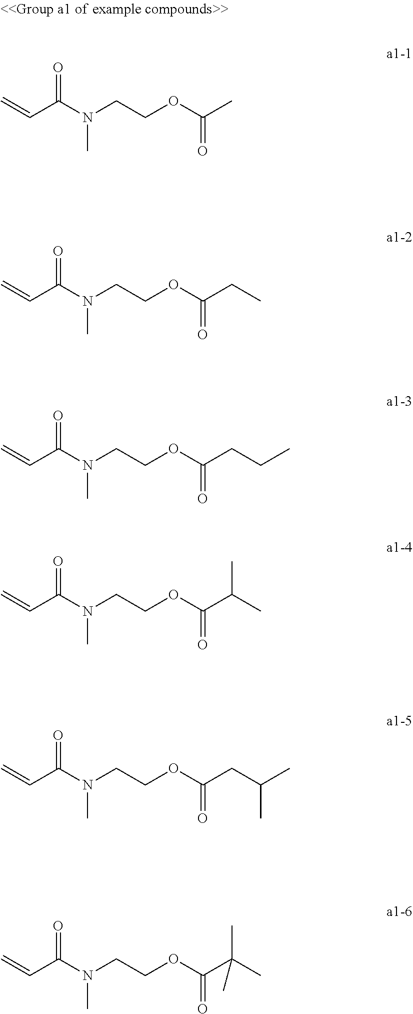

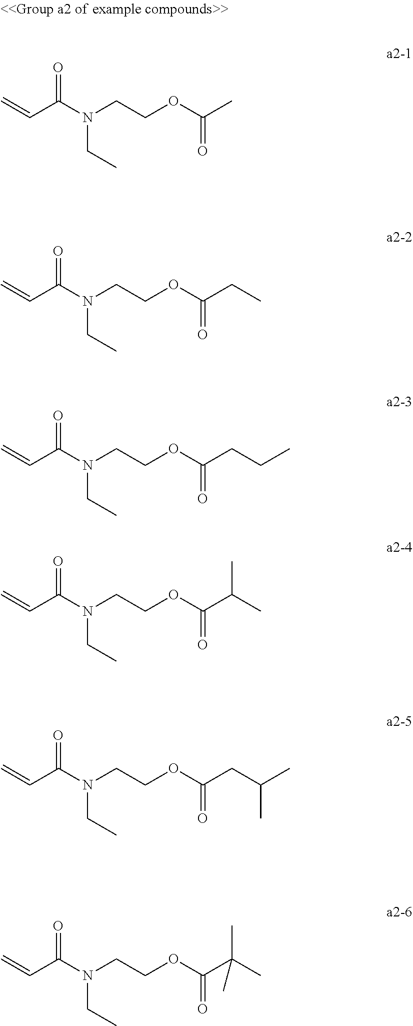

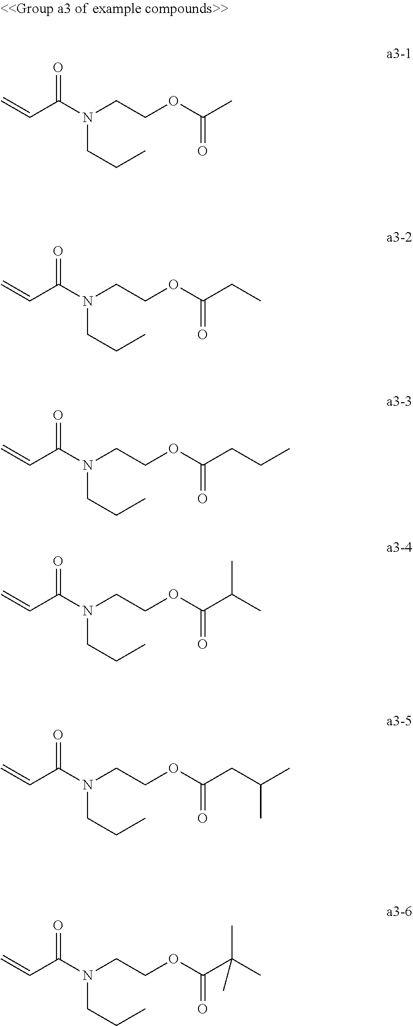

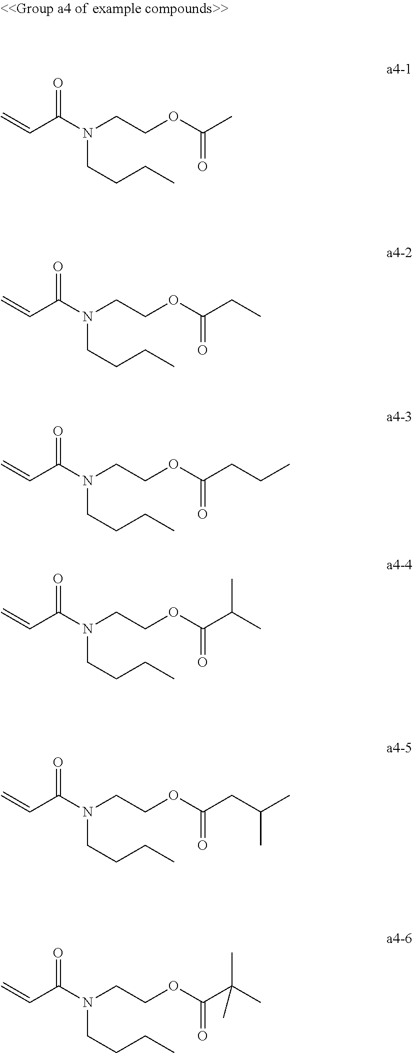

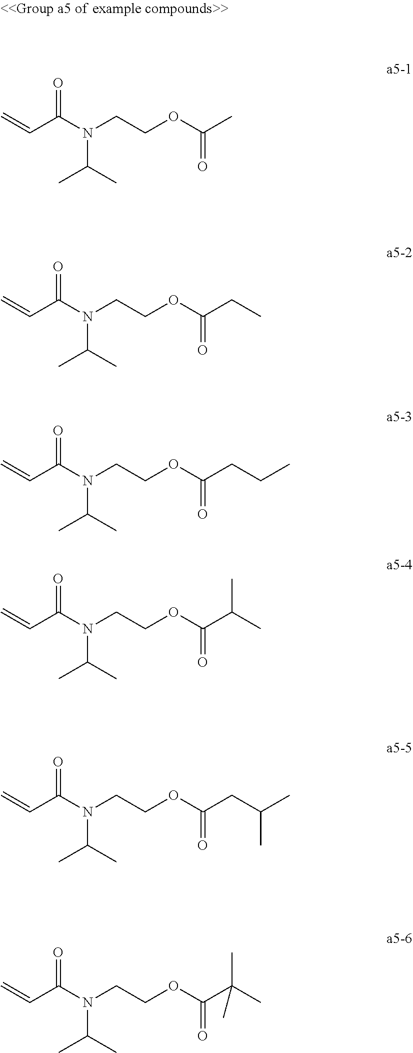

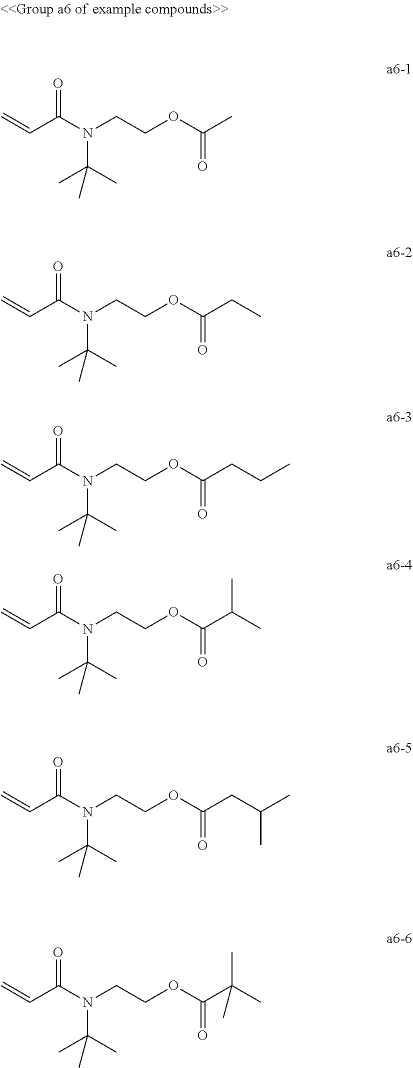

Examples of compounds in the group “b” include, but are not limited to, the compounds of the groups b1 to b6 presented below. One of these compounds may be used alone or two or more of these compounds may be used in combination.

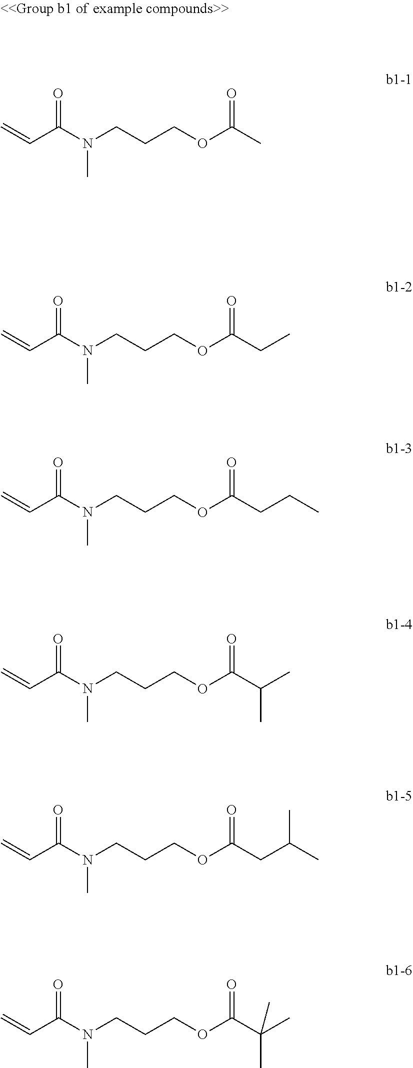

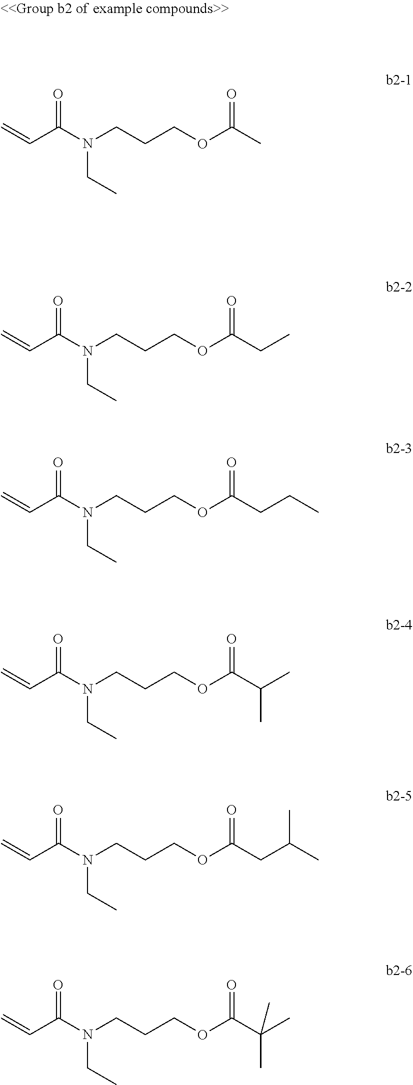

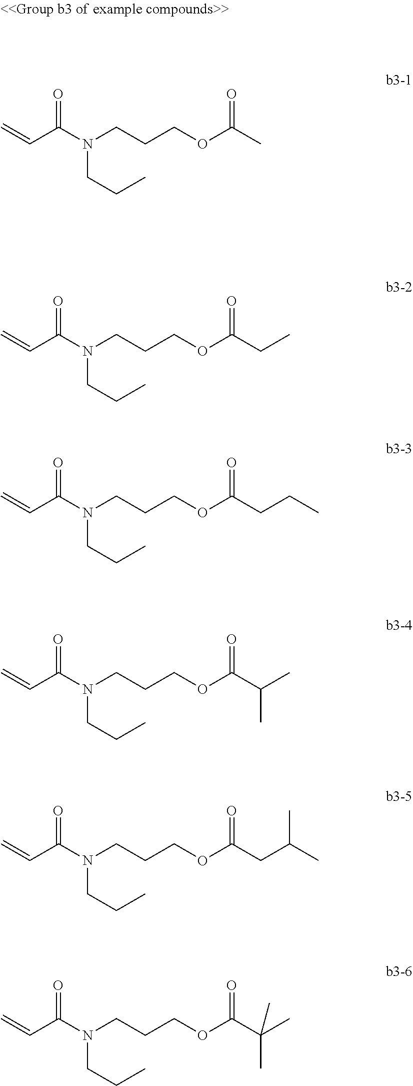

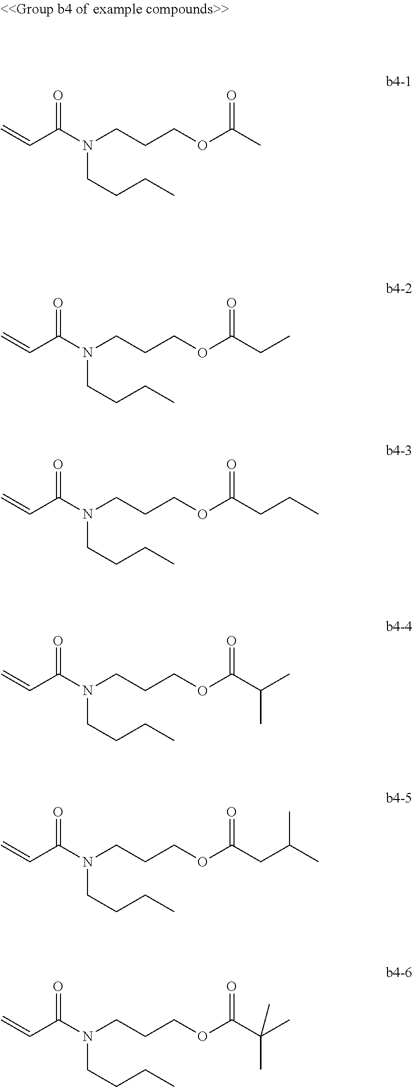

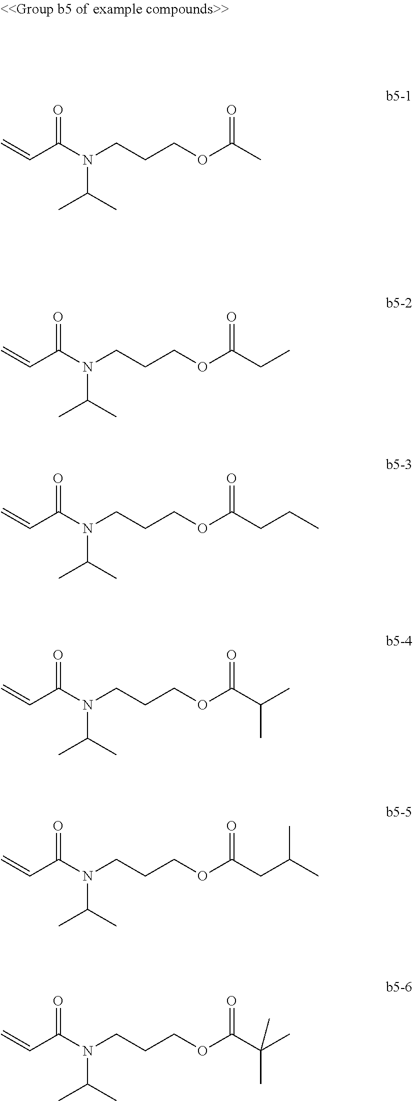

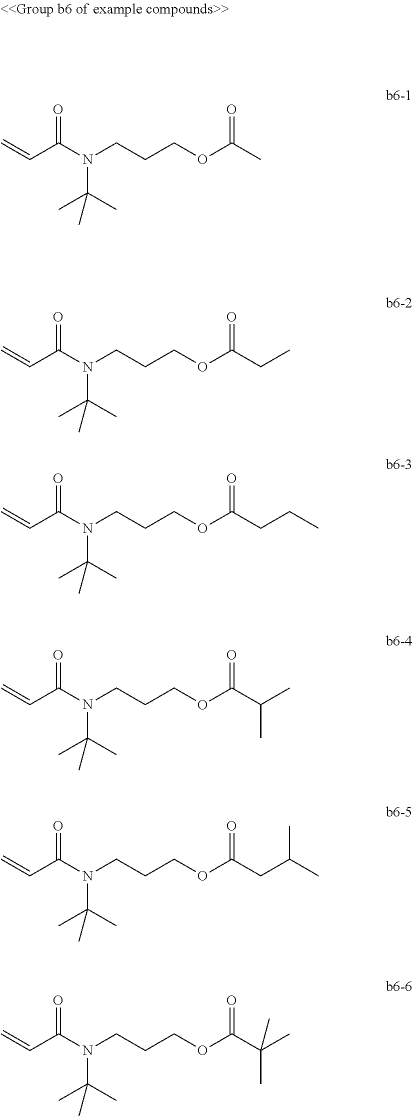

Examples of compounds in the group “c” include, but are not limited to, the compounds of the groups c1 to c6 presented below. One of these compounds may be used alone or two or more of these compounds may be used in combination.

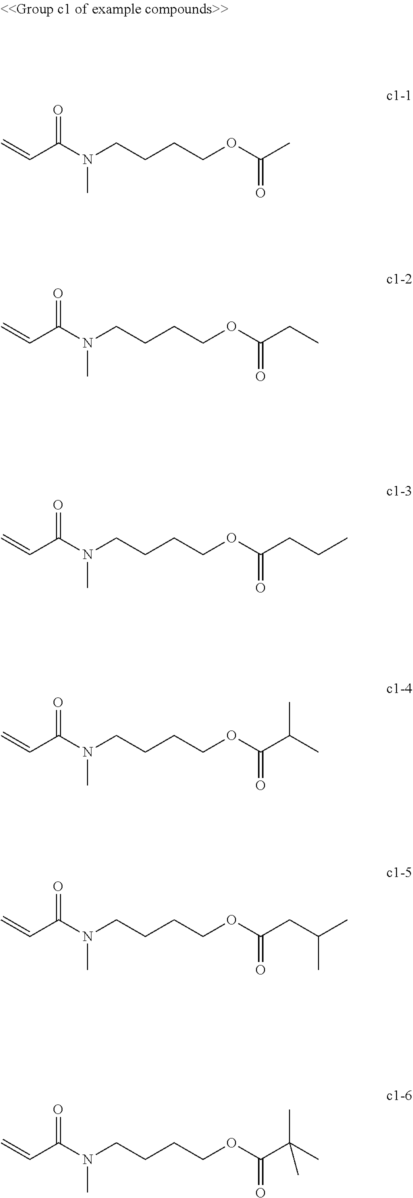

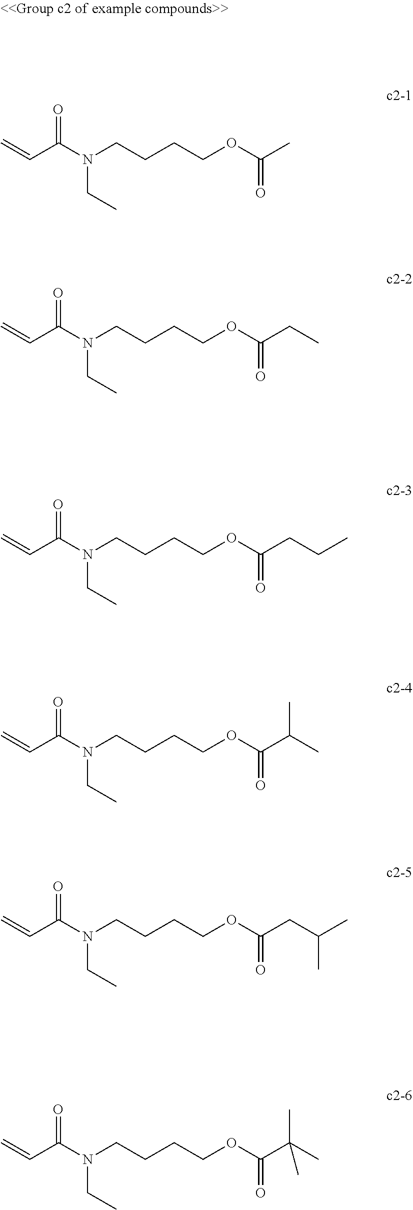

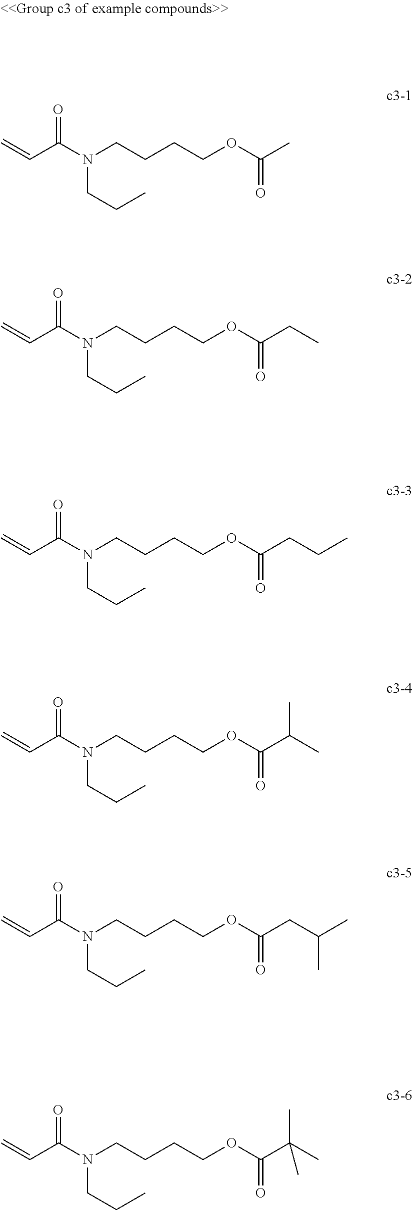

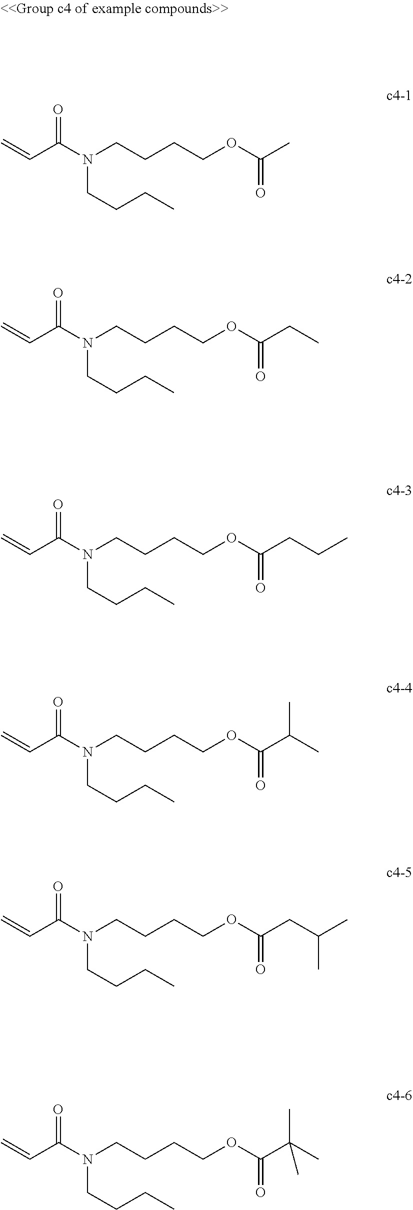

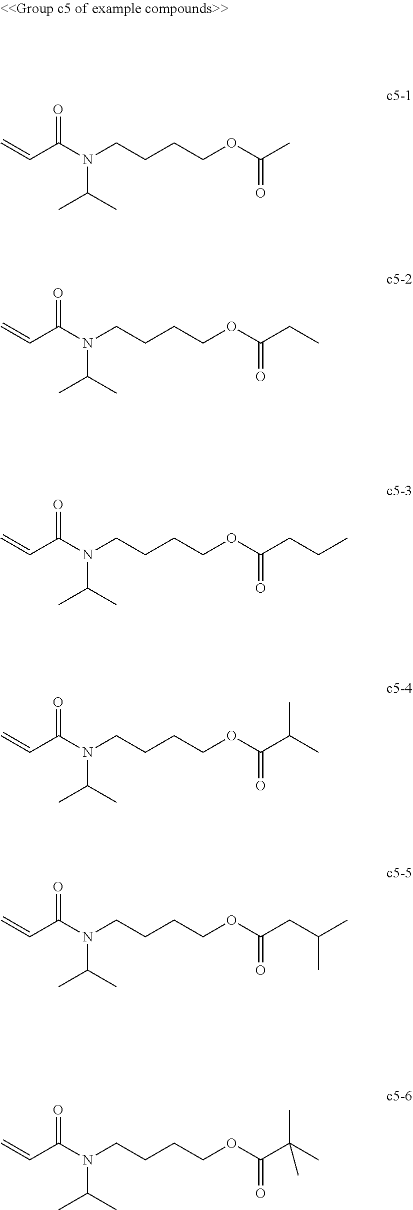

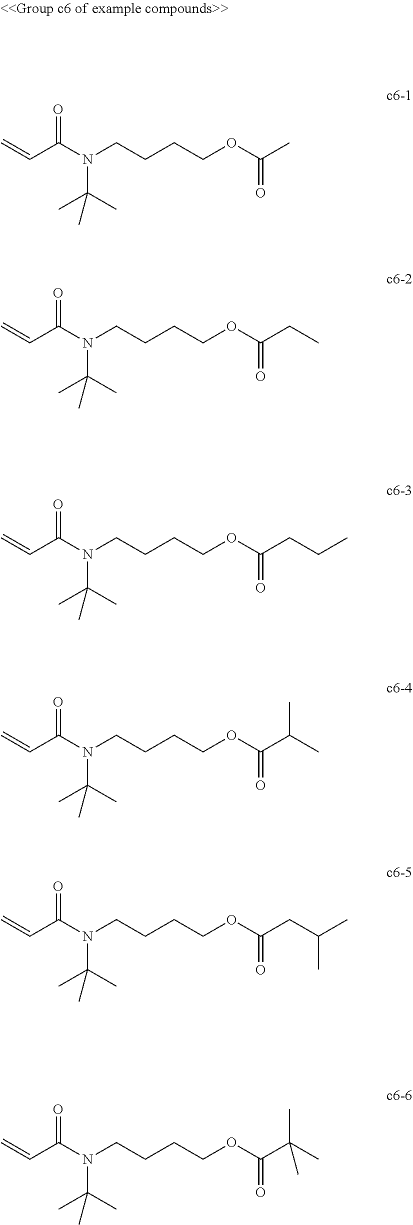

Examples of compounds in the group “d” include, but are not limited to, the compounds of the groups d1 to d6 presented below. One of these compounds may be used alone or two or more of these compounds may be used in combination.

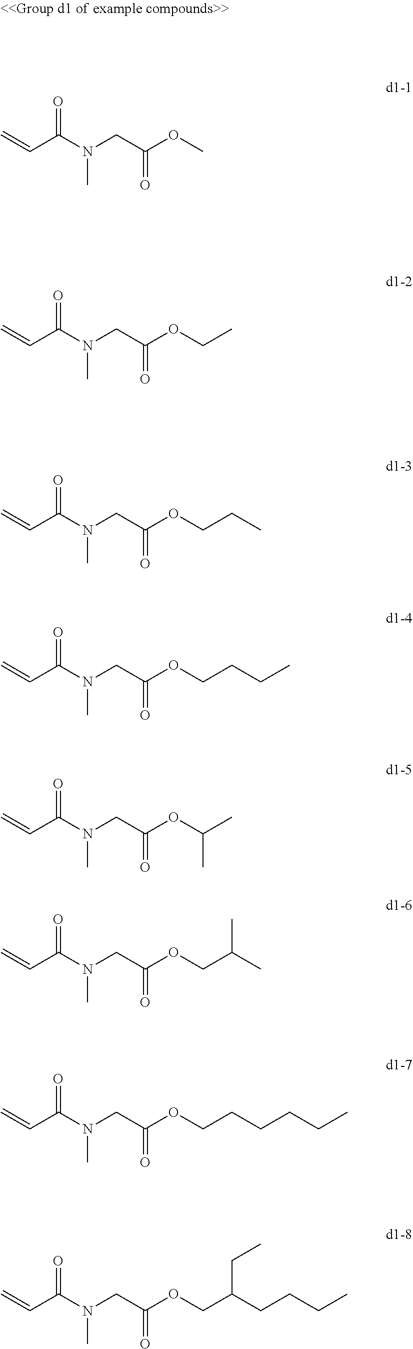

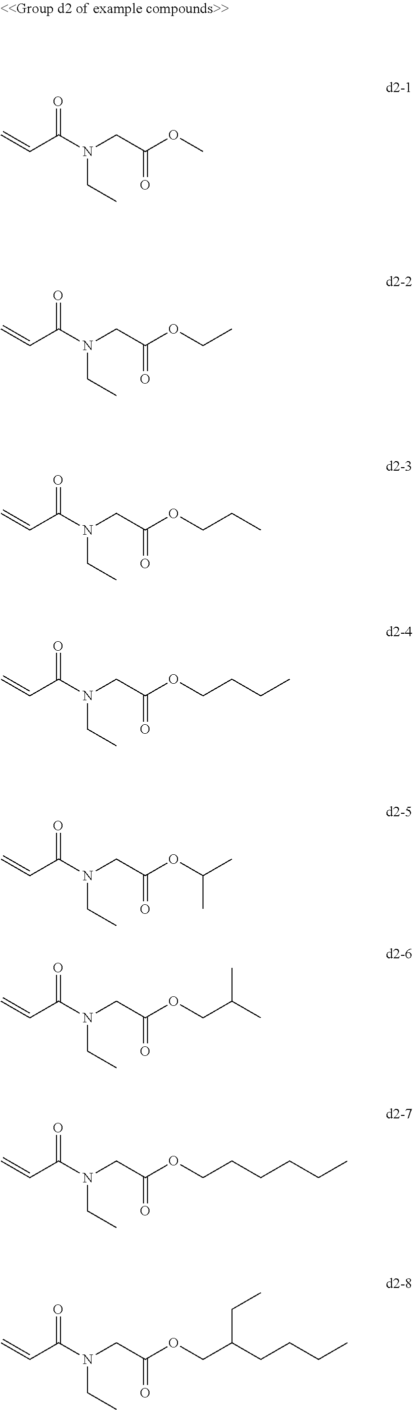

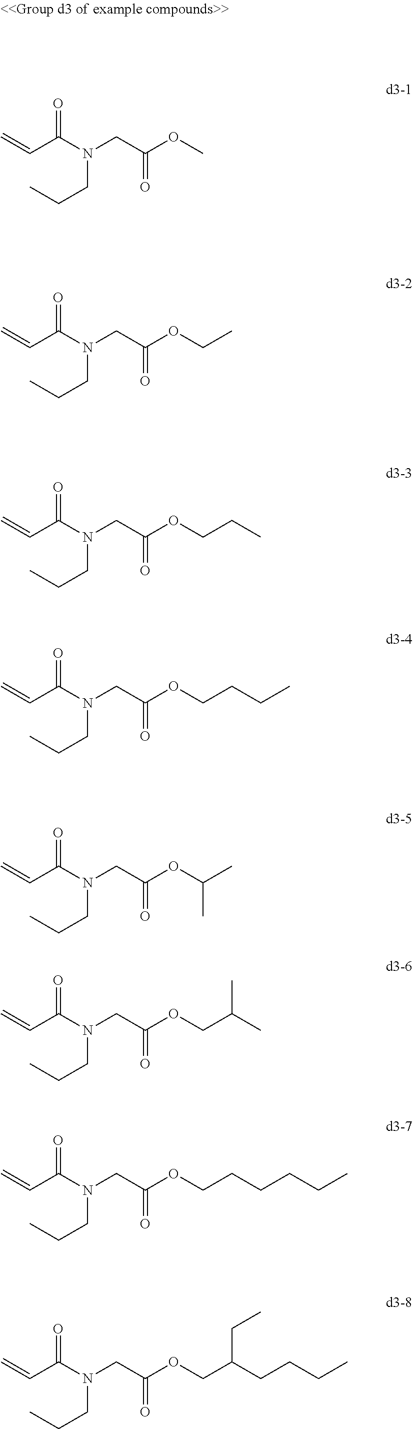

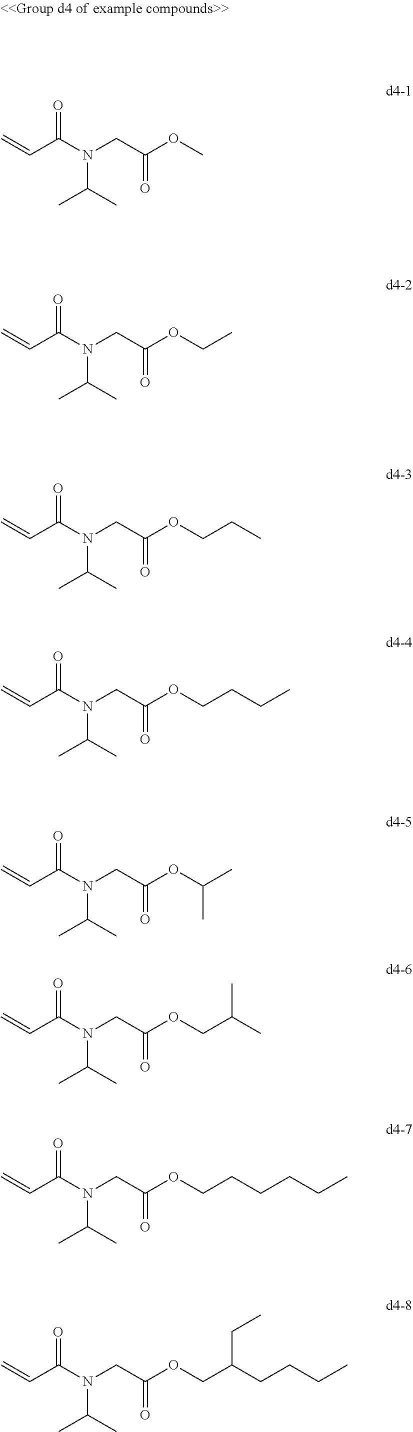

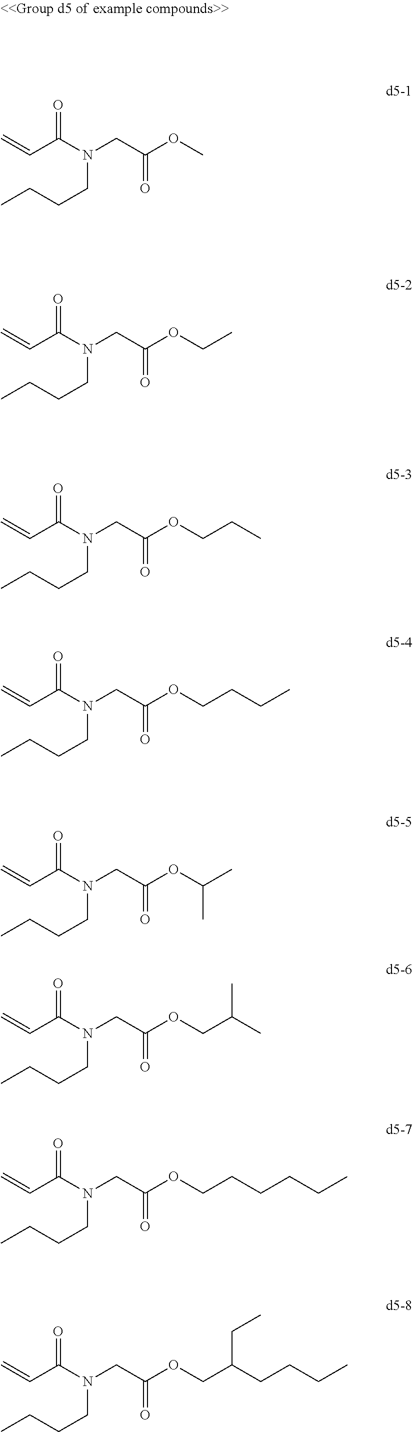

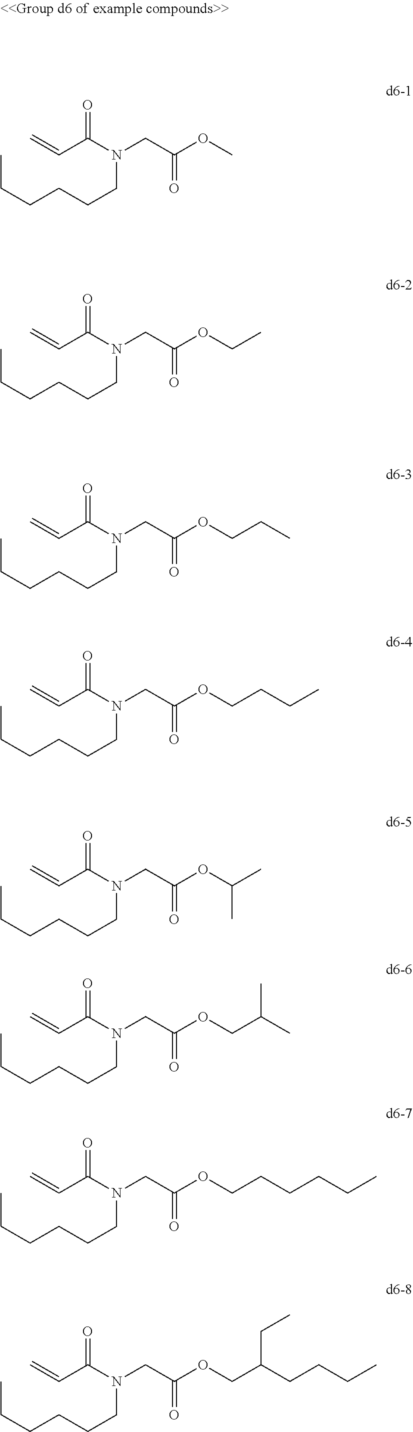

Examples of compounds in the group e include, but are not limited to, the compounds of the groups e1 to e6 presented below. One of these compounds may be used alone or two or more of these compounds may be used in combination.

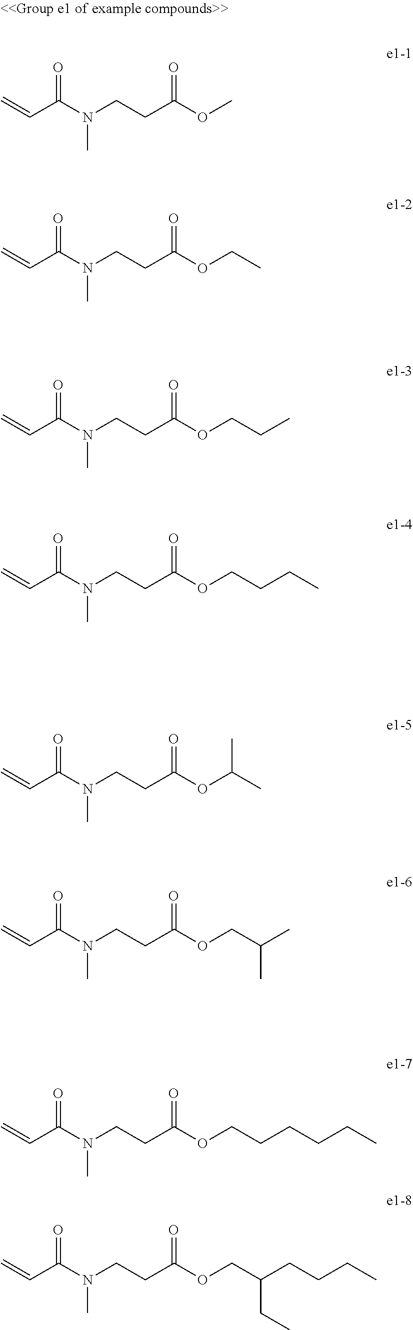

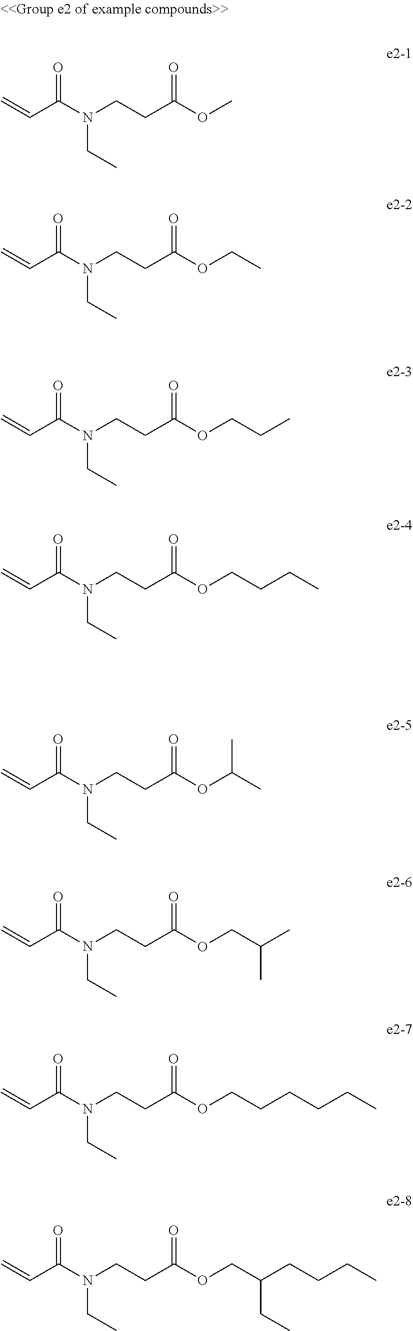

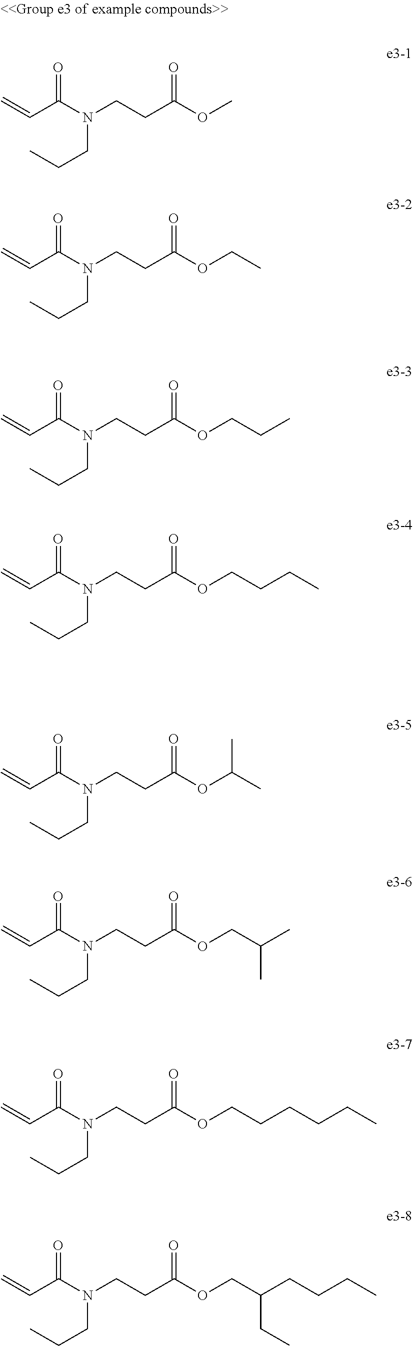

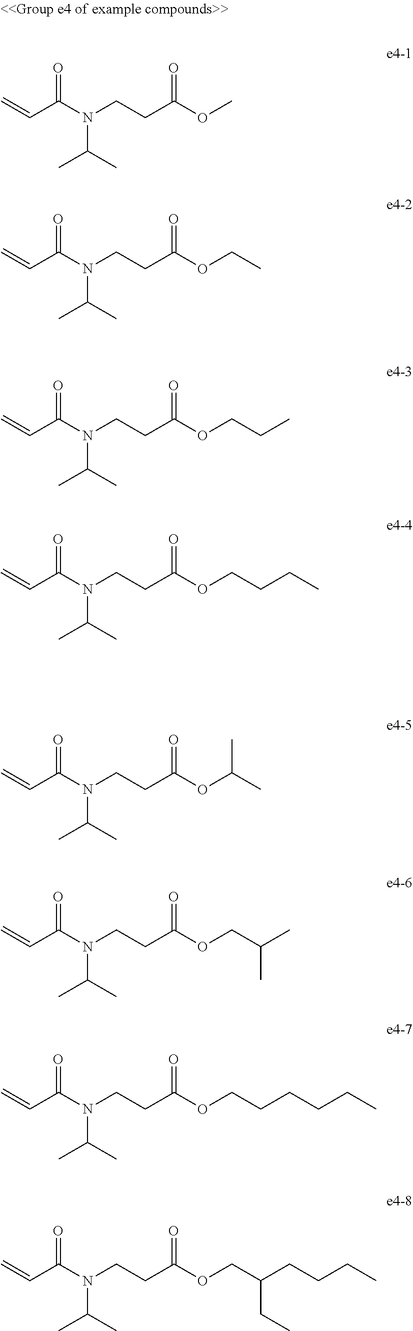

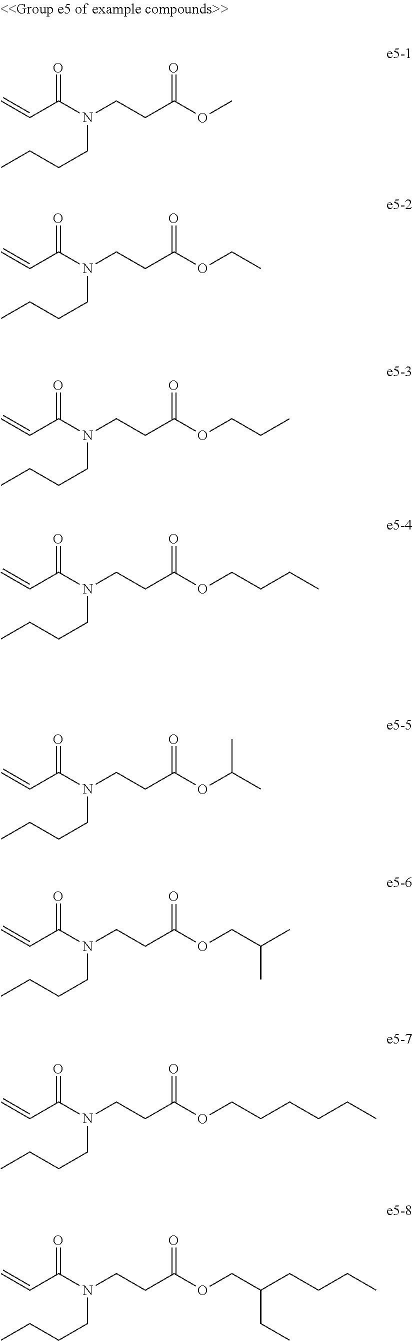

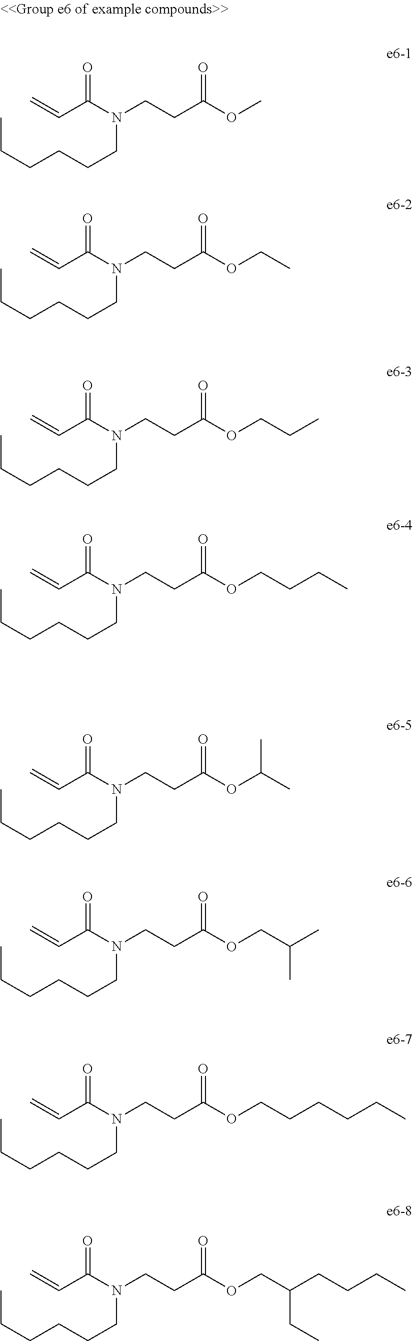

Examples of compounds in the group “f” include, but are not limited to, the compounds of the group f1 presented below. One of these compounds may be used alone or two or more of these compounds may be used in combination.

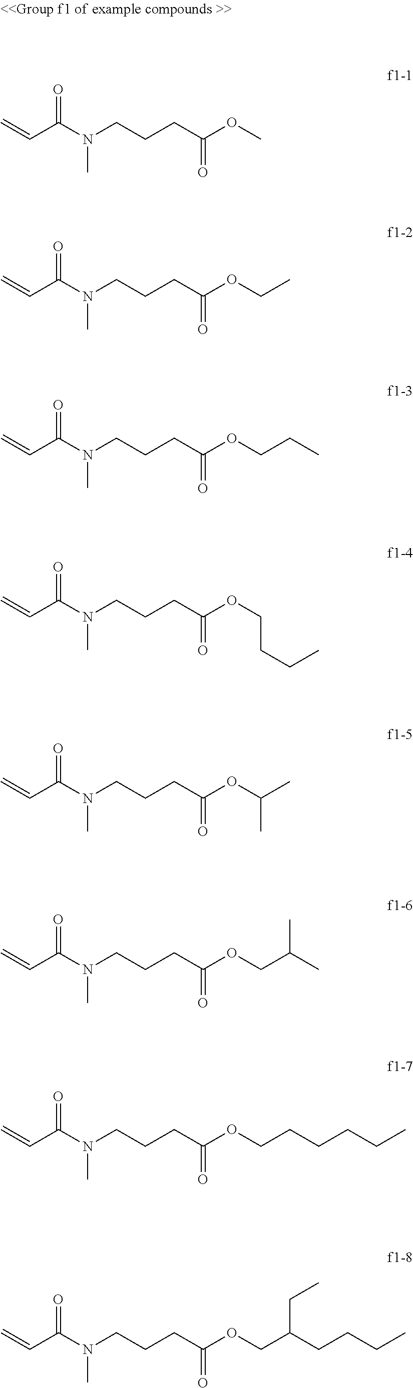

Examples of compounds in the group “g” include, but are not limited to, the compounds of the groups g1 to g6 presented below. One of these compounds may be used alone or two or more of these compounds may be used in combination.

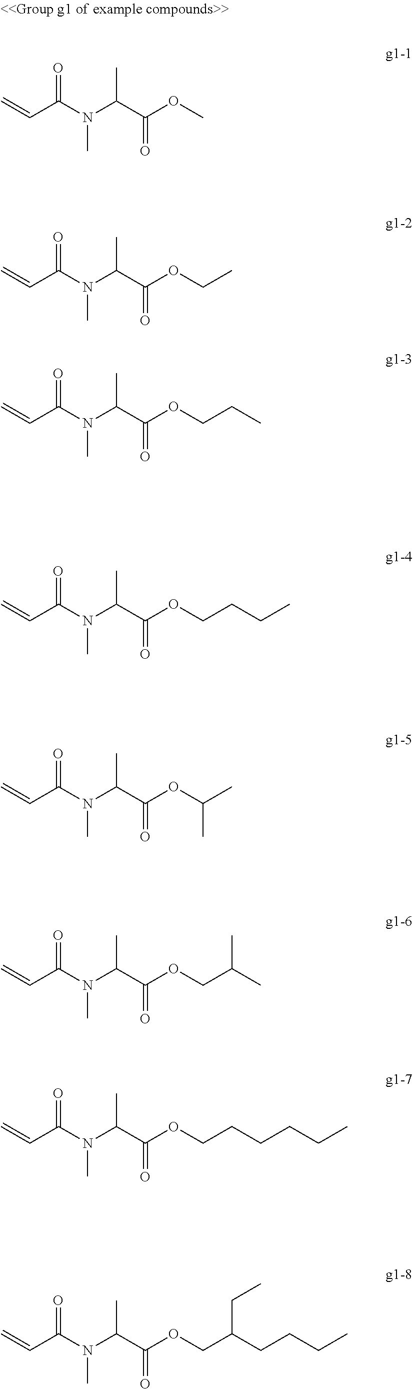

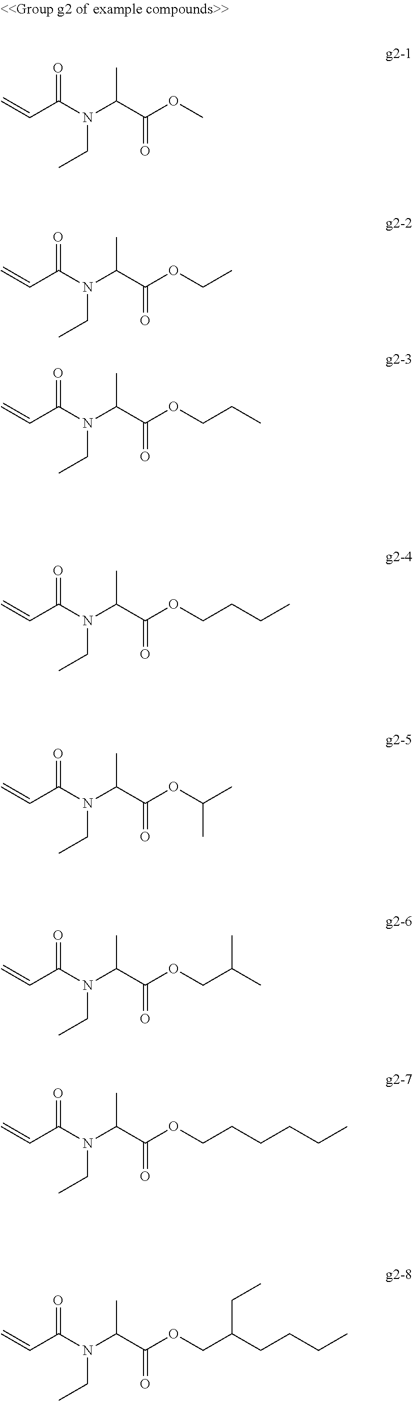

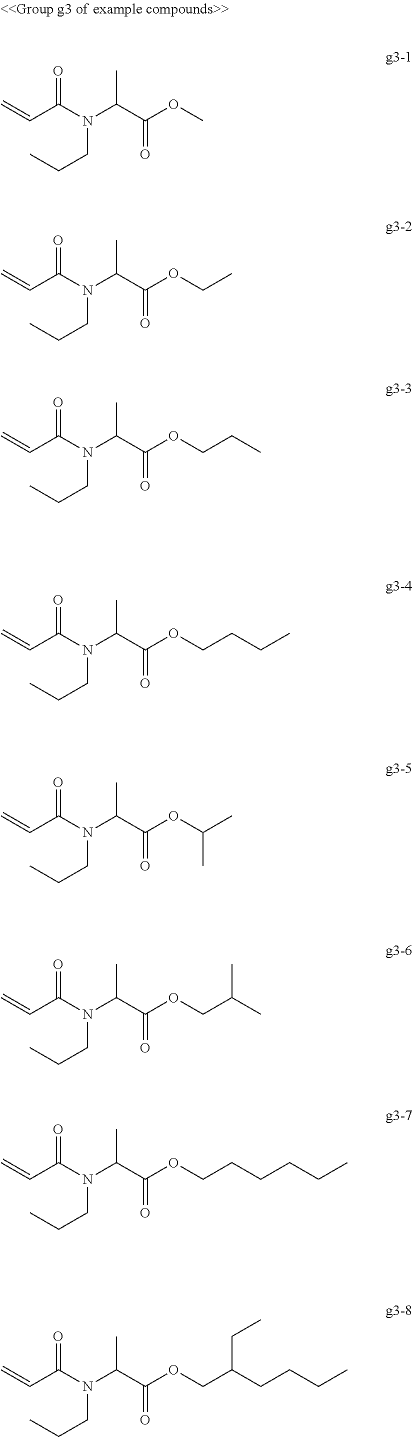

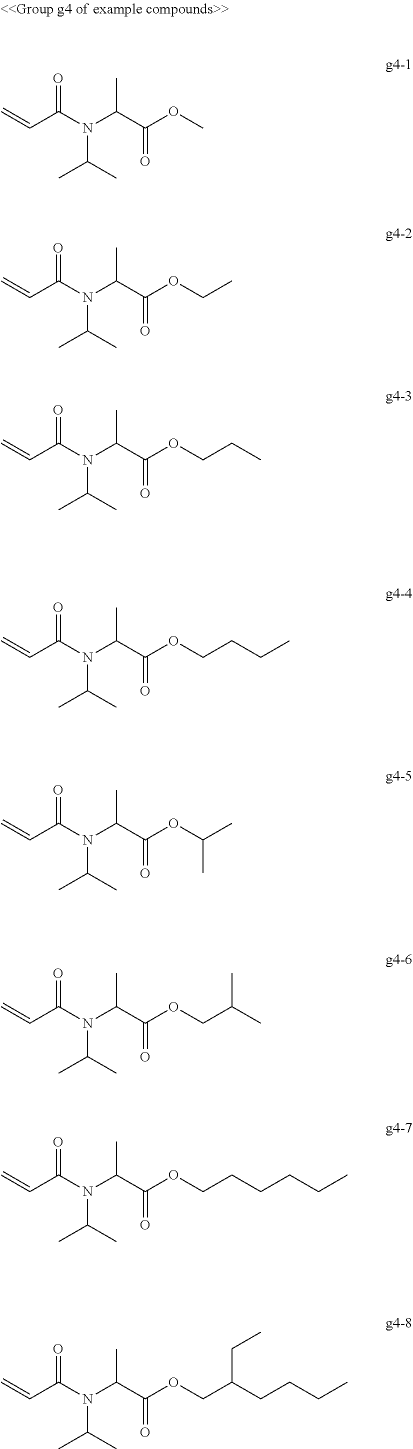

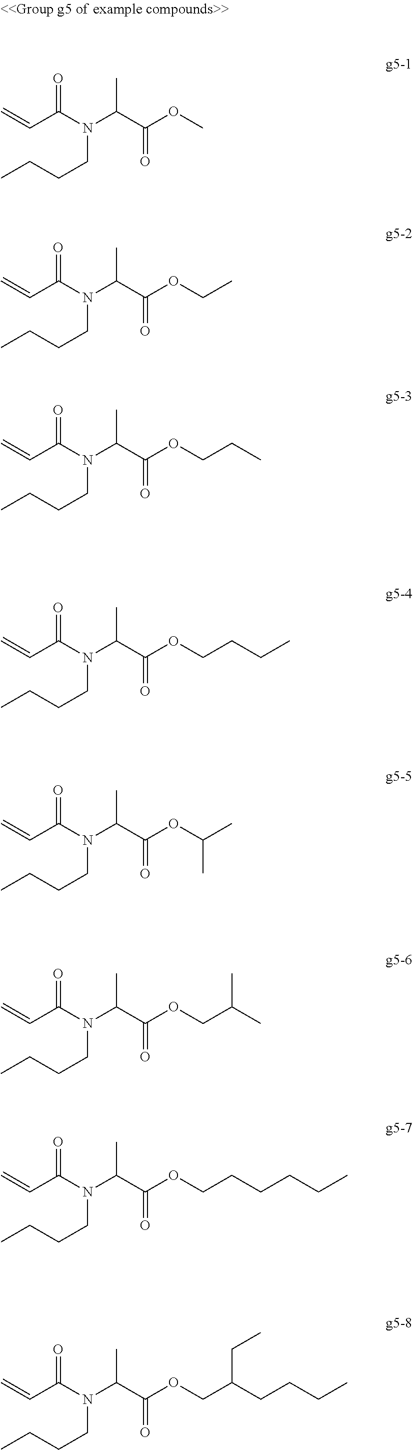

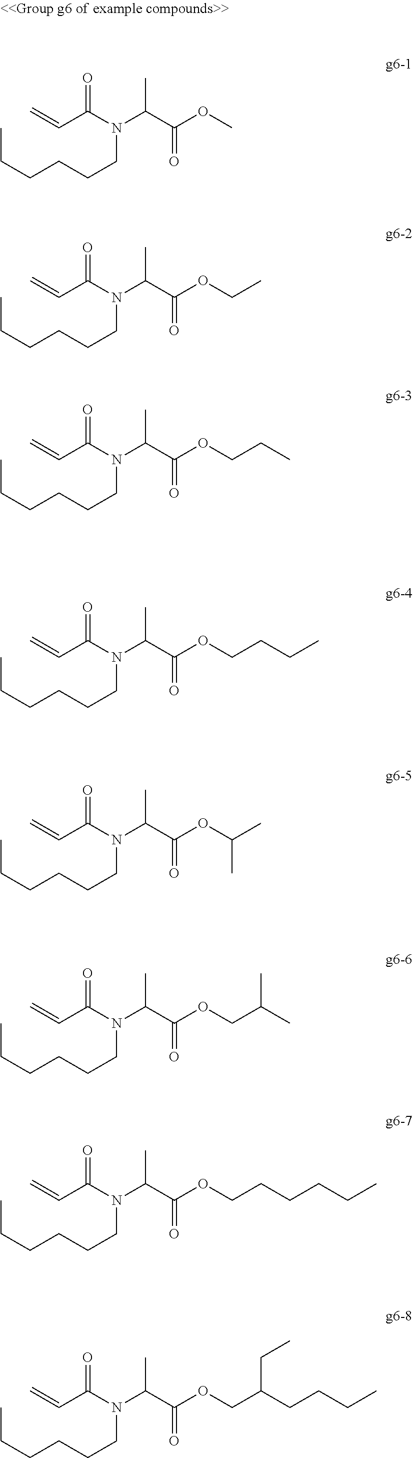

Examples of compounds in the group “h” include, but are not limited to, the compounds of the group h1 presented below. One of these compounds may be used alone or two or more of these compounds may be used in combination.

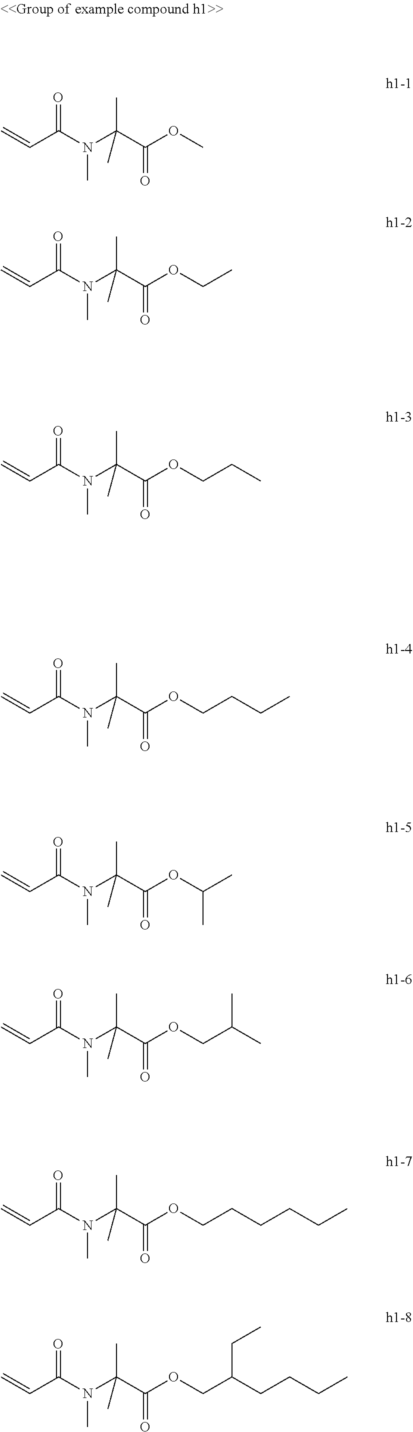

Examples of compounds in the group “i” include, but are not limited to, the compounds of the groups i1 and i2 presented below. One of these compounds may be used alone or two or more of these compounds may be used in combination.

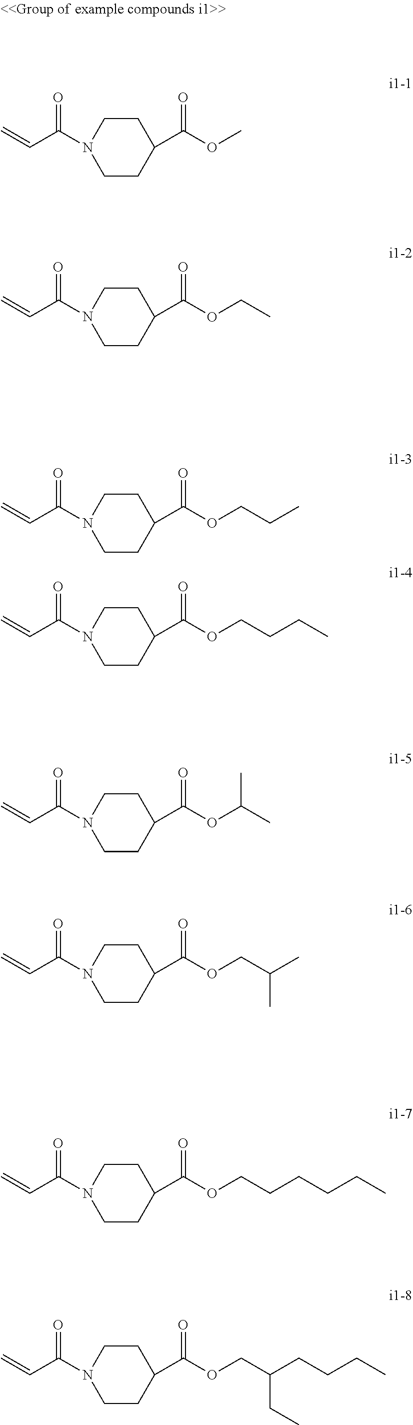

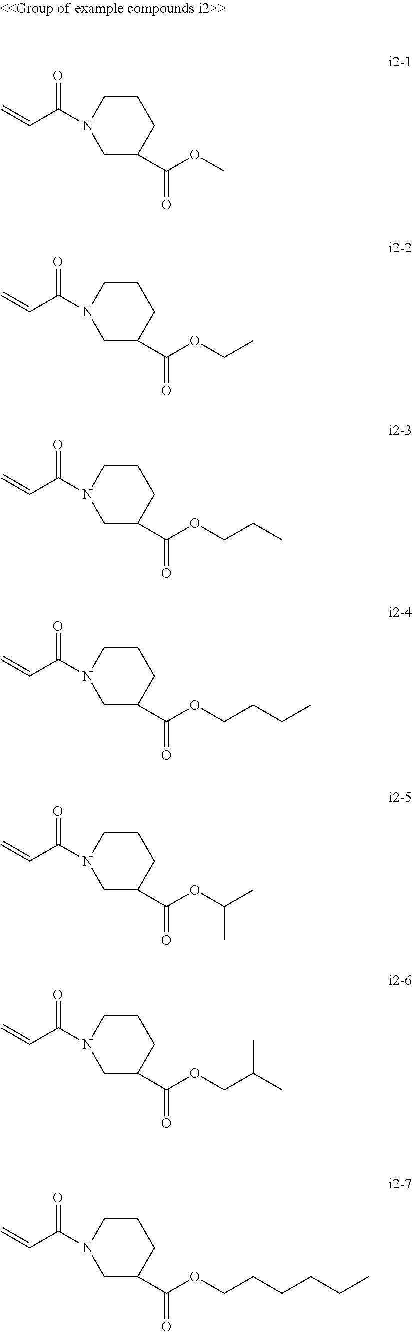

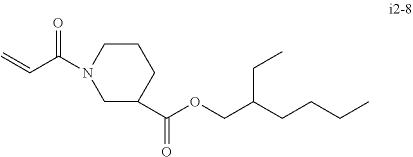 [SMILES: C=CC(=O)N1CCCC(C(=O)OCC(CC)CCCC)C1]

Among the group “a” to group “i” of example compounds, the polymerizable compound serving as a dispersion medium used for dispersing the pigment is preferably the example compound a1-1, the example compound a1-4, the example compound a6-1, the example compound d1-1, the example compound d1-2, the example compound d1-4, the example compound d1-5, the example compound d3-2, the example compound d4-1, the example compound d4-5, the example compound d6-1, the example compound d6-4, the example compound g1-1, the example compound g1-2, and the example compound g1-5, the example compound i1-2, and the example compound i2-2 in terms of dispersibility and low viscosity, and more preferably the example compound d1-1, the example compound d1-2, the example compound g1-1, the example compound g1-2, the example compound g1-5, the example compound i1-2, and the example compound i2-2 in terms of curability. Improvement of dispersibility makes the particle diameter distribution uniform and reduces excessively small particles and aggregating particles, making it possible to suppress inhibition of ultraviolet absorption, to improve curability, and to improve dischargeability at the same time.

### <Multifunctional Polymerizable Compound (A2) Having Skin Sensitization SI Value of 3 or Lower>

A multifunctional polymerizable compound (A2) having a skin sensitization SI value of 3 or lower is not particularly limited and may be appropriately selected depending on the intended purpose. Examples of the multifunctional polymerizable compound (A2) having a skin sensitization SI value of 3 or lower include, but are not limited to, ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, neopentyl glycol di(meth)acrylate, ethoxylated neopentyl glycol di(meth)acrylate, propoxylated neopentyl glycol di(meth)acrylate, pentaerythritol tri(meth)acrylate, pentaerythritol tetra(meth)acrylate, dipentaerythritol hexa(meth)acrylate, trimethylolpropane tri(meth)acrylate, and caprolactone-modified dipentaerythritol hexa(meth)acrylate. A (meth)acrylic acid ester refers to an acrylic acid ester or a methacrylic acid ester. The same applies to, for example, (meth)acrylate. One of these multifunctional polymerizable compounds may be used alone or two or more of these multifunctional polymerizable compounds may be used in combination.

Examples of the multifunctional polymerizable compound (A2) having a skin sensitization SI value of 3 or lower also include, but are not limited to, urethane (meth)acrylate derivatives obtained by allowing a compound containing an isocyanate group to undergo a reaction with (meth)acrylic acid esters containing a hydroxy group, and epoxy (meth)acrylate derivatives obtained by allowing a compound containing an epoxy group to undergo a reaction with (meth)acrylic acids.

In addition to the (meth)acrylic acid derivatives, vinyl ethers such as diethylene glycol divinyl ethers, triethylene glycol divinyl ethers, and cyclohexane dimethanol divinyl ethers, and allyl compounds such as diallyl phthalate and triallyl trimellitate may also be used.

It is preferable that the multifunctional polymerizable compound (A2) having a skin sensitization SI value of 3 or lower be contained in the composition by 1.0% by mass or greater but 60.0% by mass or less, more preferably by 5.0% by mass or greater but 40.0% by mass or less, and yet more preferably 10.0% by mass or greater but 30.0% by mass or less. One kind of the multifunctional polymerizable compound (A2) having a skin sensitization SI value of 3 or lower may be used alone or two or more kinds of the multifunctional polymerizable compound (A2) having a skin sensitization SI value of 3 or lower may be used in combination.

Combined use of multifunctional polymerizable compounds (A2) having a skin sensitization SI value of 3 or lower makes it possible to easily adjust curability and viscosity of the composition or hardness and adhesiveness of a cured product depending on the intended purpose.

<Polymerizable Compounds Other than A1 and A2>

Polymerizable compounds other than A1 and A2 are not particularly limited and may be appropriately selected depending on the intended purpose so long as the polymerizable compounds can undergo a polymerization reaction in response to active energy rays (e.g., ultraviolet rays and electron beams). One kind of the polymerizable compound may be used alone or two or more kinds of the polymerizable compound may be used in combination in terms of adjusting, for example, a reaction speed, ink properties, and cured film properties.

Examples of the polymerizable compounds include radical-polymerizable polymerizable compounds and polymerizable oligomers.

Examples of the radical-polymerizable polymerizable compound include, but are not limited to, (meth)acrylate compounds, (meth)acrylamide compounds, and aromatic vinyl compounds. One of these radical-polymerizable polymerizable compounds may be used alone or two or more of these radical-polymerizable polymerizable compounds may be used in combination. (Meth)acrylate as used herein refers to at least one of acrylate and methacrylate, and (meth)acrylic refers to at least one of acrylic and methacrylic.

### <<(Meth)Acrylate Compound>>

Examples of the (meth)acrylate compounds include, but are not limited to, monofunctional (meth)acrylates, bifunctional (meth)acrylates, trifunctional (meth)acrylates, tetrafunctional (meth)acrylates, pentafunctional (meth)acrylates, and hexafunctional (meth)acrylates. One of these (meth)acrylate compounds may be used alone or two or more of these (meth)acrylate compounds may be used in combination.

Examples of the monofunctional (meth)acrylates include, but are not limited to, hexyl(meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (meth)acrylate, 2-hydroxyethyl (meth)acrylate, 3-hydroxupropyl (meth)acrylate, 2-3-5 hydroxypropyl (meth)acrylate, 2-hydroxubutyl (meth)acrylate, 4-hydroxybutyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethyl succinic acid, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, ethylene oxide-modified phenol (meth)acrylate, ethylene oxide-modified cresol (meth)acrylate, ethylene oxide-modified nonylphenol (meth)acrylate, propylene oxide-modified nonylphenol (meth)acrylate, ethylene oxide-modified-2-ethylhexyl (meth)acrylate, 2-(2-vinyloxyethoxy)ethyl acrylate, and benzyl acrylate. One of these monofunctional (meth)acrylates may be used alone or two or more of these monofunctional (meth)acrylates may be used in combination. Among these monofunctional (meth)acrylates, phenoxyethyl (meth)acrylate, benzyl acrylate, acrylic acid-2-(2-vinyloxyethoxy)ethyl, 2-hydroxyethyl (meth)acrylate, 3-hydroxypropyl (meth)acrylate, 2-hydroxypropyl (meth)acrylate, and 4-hydroxubutyl (meth)acrylate are preferable for low viscosity, low odor, and high curability, and phenoxyethyl (meth)acrylate, benzyl acrylate, and acrylic acid-2-(2-vinyloxyethoxy)ethyl are particularly preferable in terms of compatibility with a photopolymerization initiator and other monomers.

Examples of the bifunctional (meth)acrylate include, but are not limited to, 1,6-hexanediol di(meth)acrylate, 1,10-decanediol di(meth)acrylate, neopentylglycol di(meth)acrylate, 2,4-dimethyl-1,5-pentanediol di(meth)acrylate, butylethylpropanediol (meth)acrylate, ethoxylated cyclohexanemethanol di(meth)acrylate, 2-ethyl-2-butyl-butanediol di(meth)acrylate, hydroxypivalic acid neopentyl glycol di(meth)acrylate, bisphenol F polyethoxy di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate, and tricyclodecane di(meth)acrylate. One of these bifunctional (meth)acrylates may be used alone or two or more of these bifunctional (meth)acrylates may be used in combination.

Examples of the trifunctional (meth)acrylate include, but are not limited to, trimethylolpropane tri(meth)acrylate, trimethylolethane tri(meth)acrylate, alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl)ether, isocyanuric acid alkylene oxide-modified tri(meth)acrylate, propionic acid dipentaerythritol tri(meth)acrylate, tri(meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate, and ethoxylated glycerin tri(meth)acrylate. One of these trifunctional (meth)acrylates may be used alone or two or more of these trifunctional (meth)acrylates may be used in combination.

Examples of the tetrafunctional (meth)acrylate include, but are not limited to, sorbitol tetra(meth)acrylate, ditrimethylolpropane tetra(meth)acrylate, and propionic acid dipentaerythritol tetra(meth)acrylate. One of these tetrafunctional (meth)acrylates may be used alone or two or more of these tetrafunctional (meth)acrylates may be used in combination.

Examples of the pentafunctional (meth)acrylate include, but are not limited to, sorbitol penta(meth)acrylate. One of these pentafunctional (meth)acrylates may be used alone or two or more of these pentafunctional (meth)acrylates may be used in combination.

Examples of the hexafunctional (meth)acrylate include, but are not limited to, dipentaerythritol hexa(meth)acrylate, sorbitol hexa(meth)acrylate, phosphazene alkylene-oxide-modified hexa(meth)acrylate, and caprolactone-modified dipentaerythritol hexa(meth)acrylate. One of these hexafunctional (meth)acrylates may be used alone or two or more of these hexafunctional (meth)acrylates may be used in combination.

### <<(Meth)Acrylamide Compound>>

Examples of the (meth)acrylamide compound include, but are not limited to, (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, (meth)acryloylmorpholine, and hydroxyethyl (meth)acrylamide. One of these (meth)acrylamide compounds may be used alone or two or more of these (meth)acrylamide compounds may be used in combination. Among these (meth)acrylamide compounds, (meth)acryloylmorpholine is preferable.

### <<Aromatic Vinyl Compound>>

Examples of the aromatic vinyl compound include, but are not limited to, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, vinyl benzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene, and 4-t-butoxystyrene. One of these aromatic vinyl compounds may be used alone or two or more of these aromatic vinyl compounds may be used in combination.

### <<Polymerizable Oligomer>>

It is preferable that the polymerizable oligomer contain one or more ethylenically unsaturated double bonds. An oligomer means a polymer containing 2 or more but 20 or less monomer structure repeating units.

The weight average molecular weight of the polymerizable oligomer is not particularly limited, may be appropriately selected depending on the intended purpose, and is preferably 1,000 or greater but 30,000 or less and more preferably 5,000 or greater but 20,000 or less by polystyrene equivalent. The weight average molecular weight can be measured by, for example, gel permeation chromatography (GPC).

Examples of the polymerizable oligomer include, but are not limited to, urethane acrylic oligomer (e.g., aromatic urethane acrylic oligomers and aliphatic urethane acrylic oligomers), epoxy acrylate oligomers, polyester acrylate oligomers, and other special oligomers. One of these polymerizable oligomers may be used alone or two or more of these polymerizable oligomers may be used in combination. Among these polymerizable oligomers, oligomers containing two or more but five or less unsaturated carbon-carbon bonds are preferable, and oligomers containing two unsaturated carbon-carbon bonds are more preferable. When the number of unsaturated carbon-carbon bonds is two or more but five or less, a good curability can be obtained.

A commercially available product may be used as the polymerizable oligomer. Examples of the commercially available product include, but are not limited to, UV-2000B, UV-2750B, UV-3000B, UV-3010B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 available from Nippon Synthetic Chemical Industry Co., Ltd.; CN902, CN902J75, CN929, CN940, CN944, CN944B85, CN959, CN961E75, CN961H81, CN962, CN963, CN963A80, CN963B80, CN963E75, CN963E80, CN963J85, CN964, CN965, CN965A80, CN966, CN966A80, CN966B85, CN966H90, CN966J75, CN968, CN969, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 available from Sartomer USA, LLC; EBECRYL210, EBECRYL220, EBECRYL230, EBECRYL270, KRM8200, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270, EBECRYL8311, and EBECRYL8701 available from Daicel-Cytec Co., Ltd. One of these commercially available products may be used alone or two or more of these commercially available products may be used in combination.

Synthetic products obtained by synthesis may be used instead of commercially available products. Synthetic products and commercially available products may be used in combination.

In terms of dispersibility and low viscosity, it is preferable to use the acrylamide compound having an ester structure represented by General formula (1) or General formula (4) as the dispersion medium used for dispersing the pigment. Improvement of dispersibility makes the particle diameter distribution uniform and reduces excessively small particles and aggregating particles, making it possible to suppress inhibition of ultraviolet absorption, improve curability, and improve dischargeability at the same time.

The polymerizable compound used as the dispersion medium is preferably the compounds presented as the compounds of the group “a” to group “h” of example compounds. One of these compounds may be used alone or two or more of these compounds may be used in combination.

### <Pigment-Adsorptive Component B>

The pigment dispersion composition of the present disclosure contains a pigment-adsorptive component. Adsorption of the pigment-adsorptive component to the surface of the pigment enables a good affinity balance between the pigment and the dispersion medium, and enables improvement of wettability of the pigment over the dispersion medium.

A great polarity difference between the pigment-adsorptive component and the polymerizable compound used as the dispersion medium makes adsorption between the pigment and the dispersion medium unstable, leading to degradation of wettability and degradation of storage/dispersion stability.

Examples of the pigment-adsorptive component include resin components that have an effect of imparting wettability over a dispersion medium and an effect of imparting dispersion stability in the medium to the pigment, and can coat dispersant polymers and pigments. As the dispersant polymer, a block copolymer formed of a hydrophobic block and a hydrophilic block can be used. With the hydrophilic block oriented over the surface of the pigment and the hydrophobic block spread to the dispersion medium, a steric hindrance effect is obtained, making it possible to obtain a high dispersion stability. On the other hand, the coating is for coating the surface of the pigment with a resin to reduce the surface activity of the pigment and impart dispersibility in the medium, to enable the pigment to be dispersed. The dispersant polymer may be an acrylic block copolymer which can be obtained by allowing polyester, polyurethane, and acrylic-based copolymers to undergo a reaction with polyamine.

When the polymerizable compound that forms the dispersion medium is the acrylamide compound (A1) having an ester structure represented by General formula (1) or General formula (4), a polarity difference is low and adsorption of the pigment-adsorptive component is stabilized. This generates a steric repulsion effect through the adsorption, making it possible to obtain a good storage/dispersion stability. Therefore, an active-energy-ray-curable composition and an ink that uses the acrylamide compound (A1) can obtain a good white hiding power, liquid permeability, curability, dischargeability, and adhesiveness.

The pigment-adsorptive component that is not adsorbed to the pigment needs to be contained in a certain amount, which is from 15% by mass through 50% by mass of the amount of the pigment-adsorptive component adsorbed to the pigment. When the amount of the pigment-adsorptive component not adsorbed to the pigment is less than 15% by mass, the pigment-adsorptive component adsorbed to the pigment transfers to the dispersion medium, to degrade dispersion stability of the pigment. When the amount of the pigment-adsorptive component not adsorbed to the pigment is greater than 50% by mass, not only liquid permeability and dischargeability degrade, but also a factor of inhibiting curing may be formed to degrade film properties. The pigment-adsorptive component not adsorbed to the pigment is considered one of the factors that increases thixotropy of the ink. Increased thixotropy may degrade liquid permeability during filtration of the ink, and degrade ink dischargeability through occurrence of nozzle stains with mist.

The amount of the pigment-adsorptive component adsorbed to the pigment is affected not only by the blending amount of the pigment-adsorptive component and the physical properties of the pigment-adsorptive component such as acid value and amine value, but also by the particle diameter, the surface treated condition, and the dispersing conditions of the pigment.

The content of the pigment-adsorptive component of the pigment dispersion composition is preferably 10% by mass or greater but 80% by mass or less and more preferably 15% by mass or greater but 70% by mass or less relative to the total amount of the pigment. When the content of the pigment-adsorptive component is 10% by mass or greater, dispersibility can be secured through a steric repulsion effect of the pigment-adsorptive component adsorbed to the pigment. When the content of the pigment-adsorptive component is 80% by mass or less, the amount of the pigment-adsorptive component not adsorbed to the pigment is low, making it possible to reduce the viscosity of the composition. Moreover, because the amount of the pigment-adsorptive component not adsorbed is low, increase of thixotropy of the ink is suppressed, leading to improvement of liquid permeability and dischargeability. Furthermore, the content of the pigment-adsorptive component not adsorbed affects the film properties. Therefore, a low content of the pigment-adsorptive component not adsorbed leads to reduction of components that inhibit curing of the film, and is expected to also improve curability and adhesiveness with a base material.

Examples of the dispersant polymer include, but are not limited to, hydroxyl group-containing carboxylic acid ester, salts of long-chain polyaminoamide with high-molecular-weight acid esters, salts of high-molecular-weight polycarboxylic acids, salts of long-chain polyaminoamide with polar acid esters, high-molecular-weight unsaturated acid esters, modified polyurethane, modified polyacrylate, polyether ester-type anionic activators, salts of naphthalene sulfonic acid formalin condensate, polyoxyethylene alkylphosphoric acid ester, polyoxyethylene nonylphenyl ether, polyester polyamine, and stearylamine acetate. One of these dispersant polymers may be used alone or two or more of these dispersant polymers may be used in combination. Use of the dispersant polymer makes it possible to improve a steric repulsion effect that accompanies adsorption of the dispersant, and obtain a high dispersion stability. The dispersant polymer means a polymer having a weight average molecular weight of 1,000 or greater.

Examples of the dispersant polymer further include basic functional group-containing copolymers, acrylic block copolymers, and copolymers each containing an alkylol ammonium salt and an acid group. One of these dispersant polymers may be used alone or two or more of these dispersant polymers may be used in combination.

The basic functional group-containing copolymer is a copolymer containing a basic functional group. Examples of the basic functional group include, but are not limited to, basic polar functional groups such as an amino group, an imino group, an amide group, an imide group, and a nitrogen-containing heterocyclic group.

With a basic polar functional group, adsorption of the basic functional group-containing copolymer to the surface of the pigment is facilitated, making it possible to improve storage stability. The basic functional group-containing copolymer is preferably a copolymer containing an amino group in terms of adsorptivity to the pigment, dispersibility in polymerizable compounds, and viscosity suppressibility of the pigment dispersion composition

The acrylic block copolymer is a block copolymer containing a plurality of (meth)acrylic polymer segments obtained by polymerizing (meth)acrylic monomers. Examples of the acrylic block copolymer include, but are not limited to, a block copolymer containing a hydrophobic block and a hydrophilic block. When the dispersant polymer is an acrylic block copolymer containing a hydrophobic block and a hydrophilic block, the hydrophilic block is oriented toward the surface of the pigment and the hydrophilic block is spread toward the dispersion medium side, achieving high storage stability due to the steric repulsion effect. When the surface of the pigment is covered with the acrylic block copolymer, the surface activity of the pigment is reduced and the dispersibility of the pigment in the dispersion medium is increased, achieving highly-dispersed state.

Examples of the copolymer containing an alkylol ammonium salt and an acid group include, but are not, limited to, random copolymers and block copolymers each containing a structural unit derived from a (meth)acryloyl alkylol ammonium salt and an acid group such as a structural unit derived from (meth)acrylic acid.

The amine value of the dispersant polymer is preferably 10 mgKOH/g or greater but 100 mgKOH/g or less and more preferably 20 mgKOH/g or greater but 85 mgKOH/g or less. When the amine value of the dispersant polymer is 10 mgKOH/g or greater but 100 mgKOH/g or less, it is considered possible to suppress proceeding of a polymerization reaction with the polymerizable compound, which is a component of the composition, during a long time of storage or during heating, and it is estimated that the composition undergoes a slight viscosity change even during a long time of storage or heating, and has a high storage stability. To obtain the amine value, the polymer dispersant (1 g) is dissolved in methyl isobutyl ketone (100 mL), and potentiometrically titrated with an automatic titrator (instrument name: GT-200, available from Mitsubishi Chemical Analytech Co., Ltd.) using a 0.01 mol/L methyl isobutyl ketone chlorate solution, to measure a potential difference. The amine value can be calculated based on the obtained potential difference.

As the dispersant polymer, a commercially available product can be used. Examples of commercially available products of the basic functional group-containing copolymers include, but are not limited to, SOLSPERSE series available from Nippon Lubrizol Corporation such as product name: SOLSPERSE 20000 (with an amine value of 35.9 mgKOH/g), product name: SOLSPERSE 24000 (with an amine value of 41.6 mgKOH/g), product name: SOLSPERSE 32000 (with an amine value of 31.2 mgKOH/g), product name: SOLSPERSE 33000 (with an amine value of 43.0 mgKOH/g), product name: SOLSPERSE 35000 (with an amine value of 32.0 mgKOH/g), product name: SOLSPERSE 56000 (with an amine value of 39.0 mgKOH/g), product name: SOLSPERSE 71000 (with an amine value of 75.0 mgKOH/g), product name: SOLSPERSE 73000 (with an amine value of 80.0 mgKOH/g), product name: SOLSPERSE 74000 (with an amine value of 81.0 mgKOH/g), product name: SOLSPERSE 88000 (with an amine value of 33.0 mgKOH/g), and product name: SOLSPERSE J200 (with an amine value of 18.6 mgKOH/g), DISPERBYK series available from Byk-Chemie Japan K.K. such as product name: DISPERBYK-162 (with an amine value of 13 mgKOH/g), product name: DISPERBYK-163 (with an amine value of 10 mgKOH/g), and product name: DISPERBYK-168 (with an amine value of 11 mgKOH/g). One of these may be used alone or two or more of these may be used in combination.

Examples of commercially available products of the acrylic block copolymers include, but are not limited to, DISPERBYK series available from Byk-Chemie Japan K.K. such as product name: DISPERBYK-2050 (with an amine value of 30.7 mgKOH/g), product name: DISPERBYK-2055 (with an amine value of 45.1 mgKOH/g), product name: DISPERBYK-2150 (with an amine value of 56.7 mgKOH/g), and product name: DISPERBYK-2155 (with an amine value of 52.5 mgKOH/g). One of these may be used alone or two or more of these may be used in combination.

Examples of commercially available products of the copolymers containing an alkylol ammonium salt and an acid group include, but are not limited to, product name: DISPERBYK-140 (with an amine value of 76.0 mgKOH/g) and product name: DISPERBYK-180 (with an amine value of 94.0 mgKOH/g). One of these may be used alone or two or more of these may be used in combination.

Examples of commercially available products of the dispersant polymer further include, but are not limited to, BYKJET series available from Byk-Chemie Japan K.K. such as product name: BYKJET-9151 (with an amine value of 17.2 mgKOH/g) and product name: BYKJET-9152 (with an amine value of 27.3 mgKOH/g), and AJISPER series available from Ajinomoto Fine-Techno Co., Inc. such as product name: AJISPER PB821 (with an amine value of 11.2 mgKOH/g), product name: AJISPER PB822 (with an amine value of 18.2 mgKOH/g), and product name: AJISPER PB881 (with an amine value of 17.4 mgKOH/g).

The content of the dispersant polymer is preferably 10% by mass or greater but 70% by mass or less, more preferably 15% by mass or greater but 60% by mass or less, and particularly preferably 15% by mass or greater but 40% by mass or less, relative to the total amount of the pigment. When the content of the dispersant polymer is 10% by mass or greater, dispersibility can be improved through a steric repulsion effect of the dispersant polymer adsorbed to the pigment. When the content of the dispersant polymer is 70% by mass or less, the amount of the dispersant polymer free and not adsorbed to the pigment is low, making it possible to reduce the viscosity of the ink.

Moreover, because the amount of the dispersant polymer not adsorbed is low, increase of thixotropy of the ink is suppressed, leading to improvement of liquid permeability and dischargeability. In addition, the amount of the dispersant polymer not adsorbed affects the film properties. A low amount of the dispersant polymer not adsorbed leads to reduction of components that inhibit curing of the film, and is expected to improve curability and adhesiveness with a base material.

### <Active Energy Rays>

Active energy rays used for curing the active-energy-ray-curable composition of the present disclosure are not particularly limited, so long as they are able to give necessary energy for allowing polymerization reaction of polymerizable components in the composition to proceed. Examples of the active energy rays include, but are not limited to, electron beams, α-rays, ß-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable. In particular, those emitting light having a wavelength of from 365 to 405 nm are preferred for their high efficiency and low cost.

### <Polymerization Initiator C>

The polymerization initiator produces active species such as a radical or a cation upon application of energy of an active energy ray and initiates polymerization of a polymerizable compound (monomer or oligomer). As the polymerization initiator, it is suitable to use a known radical polymerization initiator, cation polymerization initiator, or a combination thereof. Of these, a radical polymerization initiator is preferable. Moreover, the polymerization initiator preferably accounts for 5 percent by weight to 20 percent by weight of the total content of the active-energy-ray-curable composition to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds. One of these radical polymerization initiators may be used alone or two or more of these radical polymerization initiators may be used in combination.

In addition, a polymerization accelerator is optionally used together with the polymerization initiator.

The polymerization accelerator is not particularly limited. Examples of the polymerization accelerator include, but are not limited to, amine compounds such as ethyl p-dimethylaminobenzoate, 2-ethylhexyl p-dimethylaminobenzoate, methyl p-dimethylaminobenzoate, 2-dimethylaminoethyl benzoate, and butoxyethyl p-dimethylaminobenzoate. One of these polymerization accelerators may be used alone or two or more of these polymerization accelerators may be used in combination.

### <Hydrogen Donor D>

Polymerization of the active-energy-ray-curable composition of the present disclosure is initiated by a compound having, for example, a benzophenone skeleton through a polymerization initiation mechanism described below. That is, a compound having, for example, a benzophenone skeleton becomes an excited state in response to light irradiation. Then, the excited molecule withdraws hydrogen from a surrounding compound, and a radical is produced on the compound from which hydrogen is withdrawn and serves as a radical polymerization initiation point. As a result, the compound having, for example, a benzophenone skeleton exerts a function as a photo radical polymerization initiator. That is, when a compound from which hydrogen may be withdrawn is co-present with the compound having, for example, a benzophenone skeleton, polymerization is initiated through the polymerization initiation mechanism described above. Hence, for example, if hydrogen is withdrawn from a radical polymerizable compound used in the present disclosure, there is a possibility that polymerization is initiated from where hydrogen is withdrawn.

A hydrogen-donating compound from which hydrogen is easily withdrawn may be allowed to be co-present with the active-energy-ray-curable composition of the present disclosure. In this case, hydrogen may be handed over more smoothly from the hydrogen-donating compound to the molecule of the compound having, for example, a benzophenone skeleton excited in response to light irradiation, and polymerization may proceed more efficiently. That is, addition of a polymerization initiator (C1) that does not absorb light in a wavelength range of from 365 nm through 405 nm makes it possible to significantly improve polymerization reactivity while maintaining low yellowing.

The hydrogen-donating compound used in the present disclosure needs at least to be a compound that can smoothly donate hydrogen to the molecule of a compound having, for example, a benzophenone skeleton excited in response to light irradiation.

Preferable examples of such a compound include, but are not limited to, amino group-containing compounds such as diethylamine, diphenylamine, triethylamine, tributylamine, diethanolamine, triethanolamine, N,N-diethylethanolamine, N,N-diethylmethylamine, dipropylamine, N,N-dimethylaniline, ethyl p-diethylaminobenzoate, and ethyl p-dimethylaminobenzoate; hydroxyl group-containing compounds such as methanol, ethanol, propanol, isopropyl alcohol, butanol, ethylene glycol, propylene glycol, butanediol, and phenol; ether bond-containing compounds such as tetrahydrofuran, tetrahydropyran, dioxane, trioxane, diethylene glycol, dipropylene glycol, propylene glycol monomethyl ether, and propylene glycol monomethyl ether acetate; mercapto compounds such as butanethiol, propanethiol, hexanedithiol, decanedithiol, n-dodecylmercaptan, dodecyl(4-methylthio)phenyl ether, benzenethiol, 4-dimethylmercaptobenzene, 2-mercaptoethanol, 1-mercapto-2-propanol, 3-mercapto-2-butanol, 3-mercapto-1,2-propanediol, and mercaptophenol, or disulfides obtained by oxidizing the mercapto compounds; and mercapto group-containing compounds such as butyl thioglycolate, ethylene glycol bisthioglycolate, ethylene glycol bisthiopropionate, butanediol bis(3-mercaptoisobutyrate), 1,4-butanediol bisthioglycolate, 1,4-butanediol bisthiopropionate, octyl β-mercaptopropionate, methoxybutyl β-mercaptopropionate, trishydroxyethyl tristhiopropionate, trimethylolpropane tris(3-mercaptoisobutyrate), trimethylolpropane tris(3-mercaptobutyrate), trimethylolpropane tris(3-mercaptopropionate), trimethylolpropane tris(β-thiopropionate), trimethylolpropane tirsthioglycolate, trimethylolpropane tristhiopropionate, pentaerythritol tetrakis(3-mercaptopropionate), pentaerythritol tetrakis thioglycolate, pentaerythritol tetrakis thiopropionate, thoglycolic acid, thiosalicylic acid, thiomalic acid, mercaptoacetic acid, 2-mercaptoethanesulfonic acid, 2-mercaptonicotinic acid, 2-mercaptopropionic acid, 3-mercaptopropanesulfonic acid, 3-mercaptopropionic acid, 3-mercaptobutyric acid, 4-mercaptobutanesulfonic acid, 3-[N-(2-mercaptoethyl)amino]propionic acid, 3-[N-(2-mercaptoethyl)carbamoyl]propionic acid, 2-mercapto-3-pyridinol, 2-mercaptoimidazole, 2-mercaptoethylamine, 2-mercaptobenzoimidazole, 2-mercatobenzothiazole, 6-trimercapto-s-triazine, N-(2-mercaptopropionyl)glycine, N-(3-mercaptopropionyl)alanine, diisopropyl thioxanthone, diethyl thioxanthone, thiophosphites, and trimercaptopropionic acid tris(2-hydroxyethyl)isocyanurate.

It is particularly suitable to use amino group-containing compounds because amino group-containing compounds need a low energy to hand over hydrogen. Among amino group-containing compounds, it is further suitable to use, for example, methyl 2-(N,N-dimethylamino)benzoate, ethyl 4-(N,N-dimethylamino)benzoate, ethyl 4-(N,N-diethylamino)benzoate, and a mixture of 1,3-di({α-4-(dimethylamino)benzoyl poly[oxy(1-methylethylene)]}oxy)-2,2-bis({α-4-(dimethylamino)benzoyl poly[oxy(1-methylethylene)]}oxymerhyl)propane and {α-4-(dimethylamino)benzoyl poly(oxyethylene)-poly[oxy(1-methylethylene)]-poly(oxyethylene)}4-(dimethylamino)benzoate (available from Lambson Limited, “SPEEDCURE 7040”).

The amount of use of the hydrogen-donating compound when the hydrogen-donating compound is used in the present disclosure is typically 0.01% by weight or greater but 50% by weight or less and preferably 0.1% by weight or greater but 20% by weight or less relative to the radical polymerizable compound in the photopolymerizable composition of the present disclosure.

### <Other Components>

The other components are not particularly limited. Examples of the other components include, but are not limited to, other colorants, an organic solvent, a polymerization inhibitor, a slipping agent (surfactant), a permeation enhancing agent, a wetting agent (humectant), a fixing agent, a fungicide, a preservative, an antioxidant, an ultraviolet absorbent, a chelate agent, a pH adjuster, and a thickener that are hitherto known.

### <<Other Colorants>>

As the other colorants, various other pigments and dyes may be used that impart black, white, magenta, yellow, green, orange, and gloss colors such as gold and silver, depending on the intended purpose of the active-energy-ray-curable composition of the present and requisite properties thereof. A content of the colorant is preferably from 0.1% by mass to 20% by mass and more preferably from 1% by mass to 10% by mass relative to the total mass (100% by mass) of the active-energy-ray-curable composition.

The other pigments can be either inorganic or organic, and two or more of the pigments can be used in combination.

Specific examples of the inorganic pigments include, but are not limited to, carbon blacks (C.I. Pigment Black 7) such as furnace black, lamp black, acetylene black, and channel black, and iron oxides. In order to reduce the colony count, titanium dioxide is not suitable.

Specific examples of the organic pigments include, but are not limited to, azo pigments such as insoluble azo pigments, condensed azo pigments, azo lakes, and chelate azo pigments, polycyclic pigments such as quinacridone pigments, perylene and perinone pigments, anthraquinone pigments, dioxazine pigments, thioindigo pigments, isoindolinone pigments, and quinophthalone pigments, dye chelates (e.g., basic dye chelates, acid dye chelates), dye lakes (e.g., basic dye lakes, acid dye lakes), nitro pigments, nitroso pigments, aniline black, and daylight fluorescent pigments.

The dyes are not particularly limited. Specific examples of the dyes include, but are not limited to acidic dyes, direct dyes, reactive dyes, and basic dyes. One of these dyes may be used alone or two or more of these dyes may be used in combination.

### <<Polymerization Inhibitor>>

Examples of the polymerization inhibitor include, but are not limited to, p-methoxyphenol, 4-methoxy-1-naphthol, methyl hydroquinone, hydroquinone, t-butyl hydroquinone, di-t-butyl hydroquinone, methoquinone, 2,2′-dihydroxy-3,3′-di(α-methylcyclohexyl)-5,5′-dimethyldiphenylmethane, p-benzoquinone, di-t-butyldiphenylamine, 9,10-di-n-butoxyanthracene, and 4,4′-[1,10-dioxo-1,10-decanediylbis(oxy)] bis[2,2,6,6-tetramethyl]-1-piperidinyloxy.

The content of the polymerization inhibitor is preferably 0.005% by mass or greater but 3% by mass or less relative to the total amount of the polymerization initiator. When the content of the polymerization inhibitor is 0.005% by mass or greater, storage stability can be improved and viscosity thickening in a high-temperature environment can be suppressed. When the content of the polymerization inhibitor is 3% by mass or less, curability can be improved.

### <<Surfactant>>

The surfactant is not particularly limited and may be appropriately selected depending on the intended purpose. Examples of the surfactant include, but are not limited to, higher fatty acid-based surfactants, silicone-based surfactants, and fluorosurfactants.

The content of the surfactant is preferably 0.1% by mass or greater but 3% by mass or less and more preferably 0.2% by mass or greater but 1% by mass or less relative to the total amount of the active-energy-ray-curable composition. When the content of the surfactant is 0.1% by mass or greater, wettability can be improved. When the content of the surfactant is 3% by mass or less, curability can be improved. When the content is in the more preferable range, wettability and a leveling property can be improved.

### <<Organic Solvent>>

The pigment dispersion composition and the active-energy-ray-curable composition of the present disclosure optionally contain an organic solvent although it is preferable to spare it. The composition free of an organic solvent, in particular volatile organic compound (VOC), is preferable because it enhances safety at where the composition is handled and makes it possible to prevent pollution of the environment. Incidentally, the organic solvent represents a conventional non-reactive organic solvent, for example, ether, ketone, xylene, ethyl acetate, cyclohexanone, and toluene, which is clearly distinguished from reactive monomers. Furthermore, “free of” an organic solvent means that no organic solvent is substantially contained. The content thereof is preferably less than 0.1 percent by mass.

### <Preparation of Pigment Dispersion Composition>

The pigment dispersion composition of the present disclosure can be prepared by using the components described above. The preparation devices and conditions are not particularly limited. For example, the pigment dispersion composition can be prepared by subjecting a polymerizable monomer, a pigment, a dispersant, etc., to a dispersion treatment using a dispersing machine such as a ball mill, a kitty mill, a disk mill, a pin mill, and a DYNO-MILL to prepare a pigment liquid dispersion, and further mixing the pigment liquid dispersion with a polymerizable monomer, an initiator, a polymerization inhibitor, and a surfactant.

### <Dispersing Method>

In the method for dispersing the pigment dispersion composition of the present disclosure, dispersing machines using media, such as a ball mill, a sand mill, and a bead mill may be used, or medialess dispersing machines may be used. As the method for dispersing, a method of dispersing the components in a state under a high pigment concentration that is about two times higher than the intended pigment concentration of the dispersion, and diluting the resultant with the dispersion medium to the intended pigment concentration before extracting the dispersion is effective. In the state under a high pigment concentration, it is expected that the ratio of the pigment to the dispersant polymer is high, to provide more chances of contact between the dispersant polymer and the pigment, and promote adsorption of the dispersant polymer to the pigment.

As the dispersion media of the dispersing machine using media, it is preferable to use zirconia beads in terms of dispersibility and dispersion efficiency. Two or more dispersing methods may be used in combination. For example, ball mill dispersion can obtain a dispersion liquid having a uniform particle size distribution through two-step dispersion including dispersion using zirconia beads having a diameter of 5 mm and subsequent dispersion using zirconia beads having a diameter of 1 mm.

The medialess dispersing machine does not apply excessive energy to the pigment and can prevent the pigment particles from, for example, being crushed, making it possible to promote adsorption of the dispersant polymer to the surface of the pigment and improve dispersion stability. Moreover, the medialess dispersing machine prevents not only overdispersion but also contamination attributable to the media, making it possible to suppress occurrence of fine particles and coarse particles in the system. These factors help improve the uniformity of the particle size distribution and obtain a high ink dischargeability.

Examples of the medialess dispersing machine include, but are not limited to, dispersing machines using a high-speed shear force based on, for example, impact dispersion and ultrasonic dispersion, and dispersing machines using high-speed stirring.

Examples of the dispersing machines using a high-speed shear force include, but are not limited to, machine name: NANOVEITA SERIES LABORATORY MACHINE C-ES008 (available from Yoshida Kikai Co., Ltd.).

The temperature of the dispersion liquid during dispersion is preferably 5 degrees C. or higher but 60 degrees C. or lower. When the temperature is 5 degrees C. or higher but 60 degrees C. or lower, a curing reaction of the monomer can be suppressed. It is also possible to previously add a polymerization inhibitor in a low amount in order to suppress a curing reaction.

In the present disclosure, the 50% cumulative volume-based particle diameter of the pigment in the active-energy-ray-curable composition is preferably 30 nm or greater but 350 nm or less, and the distribution width of the particle diameter distribution calculated according to Formula (2) below is preferably 100 nm or less.

Distribution width of particle diameter distribution=(84% cumulative volume-based particle diameter−16% cumulative volume-based particle diameter)/2 (2)

When the 50% cumulative volume-based particle diameter is 30 nm or greater but 350 nm or less, effects of improving dispersibility and improving white hiding power, liquid permeability, and dischargeability are achieved.

When the distribution width of the particle diameter distribution calculated according to Formula (2) above is 100 nm or less, an effect of improving liquid permeability and dischargeability is achieved with a sharp dispersed particle diameter.

The 50% cumulative volume-based particle diameter is more preferably 100 nm or greater but 300 nm or less.

The distribution width of the particle diameter distribution calculated according to Formula (2) above is more preferably 80 nm or less.

The 50% cumulative volume-based particle diameter (D50) and the distribution width of the particle diameter distribution can be obtained in the manners described below.

The 50% cumulative volume-based particle diameter (D50) is measured with a particle size distribution analyzer (product name: UPA150, available from Nikkiso Co., Ltd.) with dilution of the obtained active-energy-ray-curable composition about 2,000-fold with the polymerizable compound used as the dispersion medium.

The distribution width of the particle diameter distribution can be calculated according to Formula (2) above after measurement of the 84% cumulative volume-based particle diameter (D84) and the 16% cumulative volume-based particle diameter (D16) in the same manner as the 50% cumulative volume-based particle diameter (D50).

### <Viscosity>

The viscosity of the pigment dispersion composition and the active-energy-ray-curable composition of the present disclosure have no particular limit because it can be adjusted depending on the purpose and application devices. For example, if an ejecting device that ejects the compositions from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. In addition, it is particularly preferable to satisfy this viscosity range by the compositions free of the organic solvent described above. Incidentally, the viscosity can be measured by a cone plate rotary viscometer (VISCOMETER TVE-22L, manufactured by TOKI SANGYO CO., LTD.) using a cone rotor (1° 34′×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

The viscosity change ratio of the pigment dispersion composition and the active-energy-ray-curable composition is preferably 15% or lower, more preferably 10% or lower, and particularly preferably 5% or lower. When the viscosity change ratio is 15% or lower, the pigment dispersion composition and the active-energy-ray-curable composition have an excellent storage stability and an improved dispersibility. The viscosity change ratio can be calculated according to Formula (3) below. The viscosities in the viscosity change ratio can be measured by a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec⁻¹.

Viscosity change ratio (%)=((viscosity after storage at 70 degrees C. for 14 days−initial viscosity)/initial viscosity)×100 (3)

### <Application Field>

The application field of the pigment dispersion composition and the active-energy-ray-curable composition of the present disclosure is not particularly limited. The pigment dispersion composition and the active-energy-ray-curable composition can be applied to any field where pigment dispersion compositions and active-energy-ray-curable compositions are used. For example, the pigment dispersion composition and the active-energy-ray-curable composition are selected to a particular application and used for a resin for processing, a paint, an adhesive, an insulant, a releasing agent, a coating material, a sealing material, various resists, and various optical materials.

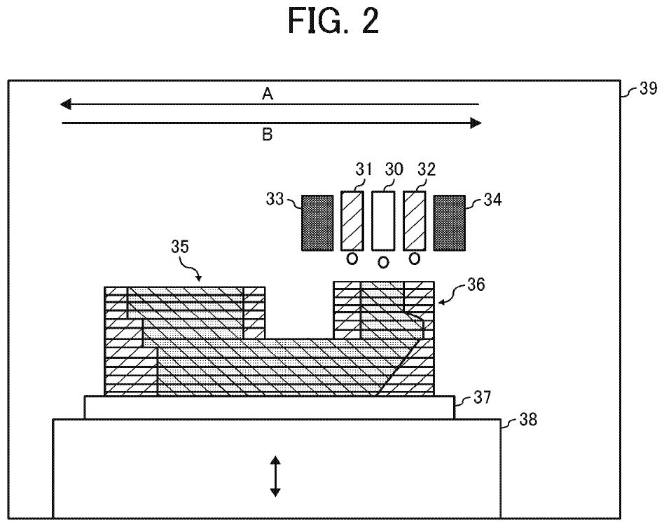

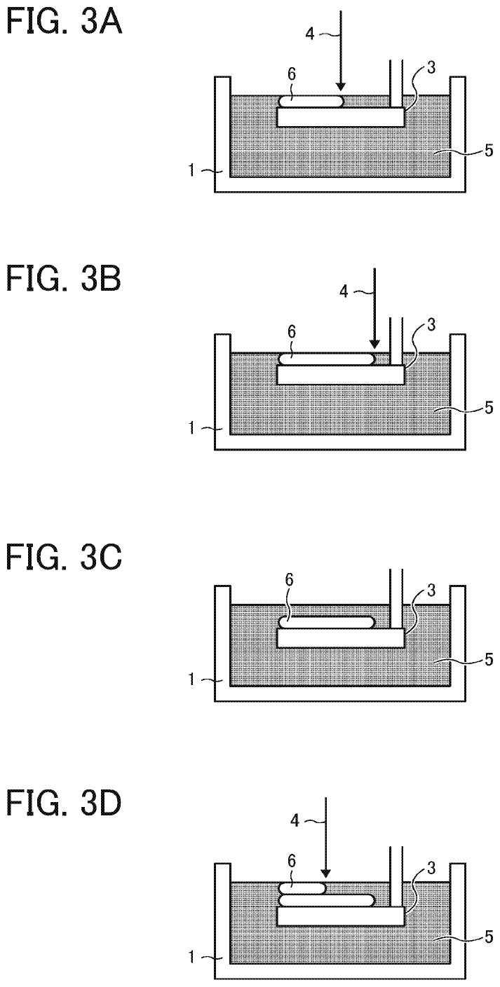

Furthermore, the pigment dispersion composition and the active-energy-ray-curable composition of the present disclosure can be used as an ink to form two-dimensional texts, images, and designed coating film on various substrates and in addition as a solid object forming material to forma three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2. FIG. 2 is a diagram illustrating a method of additive manufacturing to sequentially form layers of the active-energy-ray-curable composition of the present disclosure one on top of the other by repeating discharging the active-energy-ray-curable composition to particular areas followed by curing upon irradiation of an active energy ray (to be described in detail below). FIGS. 3A to 3D are each a diagram illustrating a method of additive manufacturing to sequentially form cured layers 6 having respective predetermined forms one on top of the other on a movable stage 3 by irradiating a storing pool (storing unit) 1 of the active-energy-ray-curable composition 5 of the present disclosure with the active energy ray 4.

An apparatus for fabricating a three-dimensional object by the active-energy-ray-curable composition of the present disclosure is not particularly limited and can be a known apparatus. For example, the apparatus includes a containing device, a supplying device, and a discharging device of the composition, and an active energy ray irradiator.

In addition, the present disclosure includes cured materials obtained by curing the active-energy-ray-curable composition and processed products obtained by processing structures having the cured materials on a substrate. The processed product is fabricated by, for example, heat-drawing and punching a cured material or structure having a sheet-like form or film-like form. Examples thereof are products that need processing after decoration of the surface, such as gauges or operation panels of vehicles, office machines, electric and electronic machines, and cameras.

The substrate is not particularly limited. It can suitably be selected to a particular application. Examples thereof include paper, thread, fiber, fabrics, leather, metal, plastic, glass, wood, ceramic, or composite materials thereof. Of these, plastic substrates are preferred in terms of processability.

Moreover, the composition of the present disclosure not only forms two-dimensional texts, images, and designed coating film on various substrates, but also, for example, a cured product obtained by curing the composition and an artificial nail formed by processing a structure having the cured product over a nail or a nail-shaped plastic base material. The composition of the present disclosure is particularly suitable as a base coat for an artificial nail composition, because the composition is excellent in removability and adhesiveness with nails.

A tensile property of the cured product of the present disclosure at 180 degrees C., expressed by a ratio (length after tensile test−length before tensile test)/(length before tensile test), is preferably 50% or higher and more preferably 100% or higher.

### <Active-Energy-Ray-Curable Ink>

An active-energy-ray-curable ink of the present disclosure (hereinafter, may be referred to as “ink”) is formed of the active-energy-ray-curable composition of the present disclosure, and is preferably intended for inkjet.

The static surface tension of the active-energy-ray-curable ink at 25 degrees C. is preferably 20 mN/m or higher but 40 mN/m or lower and more preferably 28 mN/m or higher but 35 mN/m or lower.

The static surface tension is measured with a static surface tensiometer (available from Kyowa Interface Science Co., Ltd., CBVP-Z TYPE) at 25 degrees C. The specifications of commercially available inkjet discharging heads such as GEN5 available from Ricoh Printing Systems, Ltd. are assumed for the static surface tension.

### <Composition Stored Container>

A composition stored container of the present disclosure contains the active-energy-ray-curable composition and is suitable for the applications as described above. For example, if the active-energy-ray-curable composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### <Image Forming Method and Forming Apparatus>

An image forming method of the present disclosure includes at least an irradiating step of irradiating the active-energy-ray-curable composition of the present disclosure with an active energy ray to cure the active-energy-ray-curable composition. An image forming apparatus of the present disclosure includes an irradiator to irradiate the active-energy-ray-curable composition of the present disclosure with an active energy ray, and a storing unit containing the active-energy-ray-curable composition of the present disclosure. The storing unit may include the container mentioned above. Furthermore, the method and the apparatus may respectively include a discharging step and a discharging device to discharge the active-energy-ray-curable composition. The method of discharging the active-energy-ray-curable composition is not particularly limited, and examples thereof include a continuous jetting method and an on-demand method. The on-demand method includes a piezo method, a thermal method, an electrostatic method, etc.

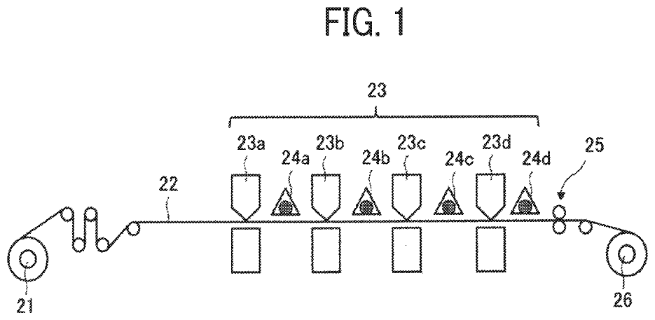

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black active-energy-ray-curable inks discharge the inks onto a recording medium 22 fed from a supplying roller 21. Thereafter, light sources 24a, 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods. The serial methods include discharging an ink onto a recording medium by moving the head while the recording medium intermittently moves according to the width of a discharging head. The line methods include discharging an ink onto a recording medium from a discharging head held at a fixed position while the recording medium continuously moves.

The recording medium 22 is not particularly limited. Specific examples thereof include, but are not limited to, paper, film, metal, or complex materials thereof. The recording medium 22 takes a sheet-like form but is not limited thereto. The image forming apparatus may have a one-side printing configuration and/or a two-side printing configuration.

Optionally, multiple colors can be printed with no or weak active energy ray from the light sources 24a, 24b, and 24c followed by irradiation of the active energy ray from the light source 24d. As a result, energy and cost can be saved.

The recorded matter having images printed with the ink of the present disclosure includes articles having printed images or texts on a plain surface of conventional paper, resin film, etc., a rough surface, or a surface made of various materials such as metal or ceramic. In addition, by laminating layers of images in part or the entire of a recording medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first active-energy-ray-curable composition, and ejection head units 31 and 32 for support and curing these compositions ejects a second active-energy-ray-curable composition having a different composition from the first active-energy-ray-curable composition, while ultraviolet irradiators 33 and 34 adjacent to the ejection head units 31 and 32 cure the compositions. To be more specific, for example, after the ejection head units 31 and 32 for support eject the second active-energy-ray-curable composition onto a substrate 37 for additive manufacturing and the second active-energy-ray-curable composition is solidified by irradiation of an active energy ray to form a first substrate layer having a space for composition, the ejection head unit 30 for additive manufacturing ejects the first active-energy-ray-curable composition onto the pool followed by irradiation of an active energy ray for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated in FIG. 2, it can have two or more units 30.

### (Two-Dimensional or Three-Dimensional Image)

A two-dimensional or three-dimensional image of the preset disclosure is obtained by applying and curing one of the active-energy-ray-curable composition of the present disclosure and the active-energy-ray-curable ink of the present disclosure over a base material.

Examples of the two-dimensional or three-dimensional image recorded with the active-energy-ray-curable ink of the present disclosure include, but are not limited to, images printed on a plain surface of conventional paper, resin film, etc., a rough surface, or a surface made of various materials such as metal or ceramic.

Examples of the two-dimensional image include, but are not limited to, letters, symbols, and diagrams or combinations thereof, and solid images.

Examples of the three-dimensional image include, but are not limited to, a three-dimensional object.

The average thickness of the three-dimensional object is not particularly limited, may be appropriately selected depending on the intended purpose, and is preferably 10 micrometers or greater.

Because the two-dimensional or three-dimensional image is formed of one of the active-energy-ray-curable composition of the present disclosure and the active-energy-ray-curable ink of the present disclosure, the two-dimensional or three-dimensional image formed over an impermeable base material has an excellent water resistance allowing the two-dimensional or three-dimensional image to maintain a good adhesiveness with the base material through immersion in water.

It is preferable to cure the two-dimensional or three-dimensional image with light from a light-emitting diode having an active energy ray irradiation intensity of 500 mJ/cm² or lower.

### (Structure)

A structure of the present disclosure includes a base material and the two-dimensional or three-dimensional image of the present disclosure over the base material.

The base material is not particularly limited and may be appropriately selected depending on the intended purpose.

### (Processed Product)

A processed product of the present disclosure is obtained by drawing one of the two-dimensional or three-dimensional image of the present disclosure and the structure of the present disclosure.

### EXAMPLES

The present disclosure will be described below in more detail by way of Examples. The present disclosure should not be construed as being limited to these Examples.

The amine value of the dispersant polymer, a skin sensitization SI value indicating a skin sensitizing potential, and the colony count by Ames test indicating carcinogenicity were obtained in the manners described below.

### <Amine Value of Dispersant Polymer>

To obtain the amine value of the dispersant polymer, the dispersant polymer (1 g) was dissolved in methyl isobutyl ketone (100 mL), and potentiometrically titrated with a 0.01 mol/L methyl isobutyl ketone chlorate solution, to measure a potential difference. The amine value was calculated based on the obtained potential difference. A potentiometric titrator (instrument name: GT-200, obtained from Mitsubishi Chemical Analytech Co., Ltd.) was used for the potentiometric titration measurement.

### <Method for Evaluating SI Value>

The SI value was measured by a skin sensitization test according to a local lymph node assay (LLNA) method.

### <Method for Evaluating Carcinogenicity>

### [Mutagenicity Test (Ames Test)]

As a method for examining safety in the present disclosure, a mutagenicity test (Ames test) was performed. In the present disclosure, a plate method was employed as a test method. The test was performed using TA1535 as a strain with metabolic activation. The active-energy-ray-curable composition of each Example and each Comparative Example was collected by 250 mg and subjected to ultrasonic treatment for 1 minute with addition of dimethyl sulfoxide (DMSO) (250 mg), to obtain a colorless solution, which was used for the test. The test was performed with preparation of the active-energy-ray-curable composition at five concentrations including 625 micrograms/plate, 1,250 micrograms/plate, 2,500 micrograms/plate, 5,000 micrograms/plate, and 10,000 micrograms/plate. Among these preparations, the maximum total colony count was divided by the colony count of a control solvent, and the obtained value (referred to as a multiple of colony growth in the present disclosure) was evaluated. The lower the value, the higher the safety. A value of 2.0 or less was determined as negative. The evaluation results are presented in Tables 4-1 to 4-6. The colony count of pigment dispersion liquids Wh-1 to Wh-47 was also evaluated by the same testing method as the testing method performed for the active-energy-ray-curable composition. The valuation results are presented in Tables 2-1 to 2-6.

### <Constituent Components of Pigment Dispersion Liquids and Active-Energy-Ray-Curable Compositions>

Abbreviations, compound names, supplier names, and product names of the materials used for preparing the pigment dispersion liquids and the active-energy-ray-curable compositions are presented in Tables 1-1 to 1-3. Monomers serving as acrylamide compounds were synthesized by the methods described in Synthesis examples 1 to 5. The synthesized compounds were identified by nuclear magnetic resonance spectroscopy (instrument used: “JNM-ECX500” obtained from JEOL Ltd.), and the purity was measured by a gas chromatograph method (instrument used: “GCMS-QP2010 PLUS” obtained from Shimadzu Corporation). These chemical analyses were performed in routine manners.

TABLE 1-1

| | | | Supplier |
|---|---|---|---|
| | | | and product |
| | Abbreviation | Compound name or structure | names |
| Acrylamide compound (A1) having ester structure | A1-1 | 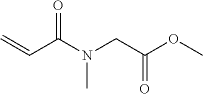 | (see Synthesis example 1) SI = 1.00 |
| | A1-2 | 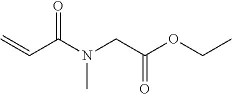 | (see Synthesis example 2) SI = 1.02 |
| | A1-3 | 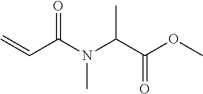 | (see Synthesis example 3) SI = 1.12 |
| | A1-4 | 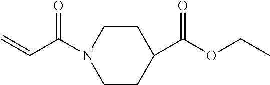 | (see Synthesis example 4) SI = 1.60 |
| Multi- functional polymerizable compound (A2) | A2-1 | 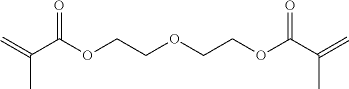 [SMILES: C=C(C)C(=O)OCCOCCOC(=O)C(=C)C] | Shin- Nakamura Chemical Co., Ltd. “2G” SI = 1.05 Ltd. |
| | A2-2 | 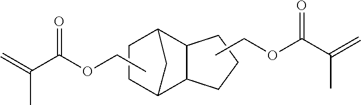 | Shin- Nakamura Chemical Co., Ltd. “DCP” SI = 1.34 |
| | A2-3 | 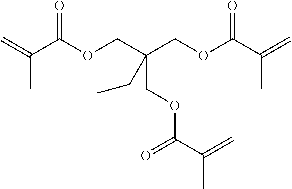 [SMILES: C=C(C)C(=O)OCC(CC)(COC(=O)C(=C)C)COC(=O)C(=C)C] | Shin- Nakamura Chemical Co., Ltd. “TMPT” SI = 1.03 |
| | A2-4 | 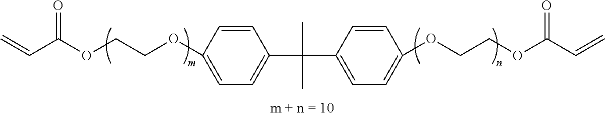 | Shin- Nakamura Chemical Co., Ltd. “A-BPE-10” SI = 1.24 |
| | A2-5 | 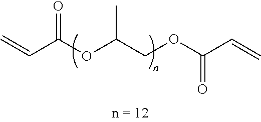 | Shin- Nakamura Chemical Co., Ltd. “APG-700” SI = 1.15 |
| | A2-6 | 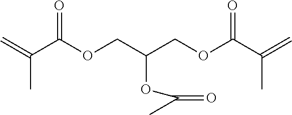 [SMILES: C=C(C)C(=O)OCC(COC(=O)C(=C)C)OC(C)=O] | (see Synthesis example 5) SI = 1.40 |
| | A2-7 | 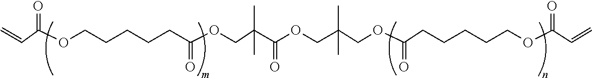 | Nippon Kayaku Co., Ltd. “HX-620” SI = 0.92 |
| | A2-8 | 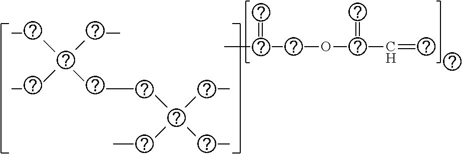 | Nippon Kayaku Co., Ltd. “DPCA-60” SI = 1.40 |

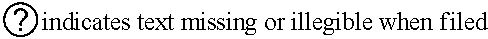

TABLE 1-2

| | | | |
|---|---|---|---|
| Mono- functional polymerizable compound (A3) other than A1 | A3-1 | 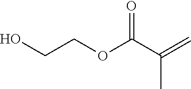 | Tokyo Chemical Industry Co., Ltd. “2-hydroxyethyl methacrylate” SI = 1.26 |
| | A3-2 | 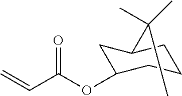 | Osaka Organic Chemical Industry Ltd. “Isobomyl acrylate” SI = 8.30 |
| Multi- functional polymerizable compound (A4) other than A2 | A4-1 | 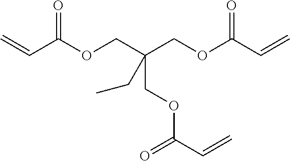 [SMILES: C=CC(=O)OCC(CC)(COC(=O)C=C)COC(=O)C=C] | Toagosei Co., Ltd. “M-3547” SI = 3.42 |
| Pigment- | B-1 | Structure not disclosed | Ajinomoto Fine-Techno Co., Inc. |
| adsorptive | | | “AJISPER PB-821 ” |
| component | | | amine value: 11.2 mgKOH/g |
| (B) | B-2 | Structure not disclosed | Ajinomoto Fine-Techno Co., Inc. |
| | | | “AJISPER PB-822” |
| | | | amine value: 18.2 mgKOH/g |
| | B-3 | Structure not disclosed | Ajinomoto Fine-Techno Co., Inc. |
| | | | “AJISPER PB-881” |
| | | | amine value: 17.4 mgKOH/g |
| | B-4 | Structure not disclosed | Nippon Lubrizol Corporation |
| | | | “SOLSPERSE 20000” |
| | | | amine value: 35.9 mgKOH/g |
| | B-5 | Structure not disclosed | Nippon Lubrizol Corporation |
| | | | “SOLSPERSE 24000” |
| | | | amine value: 41.6 mgKOH/g |
| | B-6 | Structure not disclosed | Nippon Lubrizol Corporation |
| | | | “SOLSPERSE 39000” |
| | | | amine value: 25.7 mgKOH/g |
| | B-7 | Structure not disclosed | Nippon Lubrizol Corporation |
| | | | “SOLSPERSE 56000” |
| | | | amine value: 24.6 mgKOH/g |
| | B-8 | Structure not disclosed | Nippon Lubrizol Corporation |
| | | | “SOLSPERSE 71000” |
| | | | amine value: 75.0 mgKOH/g |
| | B-9 | Structure not disclosed | Nippon Lubrizol Corporation |
| | | | “SOLSPERSE 73000” |
| | | | amine value: 80.0 mgKOH/g |
| | B-10 | Structure not disclosed | Nippon Lubrizol Corporation |
| | | | “SOLSPERSE 74000” |
| | | | amine value: 81.0 mgKOH/g |
| | B-11 | Structure not disclosed | Nippon Lubrizol Corporation |
| | | | “SOLSPERSE 88000” |
| | | | amine value: 33.0 mgKOH/g |

TABLE 1-3

| | | | |
|---|---|---|---|
| Poly- merization initiator (C) | C-1 | 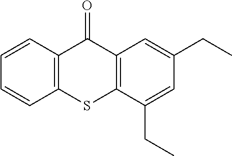 [SMILES: CCc1cc(CC)c2sc3ccccc3c(=O)c2c1] | Nippon Kayaku Co., Ltd. “DETX-S” |
| | C-2 | 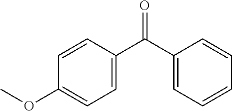 [SMILES: COc1ccc(C(=O)c2ccccc2)cc1] | Tokyo Chemical Industry Co., Ltd. “Methoxybenzophenone” |
| | C-3 | 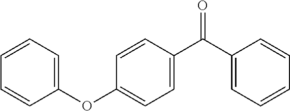 [SMILES: O=C(c1ccccc1)c1ccc(Oc2ccccc2)cc1] | Tokyo Chemical Industry Co., Ltd. “4- Benzyloxybenzophenone” |
| | C-4 | 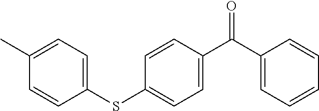 [SMILES: Cc1ccc(Sc2ccc(C(=O)c3ccccc3)cc2)cc1] | Tokyo Chemical Industry Co., Ltd. “4-Benzoyl 4′- methyldiphenyl sulfide (BMS)” |
| | C-5 | 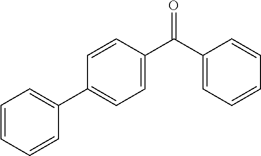 [SMILES: O=C(c1ccccc1)c1ccc(-c2ccccc2)cc1] | Tokyo Chemical Industry Co., Ltd. “4-Phenylbenzophenone” |
| | C-6 | 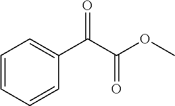 | Tokyo Chemical Industry Co., Ltd. “Methyl benzoylformate” |
| | C-7 | 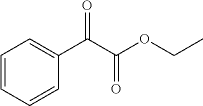 | Tokyo Chemical Industry Co., Ltd. “Ethyl benzoylformate” |
| | C-8 | Bis(2,4,6-trimethylbenzoyl) phenylphosphine oxide | BASF Japan Ltd. “IRGACURE 819” |
| | C-9 | 2,4,6-Trimethylbenzoyl-diphenyl- phosphine oxide | BASF Japan Ltd. “IRGACURE TPO” |
| Hydrogen donor (D) | D-1 | 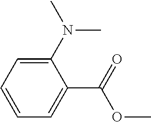 | Tokyo Chemical Industry Co., Ltd. “Methyl N,N- dimethylanthranilate” |
| | D-2 | 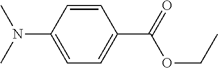 | Tokyo Chemical Industry Co., Ltd. “Ethyl p- dimethylaminobenzoate” |
| | D-3 | 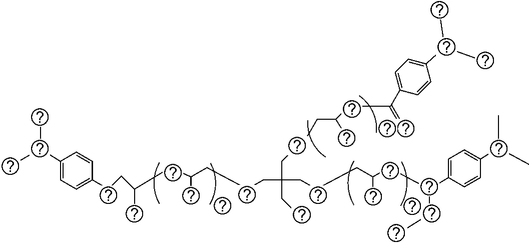 | Lambson Limited “SPEEDCURE 7040” |
| Other | Poly- | 4-Methoxyphenol | Seiko Chemical Co., Ltd. |
| components | merization | | “METHOQUINONE” |
| | inhibitor | | |
| | Surfactant | Silicone-based surfactant | Byk-Chemie Japan K.K. |
| | | | “BYK-UV3510” |

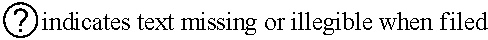

### Synthesis Example 1

### Synthesis of N-acryloyl-N-methylglycinemethyl Ester (A1-1)

N-Methylglycinemethyl ester hydrochloride (obtained from Sigma-Aldrich Japan, reagent) (0.30 moles), potassium carbonate (obtained from Kanto Chemical Co., Inc., reagent) (0.45 moles), and water (400 mL) were stirred and mixed at from 0 degrees C. through 10 degrees C. With the temperature maintained, acrylic acid chloride (obtained from Wako Pure Chemical Industry Co., Ltd., reagent) (0.33 moles) was slowly dropped into the resultant. After dropping was completed, the resultant was extracted three times with ethyl acetate (obtained from Kanto Chemical Co., Inc., reagent) (400 mL), and washed once with water (400 mL) together with the ethyl acetate layer. Ethyl acetate was evaporated at reduced pressure at 40 degrees C., to obtain intended N-acryloyl-N-methylglycinemethyl ester (A1-1) (0.20 moles) as an almost colorless, clear liquid. The purity was 98.3% by mass.

N-Acryloyl-N-methylglycinemethyl ester (A1-1) had a molecular weight of 157.2, and was a known compound (CAS Registration No. 72065-23-7). As a safety test, AMES test was performed according to OECD test guideline TG471 (±S9 mix), and the result was negative. Oral toxicity was tested according to OECD test guideline TG423. As a result, none of six cases was a fatal case, and LD50 was 2,000 mg/kg or higher. Skin stimulation was tested according to OECD test guideline TG404, and the result was PII=0.5. Skin sensitizing potential was tested according to OECD test guideline TG442B. As a result, the SI value turned out to be 1.00, and the compound was found to be significantly uninfluential on the health of human bodies.

The compounds of Synthesis examples 2 to 5 below were also significantly uninfluential on the health of human bodies like the compound of Synthesis example 1.

### Synthesis Example 2

### Synthesis of N-acryloyl-N-methylglycineethyl Ester (A1-2)

Intended N-acryloyl-N-methylglycineethyl ester (A1-2) (0.22 moles) was obtained as an almost colorless, clear liquid in the same manner as in Synthesis example 1, except that unlike in Synthesis example 1, N-methylglycinemethyl ester hydrochloride was changed to N-methylglycineethyl ester hydrochloride (obtained from Tokyo Chemical Industry Co., Ltd., reagent). The purity was 98.5 parts by mass.

N-Acryloyl-N-methylglycineethyl ester (A1-2) had a molecular weight of 171.2, and was a known compound (CAS Registration No. 170116-05-9).

### Synthesis Example 3

### Synthesis of N-acryloyl-N-methylalaninemethyl Ester (A1-3)

Intended N-acryloyl-N-methylalaninemethyl ester (A1-3) (0.22 moles) was obtained as an almost colorless, clear liquid in the same manner as in Synthesis example 1, except that unlike in Synthesis example 1, N-methylglycinemethyl ester hydrochloride was changed to N-methylalaninemethyl ester hydrochloride (obtained from Tokyo Chemical Industry Co., Ltd., reagent). The purity was 98.5% by mass.

N-Acryloyl-N-methylalaninemethyl ester (A1-3) had a molecular weight of 171.2.

### Synthesis Example 4

### Synthesis of ethyl N-acryloylpiperidine-4-carboxylate (A1-4)

Intended ethyl N-acryloylpiperidine-4-carboxylate (A1-4) (0.27 moles) was obtained as an almost colorless, clear liquid in the same manner as in Synthesis example 1, except that unlike in Synthesis example 1, N-methylglycinemethyl ester hydrochloride was changed to ethyl piperidine-4-carboxylate (obtained from Tokyo Chemical Industry Co., Ltd., reagent). The purity was 99.2% by mass.

Ethyl N-acryloylpiperidine-4-carboxylate (A1-4) had a molecular weight of 211.3, and was a known compound (CAS Registration No. 845907-79-1).

### Synthesis Example 5

### Synthesis of 2-acetyl-1,3-glycerol dimethacrylate (A2-6)

1,3-Glycerol dimethacrylate obtained from Tokyo Chemical Industry Co., Ltd. (57.1 g) (250 mmol) was added in dehydrated dichloromethane (1,000 mL). After the flask was purged with an argon gas, triethylamine (36.0 g) (360 mmol) was added. Next, after the resultant was cooled to about −10 degrees C., acetic acid chloride (24.0 g) (300 mmol) was slowly dropped into the resultant in a manner that the temperature in the system would be from −10 degrees C. through −5 degrees C., and the resultant was stirred at room temperature for 2 hours. Then, after a precipitate was removed by filtration, the filtrate was washed with water, a saturated sodium bicarbonate aqueous solution, and a saturated sodium chloride aqueous solution. Next, the resultant was dried with sodium sulfate, and concentrated at reduced pressure, to obtain a yellow oily matter. Then, the yellow oily matter was purified by column chromatography in which columns were filled with WAKOGEL C300 (obtained from Wako Pure Chemical Industry Co., Ltd.) (2,000 g) and hexane and ethyl acetate were used as eluates, to obtain a colorless oily matter (18.0 g) of intended 2-acetyl-1,3-glycerol dimethacrylate (A2-6) (at a yield of about 28%). The purity was 99.1% by mass.

### <Production of Pigment Dispersion Liquid Wh-1>

A dispersant polymer (product name: AJISPER PB821, obtained from Ajinomoto Fine-Techno Co., Inc., with an amine value of 10.0 mgKOH/g) (6.0 parts by mass) was added to the compound A1-1 (79.0 parts by mass), and stirred and dissolved at 25 degrees C. for 4 hours, to obtain a dispersion medium.

Zirconia balls having a diameter of 2 mm (80 parts by mass), strontium titanate (product name: SW-100, obtained from Titan Kogyo, Ltd.) (3.75 parts by mass), and the dispersion medium (21.25 parts by mass) were filled in a 50 mL mayonnaise bottle (product name: UM SAMPLE BOTTLE, obtained from As One Corporation), and subjected to dispersion treatment for 2 days using a ball mill having the conditions described below, to obtain [Pigment dispersion liquid Wh-1] (with a pigment concentration of 15% by mass).

### —Conditions of Ball Mill—

Media: YTZ balls with a diameter of 2 mm (zirconia balls, obtained from Nikkato Corporation)

Mill: MIX-ROTAR VMR-5 (obtained from As One Corporation)

Number of rotation: number of rotation of mayonnaise bottle: 75 rpm

### <Production of Pigment Dispersion Liquids Wh-2 to Wh-47>

Pigment dispersion liquids Wh-2 to Wh-47 were produced in the same manner as in the production of Wh-1, except that unlike in the production of the pigment dispersion liquid Wh-1, the pigment, the dispersant polymer (pigment dispersant), and the polymerizable compounds, and contents thereof were changed to as presented in Tables 2-1 to 2-6 below.

The pigment dispersion liquids Wh-1 to Wh-45 correspond to Examples, and the pigment dispersion liquids Wh-46 and Wh-47 correspond to Comparative Examples.

TABLE 2-1

| | | | | | | | Polymerizable | | Storage | Skin | |
|---|---|---|---|---|---|---|---|---|---|---|---|
| | White pigment | | | Dispersant polymer | | | compound | | stability | sensitizing | |
| Pigment | | | Content | | | Content | | Content | Viscosity | potential | Carcinogenicity |
| dispersion | Compound | Product | (% by | | Amine value | (% by | Compound | (% by | change | SI | Colony |
| liquid No. | name | name | mass) | Name | (mgKOH/g) | mass) | No. | mass) | ratio | value | count |
| Wh-1 | Strontium | SW-100 | 15.0 | AJISPER | 11.2 | 6.0 | A1-1 | 79.0 | A | A | 1.1 |
| | titanate | | | PB821 | | | | | | | |
| Wh-2 | Strontium | SW-100 | 15.0 | AJISPER | 11.2 | 6.0 | A1-2 | 79.0 | A | A | 1.1 |
| | titanate | | | PB821 | | | | | | | |
| Wh-3 | Strontium | SW-100 | 15.0 | AJISPER | 11.2 | 6.0 | A1-3 | 79.0 | A | A | 1.0 |
| | titanate | | | PB821 | | | | | | | |
| Wh-4 | Strontium | SW-100 | 15.0 | AJISPER | 11.2 | 6.0 | A1-4 | 79.0 | A | A | 1.2 |
| | titanate | | | PB821 | | | | | | | |
| Wh-5 | Strontium | SW-350 | 15.0 | SOLSPERSE | 81.0 | 6.0 | A1-1 | 79.0 | A | A | 1.1 |
| | titanate | | | 71000 | | | | | | | |
| Wh-6 | Strontium | SW-350 | 15.0 | SOLSPERSE | 80.0 | 6.0 | A1-1 | 79.0 | A | A | 1.2 |
| | titanate | | | 73000 | | | | | | | |
| Wh-7 | Strontium | SW-350 | 15.0 | SOLSPERSE | 81.0 | 6.0 | A1-2 | 79.0 | A | A | 1.0 |
| | titanate | | | 74000 | | | | | | | |
| Wh-8 | Strontium | SW-350 | 15.0 | SOLSPERSE | 33.0 | 6.0 | A1-3 | 79.0 | A | A | 1.1 |
| | titanate | | | 88000 | | | | | | | |
| Wh-9 | Strontium | SW-350 | 15.0 | DISPERBYK- | 17.2 | 6.0 | A1-4 | 79.0 | A | A | 1.1 |
| | titanate | | | 9151 | | | | | | | |
| Wh-10 | Strontium | SW-350 | 30.0 | DISPERBYK- | 94.0 | 6.0 | A1-1 | 64.0 | A | A | 1.1 |
| | titanate | | | 180 | | | | | | | |

TABLE 2-2

| | | | | | | | Polymerizable | | Storage | Skin | |
|---|---|---|---|---|---|---|---|---|---|---|---|
| | White pigment | | | Dispersant polymer | | | compound | | stability | sensitizing | |
| Pigment | | | Content | | | Content | | Content | Viscosity | potential | Carcinogenicity |
| dispersion | Compound | Product | (% by | | Amine value | (% by | Compound | (% by | change | SI | Colony |
| liquid No. | name | name | mass) | Name | (mgKOH/g) | mass) | No. | mass) | ratio | value | count |
| Wh-11 | Calcium | SC-110 | 15.0 | AJISPER | 11.2 | 6.0 | A1-1 | 79.0 | A | A | 1.1 |
| | titanate | | | PB821 | | | | | | | |
| Wh-12 | Calcium | SC-110 | 15.0 | DISPERBYK- | 94.0 | 6.0 | A1-2 | 79.0 | A | A | 1.2 |
| | titanate | | | 180 | | | | | | | |
| Wh-13 | Calcium | SC-110 | 15.0 | AJISPER | 11.2 | 6.0 | A1-3 | 79.0 | A | A | 1.2 |
| | titanate | | | PB821 | | | | | | | |
| Wh-14 | Calcium | SC-110 | 15.0 | DISPERBYK- | 94.0 | 6.0 | A1-4 | 79.0 | A | A | 1.1 |
| | titanate | | | 180 | | | | | | | |
| Wh-15 | Calcium | SC-110 | 30.0 | SOLSPERSE | 80.0 | 6.0 | A1-1 | 64.0 | A | A | 1.0 |
| | titanate | | | 71000 | | | | | | | |
| Wh-16 | Calcium | SC-110 | 50.0 | SOLSPERSE | 81.0 | 6.0 | A1-1 | 44.0 | A | A | 1.1 |
| | titanate | | | 73000 | | | | | | | |
| Wh-17 | Calcium | SC-110 | 15.0 | SOLSPERSE | 81.0 | 6.0 | A1-1 | 79.0 | A | A | 1.0 |
| | titanate | | | 74000 | | | | | | | |
| Wh-18 | Calcium | SC-110 | 15.0 | SOLSPERSE | 33.0 | 6.0 | A1-1 | 79.0 | A | A | 1.2 |
| | titanate | | | 88000 | | | | | | | |
| Wh-19 | Calcium | SC-110 | 15.0 | DISPERBYK- | 17.2 | 6.0 | A1-1 | 79.0 | A | A | 1.2 |
| | titanate | | | 9151 | | | | | | | |
| Wh-20 | Calcium | SC-110 | 15.0 | DISPERBYK- | 94.0 | 6.0 | A1-1 | 79.0 | A | A | 1.1 |
| | titanate | | | 180 | | | | | | | |

TABLE 2-3

| | | | | | | | Polymerizable | | Storage | Skin | |
|---|---|---|---|---|---|---|---|---|---|---|---|
| | White pigment | | | Dispersant polymer | | | compound | | stability | sensitizing | |
| Pigment | | | Content | | | Content | | Content | Viscosity | potential | Carcinogenicity |
| dispersion | Compound | Product | (% by | | Amine value | (% by | Compound | (% by | change | SI | Colony |
| liquid No. | name | name | mass) | Name | (mgKOH/g) | mass) | No. | mass) | ratio | value | count |
| Wh-21 | Zinc | SACHTOLITH | 15.0 | AJISPER | 11.2 | 6.0 | A1-1 | 79.0 | A | A | 1.4 |
| | sulfide | HD-S | | PB821 | | | | | | | |
| Wh-22 | Zinc | SACHTOLITH | 15.0 | AJISPER | 11.2 | 6.0 | A1-2 | 79.0 | A | A | 1.3 |
| | sulfide | HD-S | | PB821 | | | | | | | |
| Wh-23 | Zinc | SACHTOLITH | 15.0 | AJISPER | 11.2 | 6.0 | A1-3 | 79.0 | A | A | 1.5 |
| | sulfide | HD-S | | PB821 | | | | | | | |
| Wh-24 | Zinc | SACHTOLITH | 15.0 | AJISPER | 11.2 | 6.0 | A1-4 | 79.0 | A | A | 1.3 |
| | sulfide | HD-S | | PB821 | | | | | | | |
| Wh-25 | Zinc | SACHTOLITH | 30.0 | AJISPER | 11.2 | 6.0 | A1-1 | 79.0 | A | A | 1.5 |
| | sulfide | HD-S | | PB821 | | | | | | | |
| Wh-26 | Zinc | SACHTOLITH | 50.0 | AJISPER | 11.2 | 6.0 | A1-1 | 79.0 | A | A | 1.3 |
| | sulfide | HD-S | | PB821 | | | | | | | |
| Wh-27 | Zinc | SACHTOLITH | 15.0 | SOLSPERSE | 31.2 | 6.0 | A1-1 | 79.0 | A | A | 1.2 |
| | sulfide | HD-S | | 32000 | | | | | | | |
| Wh-28 | Zinc | SACHTOLITH | 15.0 | SOLSPERSE | 25.7 | 6.0 | A1-1 | 79.0 | A | A | 1.3 |
| | sulfide | HD-S | | 39000 | | | | | | | |
| Wh-29 | Zinc | SACHTOLITH | 15.0 | SOLSPERSE | 81.0 | 6.0 | A1-1 | 79.0 | A | A | 1.5 |
| | sulfide | IID-S | | 74000 | | | | | | | |
| Wh-30 | Zinc | SACHTOLITH | 15.0 | SOLSPERSE | 33.0 | 6.0 | A1-1 | 79.0 | A | A | i.3 |
| | sulfide | IID-S | | 88000 | | | | | | | |

TABLE 2-4

| | | | | | | | | | Storage | | |
|---|---|---|---|---|---|---|---|---|---|---|---|
| | White pigment | | | Dispersant polymer | | | Polymerizable | | stability | Skin | |
| Pigment | | | Content | | | Content | compound | | Viscosity | sensitizing | |
| dispersion | Compound | Product | (% by | | Amine value | (% by | Compound | Content | change | potential | Carcinogenicity |
| liquid No. | name | name | mass) | Name | (mgKOH/g) | mass) | No. | (% by mass) | ratio | SI value | Colony count |
| Wh-31 | Zinc oxide | XZ-100F | 15.0 | AJISPER | 11.2 | 6.0 | A1-1 | 79.0 | A | A | 1.4 |
| | | | | PB821 | | | | | | | |
| Wh-32 | Zinc oxide | XZ-100F | 15.0 | AJISPER | 11.2 | 6.0 | A1-2 | 79.0 | A | A | 1.5 |
| | | | | PB821 | | | | | | | |
| Wh-33 | Zinc oxide | XZ-100F | 15.0 | AJISPER | 11.2 | 6.0 | A1-3 | 79.0 | A | B | 1.3 |
| | | | | PB821 | | | | | | | |
| Wh-34 | Zinc oxide | XZ-100F | 15.0 | AJISPER | 11.2 | 6.0 | A1-4 | 79.0 | A | B | 1.3 |
| | | | | PB821 | | | | | | | |
| Wh-35 | Zinc oxide | XZ-100F | 30.0 | SOLSPERSE | 35.9 | 6.0 | A1-1 | 64.0 | A | A | 1.3 |
| | | | | 20000 | | | | | | | |
| Wh-36 | Zinc oxide | XZ-100F | 50.0 | SOLSPERSE | 41.6 | 6.0 | A1-1 | 44.0 | B | A | 1.4 |
| | | | | 24000 | | | | | | | |
| Wh-37 | Zinc oxide | XZ-300F | 15.0 | SOLSPERSE | 31.2 | 6.0 | A1-1 | 79.0 | A | B | 1.4 |
| | | | | 32000 | | | | | | | |
| Wh-38 | Zinc oxide | XZ-300F | 15.0 | SOLSPERSE | 25.7 | 6.0 | A1-1 | 79.0 | A | B | 1.3 |
| | | | | 39000 | | | | | | | |
| Wh-39 | Zinc oxide | XZ-300F | 15.0 | SOLSPERSE | 33.0 | 6.0 | A1-1 | 79.0 | B | B | 1.3 |
| | | | | 88000 | | | | | | | |
| Wh-40 | Zinc oxide | XZ-300F | 15.0 | BYK-180 | 94.0 | 6.0 | Λ1-1 | 79.0 | B | B | 1.3 |

TABLE 2-5

| | | | | | | | | | Storage | | |
|---|---|---|---|---|---|---|---|---|---|---|---|
| | White pigment | | | Dispersant polymer | | | Polymerizable | | stability | Skin | Carcino- |
| Pigment | | | Content | | | Content | compound | | Viscosity | sensitizing | genicity |
| dispersion | Compound | Product | (% by | | Amine value | (% by | Compound | Content | change | potential | Colony |
| liquid No. | name | name | mass) | Name | (mgKOH/g) | mass) | No. | (% by mass) | ratio | SI value | count |
| Wh-41 | Strontium | SW-100 | 10 | ΛJISPER | 11.2 | 6.0 | A1-1 | 79.0 | A | A | 1.4 |
| | titanate | | | PB821 | | | | | | | |
| | Calcium | SC-110 | 5 | | | | | | | | |
| Wh-42 | Calcium | SC-110 | 10 | ΛJISPER | 11.2 | 6.0 | A1-3 | 79.0 | A | A | 1.3 |
| | titanate | | | PB821 | | | | | | | |
| | Zinc | SACHTOLITH | 5 | | | | | | | | |
| | sulfide | HD-S | | | | | | | | | |
| Wh-43 | Strontium | SW-100 | 15 | SOLSPERS | 35.9 | 6.0 | A1-1 | 64.0 | A | A | 1.3 |
| | titanate | | | 20000 | | | | | | | |
| | Zinc | SACHTOLITH | 15 | | | | | | | | |
| | sulfide | HD-S | | | | | | | | | |
| Wh-44 | Strontium | SW-350 | 7.5 | SOLSPERS | 25.7 | 6.0 | A1-1 | 79.0 | A | A | 1.4 |
| | titanate | | | 39000 | | | | | | | |
| | Zinc oxide | XZ-100F | 7.5 | | | | | | | | |
| Wh-45 | Zinc | SACHTOLITH | 7.5 | BYK-180 | 94.0 | 6.0 | A1-1 | 79.0 | A | A | 1.3 |
| | sulfide | HD-S | | | | | | | | | |
| | Zinc oxide | XZ-100F | 7.5 | | | | | | | | |

TABLE 2-6

| | | | | | | | | | Storage | | |
|---|---|---|---|---|---|---|---|---|---|---|---|
| | White pigment | | | Dispersant polymer | | | Polymerizable | | stability | Skin | |
| Pigment | | | Content | | | Content | compound | | Viscosity | sensitizing | |
| dispersion | Compound | Product | (% by | | Amine value | (% by | Compound | Content | change | potential | Carcinogenicity |
| liquid No. | name | name | mass) | Name | (mgKOH/g) | mass) | No. | (% by mass) | ratio | SI value | Colony count |
| Wh-46 | Titanium | JR405 | 15 | BYK-2061 | 3.0 | 6.0 | ACMO | 79.0 | D | C | 3.4 |
| | oxide | | | | | | | | | | |
| Wh-47 | Titanium | JR405 | 15 | BYK-109 | 140.0 | 6.0 | IBXA | 79.0 | C | D | 3.8 |
| | oxide | | | | | | | | | | |

In Tables 2-1 to 2-6 above, the product names and supplier names of the polymerizable compounds and the dispersant polymers (pigment dispersant) are as follows.

### Dispersion Medium

ACMO: Acryloylmorpholine, obtained from KJ Chemicals Corporation, SI=1.41
IBXA: Isobornyl acrylate, obtained from Osaka Organic Chemical Industry Ltd., SI=8.30

### Pigment Dispersant

BYK-2061: obtained from Byk-Chemie Japan K.K., with an amine value of 3.0
BYK-109: obtained from Byk-Chemie Japan K.K., with an amine value of 140

The viscosity change ratio (storage stability) of the obtained pigment dispersion liquids Wh-1 to Wh-47 was evaluated in the manner described below. The evaluation results are presented in Tables 2-1 to 2-5 above.

### <Viscosity Change Ratio>

The initial viscosity of each of the pigment dispersion liquids Wh-1 to Wh-47 was measured immediately after production, with a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec⁻¹. Subsequently, the active-energy-ray-curable composition was left to stand still at 70 degrees C. for 14 days. Subsequently, the viscosity after storage was measured under the same conditions as the measurement of the initial viscosity. The viscosity change ratio was calculated according to Formula (3) below. A lower viscosity change ratio represents a better storage stability and a better dispersibility.

Viscosity change ratio (%)=((viscosity after storage at 70 degrees C. for 14 days−initial viscosity)/initial viscosity)×100 Formula (3)

Based on the measured viscosity change ratio, “storage stability” was evaluated according to the evaluation criteria described below.

### —Evaluation Criteria—

A: The viscosity change ratio was 5% or lower.

B: The viscosity change ratio was higher than 5% but 15% or lower.

C: The viscosity change ratio was higher than 15% but 30% or lower.

D: The viscosity change ratio was higher than 30%.

### <Evaluation of Skin Sensitizing Potential>

The stimulation index (SI) value of the compositions produced by the method described above was measured by a LLNA method stipulated by, for example, OECD Test Guideline 429. The measured values are presented in Tables 2-1 to 2-5. The ratings B and A are practically usable levels.

### —Evaluation Criteria—

A: The SI value was lower than 1.6.

B: The SI value was 1.6 or higher but 3 or lower.

C: The SI value was higher than 3 but lower than 6.

D: The SI value was 6 or higher.

### Example 1

The pigment dispersion liquid Wh-1 (20.0 parts by mass), the compound A1-1 (74.8 parts by mass), the polymerization initiator C-1 (product name: DETX-S, obtained from Nippon Kayaku Co., Ltd.) (5.0 parts by mass), a polymerization inhibitor (product name: METHOQUINONE, obtained from Nippon Kayaku Co., Ltd.) (0.1 parts by mass), and a surfactant (product name: BYK-UV3510, obtained from Byk-Chemie Japan K.K.) (0.1 parts by mass) were mixed, and filtrated through a membrane filter to remove coarse particles, to obtain an active-energy-ray-curable composition of Example 1.

### Examples 2 to 50 and Comparative Examples 1 to 10

Active-energy-ray-curable compositions of Examples 2 to 50 and Comparative Examples 1 to 10 were obtained in the same manner as in Example 1, except that the composition and contents of Examples 2 to 50 and Comparative Examples 1 to 10 were changed from Example 1 as presented in Tables 3-1 to 3-6. The compositions and contents (parts by mass) of Examples 2 to 50 and Comparative Examples 1 to 10 are presented in Tables 3-1 to 3-6.

TABLE 3-1

| | Ex. | | | | | | | | | |
|---|---|---|---|---|---|---|---|---|---|---|
| | 1 | 2 | 3 | 4 | 5 | 6 | 7 | 8 | 9 | 10 |
| | Kind | | | | | | | | | |
| Pigment | Wh-1 | Wh-2 | Wh-3 | Wh-4 | Wh-5 | Wh-6 | Wh-7 | Wh-8 | Wh-9 | Wh-10 |
| dispersion | Content (% by mass) | | | | | | | | | |
| liquid | 20 | 20 | 20 | 20 | 20 | 20 | 20 | 20 | 20 | 20 |
| A1-1 | 74.8 | 74.8 | 74.8 | 74.8 | 61.8 | 74.8 | 74.8 | 74.8 | 74.8 | 61.8 |
| A1-2 | | | | | | | | | | |
| A1-3 | | | | | | | | | | |
| A1-4 | | | | | | | | | | |
| A2-1 | | | | | | | | | | |
| A2-2 | | | | | | | | | | |
| A2-3 | | | | | | | | | | |
| A2-4 | | | | | | | | | | |
| A2-5 | | | | | | | | | | |
| A2-6 | | | | | | | | | | |
| A2-7 | | | | | | | | | | |
| A2-8 | | | | | | | | | | |
| A3-1 | | | | | | | | | | |
| A3-2 | | | | | | | | | | |
| A4-1 | | | | | | | | | | |
| C-1 | 5.0 | 5.0 | 5.0 | 5.0 | | 5.0 | 5.0 | 5.0 | 5.0 | |
| C-2 | | | | | | | | | | |
| C-3 | | | | | | | | | | |
| C-4 | | | | | 9.0 | | | | | 9.0 |
| C-5 | | | | | | | | | | |
| C-6 | | | | | | | | | | |
| C-7 | | | | | | | | | | |
| C-8 | | | | | | | | | | |
| C-9 | | | | | | | | | | |
| D-1 | | | | | 9.0 | | | | | 9.0 |
| D-2 | | | | | | | | | | |
| D-3 | | | | | | | | | | |
| Polymerization | 0.1 | 0.1 | 0.1 | 0.1 | 0.1 | 0.1 | 0.1 | 0.1 | 0.1 | 0.1 |
| inhibitor | | | | | | | | | | |
| Surfactant | 0.1 | 0.1 | 0.1 | 0.1 | 0.1 | 0.1 | 0.1 | 0.1 | 0.1 | 0.1 |
| Total of above | 100.0 | 100.0 | 100.0 | 100.0 | 100.0 | 100.0 | 100.0 | 100.0 | 100.0 | 100.0 |
| components | | | | | | | | | | |

TABLE 3-2

| | Ex. | | | | | | | | | |
|---|---|---|---|---|---|---|---|---|---|---|
| | 11 | 12 | 13 | 14 | 15 | 16 | 17 | 18 | 19 | 20 |
| | Kind | | | | | | | | | |
| Pigment | Wh-11 | Wh-12 | Wh-13 | Wh-14 | Wh-15 | Wh-16 | Wh-17 | Wh-18 | Wh-19 | Wh-20 |
| dispersion | Content (% by mass) | | | | | | | | | |
| liquid | 20 | 20 | 20 | 20 | 20 | 20 | 20 | 20 | 20 | 20 |
| A1-1 | 2.0 | 12.0 | | | | 12.0 | 5.0 | | | 10.0 |
| A1-2 | | | 31.8 | 31.8 | | | | 14.8 | | 10.0 |
| A1-3 | | | | | | | | | | 10.0 |
| A1-4 | 14.8 | 19.8 | | | 36.8 | 31.8 | 26.8 | 20.0 | 34.8 | 21.8 |
| A2-1 | | | | | | | | | | |
| A2-2 | | | | | | | | | 10.0 | |
| A2-3 | | | | | | | | | | |
| A2-4 | | | | | 5.0 | 9.0 | 15.0 | | | |
| A2-5 | 10.0 | 30.0 | | 10.0 | 5.0 | | | 17.0 | | |
| A2-6 | | | | 10.0 | 10.0 | | 5.0 | | | |
| A2-7 | 5.0 | | 10.0 | 10.0 | 5.0 | 5.0 | | | 17.0 | |
| A2-8 | 30.0 | | 20.0 | | | 4.0 | 10.0 | 10.0 | | 10.0 |
| A3-1 | | | | | | | | | | |
| A3-2 | | | | | | | | | | |
| A4-1 | | | | | | | | | | |
| C-1 | | | | | | | | | | 9.0 |
| C-2 | | | | | | | | | | |
| C-3 | 9.0 | 9.0 | 9.0 | | 9.0 | 9.0 | 9.0 | 9.0 | 9.0 | |
| C-4 | | | | 9.0 | | | | | | |
| C-5 | | | | | | | | | | |
| C-6 | | | | | | | | | | |
| C-7 | | | | | | | | | | |
| C-8 | | | | | | | | | | |
| C-9 | | | | | | | | | | |
| D-1 | 9.0 | 9.0 | 9.0 | 9.0 | 9.0 | 9.0 | 9.0 | | | |
| D-2 | | | | | | | | 9.0 | 9.0 | 9.0 |
| D-3 | | | | | | | | | | |
| Polymerization | 0.1 | 0.1 | 0.1 | 0.1 | 0.1 | 0.1 | 0.1 | 0.1 | 0.1 | 0.1 |
| inhibitor | | | | | | | | | | |
| Surfactant | 0.1 | 0.1 | 0.1 | 0.1 | 0.1 | 0.1 | 0.1 | 0.1 | 0.1 | 0.1 |
| Total of above | 100.0 | 100.0 | 100.0 | 100.0 | 100.0 | 100.0 | 100.0 | 100.0 | 100.0 | 100.0 |
| components | | | | | | | | | | |

TABLE 3-3

| | Ex. | | | | | | | | | |
|---|---|---|---|---|---|---|---|---|---|---|
| | 21 | 22 | 23 | 24 | 25 | 26 | 27 | 28 | 29 | 30 |
| | Kind | | | | | | | | | |
| Pigment | Wh-21 | Wh-22 | Wh-23 | Wh-24 | Wh-25 | Wh-26 | Wh-27 | Wh-28 | Wh-29 | Wh-30 |
| dispersion | Content (% by mass) | | | | | | | | | |
| liquid | 20 | 20 | 20 | 20 | 20 | 20 | 20 | 20 | 20 | 20 |
| A1-1 | 20.0 | | 31.8 | 31.8 | 36.8 | | 5.0 | | 74.8 | |
| A1-2 | 2.0 | 12.0 | | 20.0 | | 12.0 | 5.0 | 14.8 | | 21.8 |
| A1-3 | 10.0 | | 20.0 | | | | 20.0 | | 34.8 | 10.0 |
| A1-4 | 14.8 | 19.8 | | | | 31.8 | 26.8 | 20.0 | | 10.0 |
| A2-1 | 10.0 | | | | | | | | | 10.0 |
| A2-2 | | | | | | | | | | |
| A2-3 | | | | | | | | | | |
| A2-4 | | | | | | | | | | |
| A2-5 | | 30.0 | | | | 4.0 | | 17.0 | | |
| A2-6 | | | | | 5.0 | 5.0 | 5.0 | | | |
| A2-7 | 5.0 | | 10.0 | 10.0 | 10.0 | 5.0 | | | 17.0 | |
| A2-8 | | | | | 10.0 | 4.0 | | 10.0 | 10.0 | 10.0 |
| A3-1 | | | | | | | | | | |
| A3-2 | | | | | | | | | | |
| A4-1 | | | | | | | | | | |
| C-1 | | | | | | | | | | 9.0 |
| C-2 | | | | | | | | | | |
| C-3 | 9.0 | 9.0 | 9.0 | | 9.0 | 9.0 | 9.0 | 9.0 | 9.0 | |
| C-4 | | | | 9.0 | | | | | | |
| C-5 | | | | | | | | | | |
| C-6 | | | | | | | | | | |
| C-7 | | | | | | | | | | |
| C-8 | | | | | | | | | | |
| C-9 | | | | | | | | | | |
| D-1 | 9.0 | 9.0 | 9.0 | 9.0 | 9.0 | 9.0 | 9.0 | | | |
| D-2 | | | | | | | | 9.0 | 9.0 | 9.0 |
| D-3 | | | | | | | | | | |
| Polymerization | 0.1 | 0.1 | 0.1 | 0.1 | 0.1 | 0.1 | 0.1 | 0.1 | 0.1 | 0.1 |
| inhibitor | | | | | | | | | | |
| Surfactant | 0.1 | 0.1 | 0.1 | 0.1 | 0.1 | 0.1 | 0.1 | 0.1 | 0.1 | 0.1 |
| Total of above | 100.0 | 100.0 | 100.0 | 100.0 | 100.0 | 100.0 | 100.0 | 100.0 | 100.0 | 100.0 |
| components | | | | | | | | | | |

TABLE 3-4

| | Ex. | | | | | | | | | |
|---|---|---|---|---|---|---|---|---|---|---|
| | 31 | 32 | 33 | 34 | 35 | 36 | 37 | 38 | 39 | 40 |
| | Kind | | | | | | | | | |
| Pigment | Wh-31 | Wh-32 | Wh-33 | Wh-34 | Wh-35 | Wh-36 | Wh-37 | Wh-38 | Wh-39 | Wh-40 |
| dispersion | Content (% by mass) | | | | | | | | | |
| liquid | 20 | 20 | 20 | 20 | 20 | 20 | 20 | 20 | 20 | 20 |
| A1-1 | 16.8 | 31.8 | 10.0 | | 20.0 | 9.0 | 15.0 | 6.0 | 17.8 | 20.0 |
| A1-2 | 20.0 | | 16.8 | 31.8 | | | | | | |
| A1-3 | | | | | 16.8 | 16.8 | | | | 10.0 |
| A1-4 | | | | | 10.0 | | 11.8 | 20.0 | | |
| A2-1 | 10.0 | | | | | 10.0 | | 5.8 | | |
| A2-2 | | 10.0 | | | | 10.0 | 10.0 | | | |
| A2-3 | | | 10.0 | | | 7.0 | 10.0 | | | 10.0 |
| A2-4 | | | | 10.0 | | | 10.0 | 10.0 | | |
| A2-5 | | 20.0 | | | 10.0 | | | 20.0 | | 10.0 |
| A2-6 | | | | | | | 5.0 | | 20.0 | |
| A2-7 | 5.0 | | 10.0 | 10.0 | | 5.0 | | | 20.0 | |
| A2-8 | 10.0 | | 15.0 | 10.0 | 5.0 | 4.0 | | | 4.0 | 11.8 |
| A3-1 | | | | | | | | | | |
| A3-2 | | | | | | | | | | |
| A4-1 | | | | | | | | | | |
| C-1 | | | | 9.0 | | | | | | |
| C-2 | | | | | | | | 9.0 | | |
| C-3 | | | | | | | | | | |
| C-4 | | | | | | | | | 9.0 | 9.0 |
| C-5 | 9.0 | 9.0 | 9.0 | | | | | | | |
| C-6 | | | | | 9.0 | 9.0 | 9.0 | | | |
| C-7 | | | | | | | | | | |
| C-8 | | | | | | | | | | |
| C-9 | | | | | | | | | | |
| D-1 | 9.0 | 9.0 | 9.0 | | | | | | | |
| D-2 | | | | | | | | 9.0 | 9.0 | 9.0 |
| D-3 | | | | 9.0 | 9.0 | 9.0 | 9.0 | | | |
| Polymerization | 0.1 | 0.1 | 0.1 | 0.1 | 0.1 | 0.1 | 0.1 | 0.1 | 0.1 | 0.1 |
| inhibitor | | | | | | | | | | |
| Surfactant | 0.1 | 0.1 | 0.1 | 0.1 | 0.1 | 0.1 | 0.1 | 0.1 | 0.1 | 0.1 |
| Total of above | 100.0 | 100.0 | 100.0 | 100.0 | 100.0 | 100.0 | 100.0 | 100.0 | 100.0 | 100.0 |
| components | | | | | | | | | | |

TABLE 3-5

| | Ex. | | | | | | | | | |
|---|---|---|---|---|---|---|---|---|---|---|
| | 41 | 42 | 43 | 44 | 45 | 46 | 47 | 48 | 49 | 50 |
| | Kind | | | | | | | | | |
| Pigment | Wh-41 | Wh-42 | Wh-43 | Wh-44 | Wh-45 | Wh-41 | Wh-42 | Wh-43 | Wh-44 | Wh-45 |
| dispersion | Content (% by mass) | | | | | | | | | |
| liquid | 20 | 20 | 20 | 20 | 20 | 20 | 20 | 20 | 20 | 20 |
| A1-1 | 74.8 | 74.8 | 74.8 | 74.8 | 61.8 | 54.8 | 54.8 | 54.8 | 54.8 | 41.8 |
| A1-2 | | | | | | | | | | |
| A1-3 | | | | | | | | | | |
| A1-4 | | | | | | | | | | |
| A2-1 | | | | | | | | | | |
| A2-2 | | | | | | | | | | |
| A2-3 | | | | | | | | | | |
| A2-4 | | | | | | | | | | |
| A2-5 | | | | | | | | | | |
| A2-6 | | | | | | | | | | |
| A2-7 | | | | | | | | | | |
| A2-8 | | | | | | 20.0 | 20.0 | 20.0 | 20.0 | 20.0 |
| A3-1 | | | | | | | | | | |
| A3-2 | | | | | | | | | | |
| A4-1 | | | | | | | | | | |
| C-1 | 5.0 | 5.0 | 5.0 | 5.0 | | 5.0 | 5.0 | 5.0 | 5.0 | |
| C-2 | | | | | | | | | | |
| C-3 | | | | | | | | | | |
| C-4 | | | | | 9.0 | | | | | 9.0 |
| C-5 | | | | | | | | | | |
| C-6 | | | | | | | | | | |
| C-7 | | | | | | | | | | |
| C-8 | | | | | | | | | | |
| C-9 | | | | | | | | | | |
| D-1 | | | | | 9.0 | | | | | 9.0 |
| D-2 | | | | | | | | | | |
| D-3 | | | | | | | | | | |
| Polymerization | 0.1 | 0.1 | 0.1 | 0.1 | 0.1 | 0.1 | 0.1 | 0.1 | 0.1 | 0.1 |
| inhibitor | | | | | | | | | | |
| Surfactant | 0.1 | 0.1 | 0.1 | 0.1 | 0.1 | 0.1 | 0.1 | 0.1 | 0.1 | 0.1 |
| Total of above | 100.0 | 100.0 | 100.0 | 100.0 | 100.0 | 100.0 | 100.0 | 100.0 | 100.0 | 100.0 |
| components | | | | | | | | | | |

TABLE 3-6

| | Comp. Ex. | | | | | | | | | |
|---|---|---|---|---|---|---|---|---|---|---|
| | 1 | 2 | 3 | 4 | 5 | 6 | 7 | 8 | 9 | 10 |
| | Kind | | | | | | | | | |
| Pigment | Wh-41 | Wh-41 | Wh-41 | Wh-41 | Wh-41 | Wh-42 | Wh-42 | Wh-42 | Wh-42 | Wh-42 |
| dispersion | Content (% by mass) | | | | | | | | | |
| liquid | 20 | 20 | 20 | 20 | 20 | 20 | 20 | 20 | 20 | 20 |
| A1-1 | | | 31.8 | 31.8 | 36.8 | | 5.0 | | | |
| A1-2 | 2.0 | 12.0 | | | | 12.0 | 5.0 | 14.8 | | 21.8 |
| A1-3 | | | | | | | | | 34.8 | |
| A1-4 | 14.8 | 19.8 | | | | 31.8 | 26.8 | 20.0 | | |
| A2-1 | 10.0 | | | | | | | | | |
| A2-2 | | | | | | | | | | |
| A2-3 | | | | | | | | | | |
| A2-4 | | | | | | | | | | |
| A2-5 | | 30.0 | | | | | | 17.0 | | |
| A2-6 | | | | | | 3.0 | 5.0 | | | |
| A2-7 | 5.0 | | 10.0 | 10.0 | | 5.0 | | | 17.0 | 10.0 |
| A2-8 | | | | | | 4.0 | | | | 10.0 |
| A3-1 | 30.0 | 10.0 | 20.0 | 10.0 | 10.0 | 9.0 | | 10.0 | 10.0 | 20.0 |
| A3-2 | | | | 20.0 | | 10.0 | 5.0 | 10.0 | | 10.0 |
| A4-1 | 10.0 | | 10.0 | | 25.0 | | 25.0 | | 10.0 | |
| C-1 | | | | 3.0 | | | | | | |
| C-2 | | | | | | | | | | |
| C-3 | | | | | | | 4.0 | | | |
| C-4 | | | | | | | | | | |
| C-5 | | | | | | | | | | |
| C-6 | | | | | | | | | | |
| C-7 | | | | | | | | | | |
| C-8 | 5.0 | 5.0 | 5.0 | | 5.0 | 5.0 | 4.0 | 5.0 | 5.0 | 5.0 |
| C-9 | | | | 5.0 | | | | | | |
| D-1 | 3.0 | 3.0 | 3.0 | | | | | | | |
| D-2 | | | | | | | | 3.0 | 3.0 | 3.0 |
| D-3 | | | | | | | | | | |
| Polymerization | 0.1 | 0.1 | 0.1 | 0.1 | 0.1 | 0.1 | 0.1 | 0.1 | 0.1 | 0.1 |
| inhibitor | | | | | | | | | | |
| Surfactant | 0.1 | 0.1 | 0.1 | 0.1 | 0.1 | 0.1 | 0.1 | 0.1 | 0.1 | 0.1 |
| Total of above | 100.0 | 100.0 | 100.0 | 100.0 | 100.0 | 100.0 | 100.0 | 100.0 | 100.0 | 100.0 |
| components | | | | | | | | | | |

Liquid permeability (initial and after storage), dischargeability (initial and after storage), viscosity change ratio (storage stability), curability, and adhesiveness of the obtained active-energy-ray-curable compositions of Examples 1 to 50 and Comparative Examples 1 to 10 were evaluated in the manners described below. The results are presented in Tables 4-1 to 4-6.

### (White Hiding Power)

Using a printer for evaluation obtained by remodeling a printer (apparatus name: SG7100, obtained from Ricoh Company, Ltd.), a solid image of each obtained active-energy-ray-curable composition was formed with a size of 10 cm×10 cm over a recording medium (product name: COSMOSHINE A4300 COAT PET FILM, obtained from Toyobo Co., Ltd., an average thickness: 100 micrometers, color: clear). The obtained solid image was cured with a UV-LED device for an inkjet printer (device name: UV-LED MODULE (single-pass water cooling, obtained from Ushio Inc.), at an illuminance of 1 W/cm² with an amount of light for irradiation of 500 mJ/cm², to obtain an image (cured product) having an average thickness of 10 micrometers and a size of 10 cm×10 cm.

The amount of light for irradiation was measured with an ultraviolet intensity meter (instrument name: UM-10) and a light receiver (instrument name: UM-400) (both obtained from Konica Minolta, Inc.). The method for measuring the average thickness includes measuring thickness at ten positions using an electric micrometer (obtained from Anritsu Corporation) and averaging the measurements. The printer for evaluation was obtained by remodeling the printer SG7100 (obtained from Ricoh Company, Ltd.) by incorporating a MH2620 head (obtained from Ricoh Company, Ltd.) in which the head portion was capable of discharging inks through heating via conveying and driving systems of the printer SG7100 and capable of handling high viscosity inks.

Black paper (product name: EXTRA BLACK, obtained from Takeo Co., Ltd., with a density of 1.65) was placed over a side of the recording medium opposite to the side over which the obtained image (cured product) was formed. The density of the image (cured product) relative to the black color was measured with a reflective spectral densitometer (instrument name: X-RITE 939, obtained from X-Rite Inc.). A hiding ratio was calculated according to Formula (1) below, to evaluate “hiding power”. A higher hiding ratio represents a better hiding power.

Hiding ratio (%)=[1−(density of image (cured product)/density of black paper (1.65))]×100 Formula (1)

### —Evaluation Criteria—

A: 80% or higher

B: 70% or higher but lower than 80%

C: 60% or higher but lower than 70%

D: Lower than 60%

### (Liquid Permeability)

The active-energy-ray-curable composition of each of Examples 1 to 50 and Comparative Examples 1 to 10 (100 mL) was filtrated through a hydrophobic PTFE membrane filter having a diameter of 10.0 micrometers under pressurization at 50 kPa, to evaluate initial liquid permeability. Liquid permeability (liquid permeability after storage) of the active-energy-ray-curable composition left to stand still at 70 degrees C. for 14 days, used in the evaluation of storage stability described below, was also evaluated in the same manner.

### —Evaluation Criteria—

A: The hundred milliliters of the active-energy-ray-curable composition wholly permeated the filter.

B: Fifty milliliters or more but less than 75 mL of the active-energy-ray-curable composition permeated the filter.

C: Twenty-five milliliters or more but less than 50 mL of the active-energy-ray-curable composition permeated the filter.

D: Less than 25 mL of the active-energy-ray-curable composition permeated the filter.

### (Discharging Stability)

A piezo-type inkjet head in which an ink in a portion from the ink supplying system to the head portion was temperature-adjustable was used as an inkjet recording apparatus. The active-energy-ray-curable composition of each of Examples 1 to 50 and Comparative Examples 1 to 10 was filled in the inkjet recording apparatus, and adjusted to a temperature at which the viscosity would be 10 mPa·s, to evaluate initial dischargeability at a discharging speed of 3 kHz. The active-energy-ray-curable composition was discharged continuously for 60 minutes. Sixty minutes later, dischargeability was evaluated according to the evaluation criteria described below (initial dischargeability). The active-energy-ray-curable composition left to stand still at 70 degrees C. for 14 days, used in the evaluation of storage stability described below, was also filled in the inkjet recording apparatus, to evaluate dischargeability in the same manner (dischargeability after storage). The temperature condition was the same as the initial evaluation condition.

Using a temperature-adjustable cone plate rotary viscometer, a temperature condition at which the ink viscosity would be 10.0±0.5 mPa·s was explored, and used as the heating condition for printing.

### —Evaluation Criteria—

A: The active-energy-ray-curable composition was discharged normally from 95% or more of the nozzles.

B: The active-energy-ray-curable composition was discharged normally from 90% or more of the nozzles.

C: The active-energy-ray-curable composition was discharged normally from 70% or more of the nozzles.

D: The active-energy-ray-curable composition was discharged normally from less than 70% of the nozzles.

### (Storage Stability: Viscosity Change Ratio)

The initial viscosity of the active-energy-ray-curable composition of each of Examples 1 to 50 and Comparative Examples 1 to 10 was measured immediately after production, with a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec⁻¹. Subsequently, each active-energy-ray-curable composition was left to stand still at 70 degrees C. for 14 days, and the viscosity after storage was measured under the same conditions as the measurement of the initial viscosity. The viscosity change ratio was calculated according to Formula (3) below. A lower viscosity change ratio represents a better storage stability ad a better dispersibility.

Viscosity change ratio (%)=((viscosity after storage at 70 degrees C. for 14 days−initial viscosity)/initial viscosity)×100 (3)

### (Evaluation of Curability)

Each active-energy-ray-curable composition was filled in a composition stored container formed of plastic, and incorporated in an image forming apparatus including an inkjet head (obtained from Ricoh Company, Ltd., “MH5440”) serving as a discharging unit, a UV-LED (obtained from Integration Technology Japan, “LED ZERO”, with a wavelength of 395 nm and an illuminance of 1.0 W/cm² at an irradiated surface) serving as an active energy ray irradiator, a controller configured to control discharging, and a supplying path from the composition stored container to the inkjet head.

With appropriate temperature adjustment of the inkjet head in a manner that the viscosity of the active-energy-ray-curable composition would be from 10 mPa·s through 12 mPa·s, the active-energy-ray-curable composition was inkjet-discharged with a film thickness of 10 micrometers over a commercially available PET film (obtained from Toyobo Co., Ltd., “COSMOSHINE A4100” with a thickness of 188 micrometers), which was a general-purpose film material, and irradiated with ultraviolet rays using a UV-LED, to produce a printed image. The coating film was determined to have been cured when the coating film reached a state having no tackiness when touched. The cumulative amount of light for irradiation needed for curing was measured. An active-energy-ray-curable composition for which the cumulative amount of light for irradiation needed for curing was 2.0 J/cm² or lower was judged as practically usable.

### (Evaluation of Adhesiveness)

In the same manner as in the evaluation of curability, an image (cured product) of the active-energy-ray-curable composition of each of Examples 1 to 50 and Comparative Examples 1 to 10 was obtained with an average thickness of 10 micrometers and a size of 10 cm×10 cm. A solid portion of the obtained image (cured product) was cut into at 1 mm intervals in a grid pattern including 100 grid squares in accordance with JiS K5400, peeled with an adhesive cellophane tape (product name: SCOTCH MENDING TAPE (18 mm), obtained from 3M Company), and observed with a loupe (product name: PEAK No. 1961 (×10), obtained from Tokai Sangyo Co., Ltd.) to count the number of grid squares that were not peeled, to evaluate “adhesiveness” according to the evaluation criteria described below.

### —Evaluation Criteria—

A: The number of grid squares that were not peeled was 100 grid squares out of 100 grid squares.

B: The number of grid squares that were not peeled was 80 grid squares or more but 99 grid squares or less out of 100 grid squares.

C: The number of grid squares that were not peeled was 40 grid squares or more but 79 grid squares or less out of 100 grid squares.

D: The number of grid squares that were not peeled was 39 grid squares or less out of 100 grid squares.

TABLE 4-1

| | Ex. | | | | | | | | | |
|---|---|---|---|---|---|---|---|---|---|---|
| Evaluation items | 1 | 2 | 3 | 4 | 5 | 6 | 7 | 8 | 9 | 10 |
| Pigment dispersion | Wh-1 | Wh-2 | Wh-3 | Wh-4 | Wh-5 | Wh-6 | Wh-7 | Wh-8 | Wh-9 | Wh-10 |
| liquid No. | | | | | | | | | | |
| Viscosity change | A | A | A | A | A | A | A | A | A | A |
| ratio (%) | | | | | | | | | | |
| Cumulative amount | 0.5 | 0.4 | 0.4 | 0.5 | 0.8 | 0.5 | 0.6 | 0.7 | 0.5 | 0.8 |
| of light for irradiation | | | | | | | | | | |
| needed for curing | | | | | | | | | | |
| (J/cm²) | | | | | | | | | | |
| White hiding power | A | B | A | A | A | B | B | B | A | A |
| Liquid permeability | A | A | A | B | A | A | B | A | A | B |
| Discharging stability | A | A | A | A | A | A | A | A | A | A |
| Adhesiveness | A | B | B | A | B | A | B | A | B | A |
| Skin sensitizing | A | A | A | A | A | A | A | B | A | B |
| potential | | | | | | | | | | |
| Carcinogenicity | 1.0 | 1.0 | 1.0 | 1.0 | 1.0 | 1.1 | 1.1 | 1.0 | 1.0 | 1.1 |
| (colony count) | | | | | | | | | | |

TABLE 4-2

| | Ex. | | | | | | | | | |
|---|---|---|---|---|---|---|---|---|---|---|
| Evaluation items | 11 | 12 | 13 | 14 | 15 | 16 | 17 | 18 | 19 | 20 |
| Pigment dispersion | Wh-11 | Wh-12 | Wh-13 | Wh-14 | Wh-15 | Wh-16 | Wh-17 | Wh- 18 | Wh-19 | Wh-20 |
| liquid No. | | | | | | | | | | |
| Viscosity change | A | A | A | A | A | A | A | A | A | A |
| ratio (%) | | | | | | | | | | |
| Cumulative amount | 1.0 | 0.9 | 0.9 | 0.8 | 1.1 | 1.0 | 0.9 | 0.9 | 1.1 | 1.2 |
| of light for irradiation | | | | | | | | | | |
| needed for curing | | | | | | | | | | |
| (J/cm²) | | | | | | | | | | |
| White hiding power | A | A | A | B | B | B | B | A | B | A |
| Liquid permeability | B | A | B | A | A | B | A | B | A | B |
| Discharging stability | A | A | A | B | B | B | B | B | A | B |
| Adhesiveness | A | B | A | B | A | A | A | A | B | B |
| Skin sensitizing | A | A | A | A | A | A | A | A | A | A |
| potential | | | | | | | | | | |
| Carcinogenicity | 1.2 | 1.1 | 1.0 | 1.1 | 1.0 | 1.2 | 1.1 | 1.3 | 1.3 | 1.1 |
| (colony count) | | | | | | | | | | |

TABLE 4-3

| | Ex. | | | | | | | | | |
|---|---|---|---|---|---|---|---|---|---|---|
| Evaluation items | 21 | 22 | 23 | 24 | 25 | 26 | 27 | 28 | 29 | 30 |
| Pigment | Wh-21 | Wh-22 | Wh-23 | Wh-24 | Wh-25 | Wh-26 | Wh-27 | Wh-28 | Wh-29 | Wh-30 |
| dispersion liquid | | | | | | | | | | |
| No. | | | | | | | | | | |
| Viscosity change | B | B | A | B | B | A | B | B | B | A |
| ratio (%) | | | | | | | | | | |
| Cumulative | 1.1 | 1.2 | 1.2 | 1.3 | 1.3 | 1.6 | 1.6 | 1.3 | 1.3 | 1.4 |
| amount of light for | | | | | | | | | | |
| irradiation needed | | | | | | | | | | |
| for curing (J/cm²) | | | | | | | | | | |
| White hiding | A | A | B | B | B | B | A | B | B | B |
| power | | | | | | | | | | |
| Liquid | B | A | B | A | A | B | A | B | A | B |
| permeability | | | | | | | | | | |
| Discharging | A | A | A | B | B | B | B | B | A | B |
| stability | | | | | | | | | | |
| Adhesiveness | A | B | A | B | A | A | A | A | B | B |
| Skin sensitizing | A | B | A | B | B | A | A | A | B | A |
| potential | | | | | | | | | | |
| Carcinogcnicity | 1.3 | 1.3 | 1.2 | 1.2 | 1.1 | 1.2 | 1.4 | 1.5 | 1.3 | 1.4 |
| (colony count) | | | | | | | | | | |

TABLE 4-4

| | Ex. | | | | | | | | | |
|---|---|---|---|---|---|---|---|---|---|---|
| Evaluation items | 31 | 32 | 33 | 34 | 35 | 36 | 37 | 38 | 39 | 40 |
| Pigment | Wh-31 | Wh-32 | Wh-33 | Wh-34 | Wh-35 | Wh-36 | Wh-37 | Wh-38 | Wh-39 | Wh-40 |
| dispersion liquid | | | | | | | | | | |
| No. | | | | | | | | | | |
| Viscosity change | B | B | B | A | B | B | A | B | A | A |
| ratio (%) | | | | | | | | | | |
| Cumulative | 1.6 | 1.8 | 1.7 | 1.5 | 1.7 | 1.4 | 1.5 | 1.8 | 1.9 | 1.8 |
| amount of light for | | | | | | | | | | |
| irradiation needed | | | | | | | | | | |
| for curing (J/cm²) | | | | | | | | | | |
| White hiding | B | B | B | B | B | B | B | B | B | B |
| power | | | | | | | | | | |
| Liquid | B | A | B | B | A | B | A | B | B | B |
| permeability | | | | | | | | | | |
| Discharging | A | A | A | B | B | B | B | B | A | B |
| stability | | | | | | | | | | |
| Adhesiveness | A | B | A | B | A | A | A | A | B | B |
| Skin sensitizing | B | B | A | B | B | B | A | A | B | A |
| potential | | | | | | | | | | |
| Carcinogenicity | 1.2 | 1.4 | 1.4 | 1.5 | 1.6 | 1.2 | 1.5 | 1.3 | 1.3 | 1.5 |
| (colony count) | | | | | | | | | | |

TABLE 4-5

| | Ex. | | | | | | | | | |
|---|---|---|---|---|---|---|---|---|---|---|
| Evaluation items | 41 | 42 | 43 | 44 | 45 | 46 | 47 | 48 | 49 | 50 |
| Pigment | Wh-41 | Wh-42 | Wh-43 | Wh-44 | Wh-45 | Wh-41 | Wh-42 | Wh-43 | Wh-44 | Wh-45 |
| dispersion liquid | | | | | | | | | | |
| No. | | | | | | | | | | |
| Viscosity change | A | A | A | A | A | A | A | A | A | A |
| ratio (%) | | | | | | | | | | |
| Cumulative | 0.5 | 0.4 | 0.4 | 0.5 | 0.8 | 0.5 | 0.6 | 0.7 | 0.5 | 0.8 |
| amount of light | | | | | | | | | | |
| for irradiation | | | | | | | | | | |
| needed for curing | | | | | | | | | | |
| (J/cm²) | | | | | | | | | | |
| White hiding | A | B | A | A | A | B | B | B | A | A |
| power | | | | | | | | | | |
| Liquid | A | A | A | B | A | A | B | A | A | B |
| permeability | | | | | | | | | | |
| Discharging | A | A | A | A | A | A | A | A | A | A |
| stability | | | | | | | | | | |
| Adhesiveness | A | B | B | A | B | A | B | A | B | A |
| Skin sensitizing | A | A | A | A | A | A | A | B | A | B |
| potential | | | | | | | | | | |
| Carcinogenicity | 1.3 | 1.3 | 1.4 | 1.3 | 1.2 | 1.3 | 1.3 | 1.3 | 1.2 | 1.2 |
| (colony count) | | | | | | | | | | |

TABLE 4-6

| | Comp. Ex. | | | | | | | | | |
|---|---|---|---|---|---|---|---|---|---|---|
| Evaluation items | 1 | 2 | 3 | 4 | 5 | 6 | 7 | 8 | 9 | 10 |
| Pigment | Wh-46 | Wh-46 | Wh-46 | Wh-46 | Wh-46 | Wh-47 | Wh-47 | Wh-47 | Wh-47 | Wh-47 |
| dispersion liquid | | | | | | | | | | |
| No. | | | | | | | | | | |
| Viscosity change | C | D | C | D | B | D | B | D | C | D |
| ratio (%) | | | | | | | | | | |
| Cumulative | 2.5 | 2.8 | 3.0 | 4.3 | 3.8 | 3.6 | 4.0 | 2.3 | 2.8 | 2.4 |
| amount of light for | | | | | | | | | | |
| irradiation needed | | | | | | | | | | |
| for curing (J/cm²) | | | | | | | | | | |
| White hiding | B | C | C | D | C | C | C | B | C | C |
| power | | | | | | | | | | |
| Liquid | C | D | D | C | C | C | C | C | C | B |
| permeability | | | | | | | | | | |
| Discharging | D | D | C | B | B | B | C | C | C | B |
| stability | | | | | | | | | | |
| Adhesiveness | D | D | D | C | C | B | B | B | B | B |
| Skin sensitizing | B | D | B | D | B | D | B | D | B | D |
| potential | | | | | | | | | | |
| Carcinogenicity | 3.2 | 3.8 | 3.5 | 4.4 | 4.2 | 3.4 | 3.1 | 4.6 | 4.7 | 3.8 |
| (colony count) | | | | | | | | | | |

As can be seen from the results in Tables 4-1 to 4-6, the active-energy-ray-curable composition (active-energy-ray-curable ink) of the present disclosure can satisfy all of white hiding power, liquid permeability, dischargeability, dispersion stability, curability, adhesiveness, and safety (skin sensitizing potential and carcinogenicity).

As regards the effect of reducing the colony count, strontium titanate (pigment dispersion liquids Wh-1 to Wh-10) had the highest effect of reducing the colony count, calcium titanate (pigment dispersion liquids Wh-11 to Wh-20) was the second highest, and zinc sulfide (pigment dispersion liquids Wh-21 to Wh-30) was the third highest.

Any composition in which the amount of adsorption of the dispersant is in the range of the present disclosure is considered to have a good dispersibility without, for example, aggregation of pigment particles. Moreover, without presence of an excessive free dispersant, such a composition is considered to have a good liquid permeability and a good dischargeability. At the same time, such a component is considered to have an improved curability and an improved adhesiveness without presence of an excessive dispersant.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An active-energy-ray-curable composition comprising:
a pigment;
a polymerizable compound; and
a pigment-adsorptive component,
wherein the pigment comprises at least one selected from the group consisting of strontium titanate, calcium titanate, zinc sulfide, and zinc oxide, and
wherein the polymerizable compound contains an acrylamide compound (A1) having an ester structure represented by General formula (1) below or General formula (4) below, 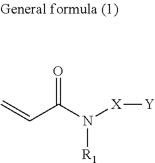
where in General formula (1), R₁ represents an alkyl group containing from one through six carbon atoms, X represents an alkylene group containing from one through six carbon atoms, and Y represents a structure represented by General formula (2) below or General formula (3) below, 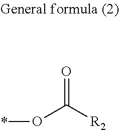
where in General formula (2), R₂ represents an alkyl group containing from one through ten carbon atoms, and * represents a binding site with the X, 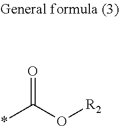
where in General formula (3), R₂ represents an alkyl group containing from one through ten carbon atoms, and * represents a binding site with the X, 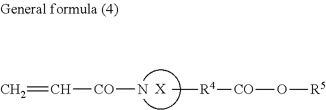
where in General formula (4), a ring X represents a nitrogen-containing ring structure containing from two through five carbon atoms, R⁴ represents a single bond, or a straight-chained or branched alkylene group containing from one through three carbon atoms, R⁵ represents a straight-chained or branched alkyl group containing from one through three carbon atoms, and a total number of carbon atoms contained in the ring X, R⁴, and R⁵ is from three through six.

2. The active-energy-ray-curable composition according to claim 1,
wherein the pigment-adsorptive component is a dispersant polymer (B1), and the dispersant polymer (B1) comprises at least one selected from the group consisting of polyester, polyurethane, and an acrylic skeleton.

3. The active-energy-ray-curable composition according to claim 2,
wherein the dispersant polymer (B1) has an amine value of 10 mgKOH/g or greater but 100 mgKOH/g or less, and
wherein the dispersant polymer (B1) comprises at least one selected from the group consisting of basic functional group-containing copolymers, acrylic block copolymers, and copolymers each containing an alkylol ammonium salt and an acid group.

4. The active-energy-ray-curable composition according to claim 1,
wherein the pigment has a 50% cumulative volume-based particle diameter of 30 nm or greater but 350 nm or less.

5. The active-energy-ray-curable composition according to claim 2,
wherein a blending amount of the dispersant polymer (B1) is 10% by mass or greater but 70% by mass or less relative to a total amount of the pigment.

6. The active-energy-ray-curable composition according to claim 1,
wherein the active-energy-ray-curable composition is free of an organic solvent.

7. An active-energy-ray-curable ink comprising:
the active-energy-ray-curable composition according to claim 1; and
a polymerization initiator,
wherein the polymerization initiator is blended in the active-energy-ray-curable composition.

8. The active-energy-ray-curable ink according to claim 7,
wherein the active-energy-ray-curable ink is an inkjet ink.

9. A composition stored container comprising:
a container; and
the active-energy-ray-curable composition according to claim 1 stored in the container.

10. A two-dimensional or three-dimensional image forming apparatus comprising:
a storing unit including:
a container; and
the active-energy-ray-curable composition according to claim 1 stored in the container; and
an irradiator configured to irradiate the active-energy-ray-curable composition with active energy rays.

11. The image forming apparatus according to claim 10,
wherein the irradiator comprises a UV-LED configured to emit ultraviolet rays having a peak in a wavelength range of from 365 nm through 405 nm.

12. A two-dimensional or three-dimensional image forming method comprising
irradiating the active-energy-ray-curable composition according to claim 1 with active energy rays to form a two-dimensional or three-dimensional image.

13. The image forming method according to claim 12,
wherein the active energy rays are emitted from a UV-LED configured to emit ultraviolet rays having a peak in a wavelength range of from 365 nm through 405 nm.

14. A cured product produced by curing the active-energy-ray-curable composition according to claim 1.

15. A decorated product comprising:
a base material; and
a surface decoration applied over the base material,
wherein the surface decoration is formed of the cured product according to claim 14.
